(19) United States
(12) Patent Application Publication
(10) Pub. No.: US 2026/0260010 A1
(43) Pub. Date: Sep. 3, 2026

(54) SYSTEMS AND METHODS FOR DYNAMICALLY REVISING A STRUCTURE OF A GRAPH DATA STRUCTURE USING DYNAMICALLY SELECTED VIEWS OF THE GRAPH DATA STRUCTURE

(71) Applicant: Altana Technologies, Inc., Brooklyn, NY (US)

(72) Inventors: Evan Smith, New York, NY (US); Peter Swartz, New York, NY (US); Ian Cadieu, Stamford, CT (US); Joshua Max Broomberg, Brooklyn, NY (US)

(73) Assignee: Altana Technologies, Inc., Brooklyn, NY (US)

(21) Appl. No.: 19/553,388

(22) Filed: Mar. 1, 2026

Related U.S. Application Data
(60) Provisional application No. 63/766,225, filed on Mar. 3, 2025.

(51) Int. Cl. G06F 21/62; G06F 16/901

(52) U.S. Cl. CPC G06F 21/6218; G06F 16/9024

(57) ABSTRACT

Systems and methods for dynamically revising a structure of a network graph data structure using a generated view of the network graph data structure are disclosed. A system can receive a request to generate a digital record for a networked item comprising an identification of the networked item. The system can identify a node for a profile for the networked item from a network graph data structure and identify a plurality of attributes of the networked item stored at or with the node. The system can identify one or more sub-graph data structures each linked to the node and comprising a chain of nodes forming a path of instances of the networked item from a source node to a destination node. The system can generate and communicate the digital record and revise a node or edge of the one or more sub-graph data structures based on a user input.

### CROSS-REFERENCE TO APPLICATIONS

This application claims the benefit of priority to U.S. Provisional Application No. 63/766,225, filed Mar. 3, 2025, the entirety of which is incorporated by reference herein.

### BACKGROUND

Network graph data structures can store complex relationships between entities and networked items as interconnected nodes and edges. Computing devices can process and analyze network graph data structures to extract insights about the represented relationships. However, efficiently managing and updating large-scale network graph data structures is difficult given the large amount of computational resources (e.g., memory and processing power) that is used as the data scales.

### SUMMARY

In distributed computing environments where a computing system maintains a graph database representing dynamic operational states, such as in supply chain asset tracking, cybersecurity threat modeling, or complex system simulations, the computing system may provide users with visualized sub-graph data scoped to a particular entity. However, when operating with conventional tools, the computing system generates static visualization exports that break the live link to the persisted graph state, causing the computing system to present outdated information and potentially influencing user decisions based on stale data. The computing system may also retrieve and display graph data without enforcing fine-grained node and edge-level access controls in visualization modes, thereby increasing the risk of exposing sensitive information to unauthorized users. Further, when multiple users concurrently edit overlapping portions of the graph, the computing system frequently processes conflicting updates to the same graph elements without any automated resolution mechanism at the structural graph level, resulting in mutual overwrites, loss of data integrity, and reduced reliability in collaborative editing environments.

The embodiments described herein address these shortcomings by providing a computing system that actively generates and maintains a real-time link between a graph data structure and an interactive sub-graph visualization. The computing system receives a request from a client device for information about a particular networked entity, resolves the request to the corresponding node within the stored graph, and identifies one or more connected sub-graph structures by executing a traversal operation on the graph database. The computing system generates a live view of particular nodes and edges within the identified sub-graph data structure, the live view being a system-maintained, query-scoped representation of the selected graph elements that remains logically bound to the persisted database state. The computing system then transmits to the client device an address pointer to the live view, such as a hyperlink or other network-accessible resource locator, that, when accessed by the client, retrieves and renders the up-to-date visualization directly from the computing system without requiring the client to store or manage an independent copy of the sub-graph.

This arrangement allows the computing system to apply edits made in the user interface directly to the corresponding nodes and edges in the underlying graph database without requiring separate export or manual synchronization. In some examples, this can prevent conflicting updates. For example, the computing system can detect conflicting edits to the same graph elements originating from multiple concurrent sessions and applies a machine-learning-based resolution process, trained on historical editing patterns, to determine and commit the correct revision. Because the system is generating and presenting sub-graphs based on a larger network graph that each show a subset of entities and relationships, users may inadvertently introduce conflicting changes due to operating on isolated views that omit dependencies or constraints present in other portions of the graph. By resolving conflicting updates during the editing workflow, the computing system may maintain graph consistency across sessions, reduce the likelihood of data corruption, and ensure that committed revisions reflect the most contextually accurate and policy-compliant state of the graph. Moreover, by leveraging machine learning to resolve conflicts between multiple updates, the computing system can intelligently prioritize the most significant revisions, thereby enhancing the accuracy of conflict resolution.

This arrangement may also allow the computing system to securely manage and restrict access to specific nodes based on user roles or permissions. The computing system can enforce node- and edge-level access controls during both retrieval and edit operations by verifying the requesting user's credentials against stored permissions before allowing the visualization to display or mutate protected data. Because nodes and edges are components of larger, interconnected graph structures, they may be contextually linked to data that falls outside a user's access privileges. By verifying access permissions before presenting the sub-graph data structures that represent subsets of the larger network graph data structure, the computing system can prevent unauthorized exposure of adjacent or related elements, which may ensure that users only interact with data explicitly permitted by their access level.

At least one aspect relates to a system. The system can include memory storing a network graph data structure that stores a network of nodes and edges between the nodes and digitally represents types of relationships between entities and networked items. The system can include a digital record generator configured to generate dedicated views of portions of the network graph data structure. The system can receive, from a client device via a user interface, a request to generate a digital record for a networked item, where the request includes an identification of the networked item. The system can activate the digital record generator in response to the request. The system can identify, based on the identification, a node for a profile for the networked item from the network graph data structure. The system can identify a plurality of attributes of the networked item stored at or with the node for the profile. The system can identify, for the networked item, one or more sub-graph data structures of the network graph data structure that are each linked to the node of the profile and that each comprise a chain of nodes forming a sequence of connected nodes that defines a path of one or more instances of the networked item from a source node to a destination node. The path represents network operations of the one or more instances of the networked item through the sequence of connected nodes. Each node of the sequence represents an entity performing a network operation on the one or more instances of the networked item. Each edge between one or more pairs of the sequence of connected nodes represents movement of the one or more instances of the networked item from a first node of a pair to a second node of the pair. The system can generate the digital record identifying the plurality of attributes of the networked item and the identified one or more sub-graph data structures for the networked item. The system can communicate the digital record for presentation via the user interface at the client device. The system can revise a node or an edge of the one or more sub-graph data structures of the network graph data structure based on a user input into the digital record from the user interface.

In some implementations, the system can receive the request to generate the digital record by receiving a user-generated input identifying the networked item and associated access permissions corresponding to levels of access with different nodes of the network graph data structure. In some implementations, the system can identify the one or more sub-graph data structures based on the access permissions.

In some implementations, the system can identify the one or more sub-graph data structures by identifying a plurality of nodes or sub-graph data structures linked with the node for the networked item. In some implementations, the system can compare the access permissions with access restrictions associated with each of the plurality of nodes or sub-graph data structures. In some implementations, the system can identify, based on the comparison, the one or more sub-graph data structures responsive to determining that the access permissions of a user providing the user input satisfy access restrictions of each of the one or more sub-graph data structures and nodes within the sub-graph data structures.

In some implementations, the system can communicate the digital record for presentation via the user interface by transmitting a Hypertext Transfer Protocol link corresponding to the digital record to the client device. In some implementations, the system can receive a selection of the link from the client device. In some implementations, the system can transmit a view of the one or more sub-graph data structures to the client device for presentation in response to receiving the selection of the link.

In some implementations, the system can generate the view by configuring the view to depict each of the one or more sub-graph data structures, the configuration depicting nodes connected by lines within each of the respective one or more sub-graph data structures.

In some implementations, the system can transmit the view of the one or more sub-graph data structures by transmitting a file containing data objects representing nodes within each of the one or more sub-graph data structures. In some implementations, the system can revise the node or edge of the one or more sub-graph data structures by receiving, from the client device, the user input indicating a change to a data object representing the node or the edge, identifying the node or the edge that corresponds to the changed data object, and propagating the change from the changed data object to the identified node or edge.

In some implementations, the system can propagate the change from the changed data object to the identified node or edge in response to determining that an access credential of a user providing the user input satisfies an access restriction of the identified node or edge.

In some implementations, the system can transmit the view of the one or more sub-graph data structures by transmitting the one or more sub-graph data structures to the client device. In some implementations, the system can revise the node or the edge of the one or more sub-graph data structures by receiving, from the client device, the user input indicating a change to the node or the edge and propagating the change to the identified node or edge.

In some implementations, the system can, prior to revising the node or the edge of the one or more sub-graph data structures, determine whether the revision conflicts with any other pending revisions to the node or the edge. In some implementations, the system can revise the node or the edge responsive to determining that the revision does not conflict with any other pending revisions.

In some implementations, the system can, prior to revising the node or the edge of the one or more sub-graph data structures, determine whether the revision conflicts with any other pending revisions to the node or the edge. In some implementations, the system can detect a conflict between the revision and a pending revision from a second user input originating from a second computing device. In some implementations, the system can execute a machine learning model using the revision and the pending revision as input to cause the machine learning model to output a selection of the revision as the correct revision, where the machine learning model is trained based on labeled training data of conflicting revisions to the network graph data structure. In some implementations, the system can revise the node or the edge based on the output of the machine learning model.

At least one other aspect relates to a method. The method can be performed, for example, by one or more processors coupled to non-transitory memory. The method can include receiving, from a client device via a user interface, a request to generate a digital record for a networked item, where the request includes an identification of the networked item. The method can include identifying, based on the identification, a node for a profile for the networked item from a network graph data structure that stores a network of nodes and edges between the nodes and digitally represents types of relationships between entities and networked items represented by the nodes. The method can include identifying a plurality of attributes of the networked item stored at or with the node for the profile. The method can include identifying, for the networked item, one or more sub-graph data structures of the network graph data structure that are each linked to the node of the profile and that each comprise a chain of nodes forming a sequence of connected nodes defining a path of one or more instances of the networked item from a source node to a destination node. The path represents network operations of the one or more instances of the networked item through the sequence of connected nodes. Each node of the sequence represents an entity performing a network operation on the one or more instances of the networked item. Each edge between one or more pairs of the sequence of connected nodes represents movement of the one or more instances of the networked item from a first node of a pair to a second node of the pair. The method can include generating the digital record identifying the plurality of attributes and the one or more sub-graph data structures. The method can include communicating the digital record for presentation via the user interface at the client device. The method can include revising a node or an edge of the one or more sub-graph data structures of the network graph data structure based on a user input into the digital record from the user interface.

In some implementations, the method can include receiving a user-generated input identifying the networked item and associated access permissions corresponding to levels of access with different nodes of the network graph data structure. In some implementations, identifying the one or more sub-graph data structures is based on the access permissions.

In some implementations, the method can include identifying a plurality of nodes or sub-graph data structures that are linked with the node for the networked item. In some implementations, the method can include comparing the access permissions with access restrictions associated with each of the plurality of nodes or sub-graph data structures. In some implementations, the method can include identifying, based on the comparison, the one or more sub-graph data structures responsive to determining that the access permissions of a user providing the user input satisfy access restrictions of each of the one or more sub-graph data structures and nodes within the sub-graph data structures.

In some implementations, communicating the digital record for presentation via the user interface at the client device can include transmitting a Hypertext Transfer Protocol link corresponding to the digital record to the client device. In some implementations, the method can include receiving a selection of the link from the client device. In some implementations, the method can include transmitting a view of the one or more sub-graph data structures to the client device for presentation.

In some implementations, the method can include generating the view by configuring the view to depict each of the one or more sub-graph data structures, the configuration depicting nodes connected by lines within each of the respective one or more sub-graph data structures.

In some implementations, transmitting the view of the one or more sub-graph data structures can include transmitting a file containing data objects representing nodes within each of the one or more sub-graph data structures. In some implementations, revising the node or the edge of the one or more sub-graph data structures can include receiving, from the client device, the user input indicating a change to a data object representing the node or the edge, identifying the node or the edge that corresponds to the changed data object, and propagating the change from the changed data object to the identified node or edge.

In some implementations, the method can include, prior to revising the node or the edge of the one or more sub-graph data structures, determining whether the revision conflicts with any other revisions to the node or the edge. In some implementations, the method can include detecting a conflict between the revision and a pending revision from a second user input originating from a second computing device. In some implementations, the method can include executing a machine learning model using the revision and the pending revision as input to cause the machine learning model to output a selection of the revision as the correct revision, where the machine learning model is trained based on labeled training data of conflicting revisions to the network graph data structure. In some implementations, the method can include revising the node or the edge based on the output of the machine learning model.

At least one other aspect relates to a non-transitory computer-readable medium. The non-transitory computer-readable medium can store instructions that, when executed by one or more processors, cause the one or more processors to perform operations. The operations can include receiving, from a client device via a user interface, a request to generate a digital record for a networked item, where the request includes an identification of the networked item. The operations can include identifying, based on the identification, a node for a profile for the networked item from a network graph data structure that stores a network of nodes and edges between the nodes and digitally represents types of relationships between entities and networked items represented by the nodes. The operations can include identifying a plurality of attributes of the networked item stored at or with the node for the profile. The operations can include identifying, for the networked item, one or more sub-graph data structures of the network graph data structure that are each linked to the node of the profile and that each comprise a chain of nodes forming a sequence of connected nodes defining a path of one or more instances of the networked item from a source node to a destination node. The path represents network operations of the one or more instances of the networked item through the sequence of connected nodes. Each node of the sequence represents an entity performing a network operation on the one or more instances of the networked item. Each edge between one or more pairs of the sequence of connected nodes represents movement of the one or more instances of the networked item from a first node of a pair to a second node of the pair. The operations can include generating the digital record identifying the plurality of attributes and the one or more sub-graph data structures. The operations can include communicating the digital record for presentation via the user interface at the client device. The operations can include revising a node or an edge of the one or more sub-graph data structures of the network graph data structure based on a user input into the digital record from the user interface.

In some implementations, the operations can include receiving a user-generated input identifying the networked item and associated access permissions corresponding to levels of access with different nodes of the network graph data structure, and identifying the one or more sub-graph data structures based on the access permissions.

In some implementations, the operations can include, prior to revising the node or the edge of the one or more sub-graph data structures, determining whether the revision conflicts with any other revisions to the node or the edge, detecting a conflict between the revision and a pending revision from a second user input originating from a second computing device, executing a machine learning model using the revision and the pending revision as input to cause the machine learning model to output a selection of the revision as the correct revision where the machine learning model is trained based on labeled training data of conflicting revisions to the network graph data structure, and revising the node or the edge based on the output of the machine learning model.

At least one aspect relates to a system. The system can identify a digital record for a networked item, the digital record identifying one or more sub-graph data structures of a network graph data structure. Each sub-graph data structure can be linked to a node of a profile for the networked item and can include a chain of nodes, the chain of nodes comprising a sequence of connected nodes forming a path of one or more instances of the networked item from a source node to a destination node. The path can represent network operations of the one or more instances of the networked item through the sequence of connected nodes. Each node of the sequence of connected nodes can represent an entity performing a network operation on the one or more instances of the networked item. Each edge between one or more pairs of the sequence of connected nodes can represent movement of the one or more instances of the networked item from a first node of the pair of nodes to a second node of the pair of nodes. The system can transmit a message containing a link to the digital record for the networked item to a computing device. The system can provision a view of the one or more sub-graph data structures responsive to receipt of a selection of the link. The system can receive, via the view of the one or more sub-graph data structures, an indication from the computing device that the chain of nodes does not meet one or more thresholds. The system can modify the sequence of connected nodes forming the path based on the indication, the modification causing the chain of nodes to satisfy the one or more thresholds.

In some implementations, the system can receive a rule set comprising geographic exclusion parameters encoded in a structured compliance schema. In some implementations, the system can modify the sequence of connected nodes by replacing a node tagged with a geolocation attribute matching a restricted region with a substitute node having a geolocation attribute outside the restricted region. In some implementations, the system can receive a request for an origin of the networked item from the computing device with the indication. In some implementations, the system can append a data structure identifying the origin of the networked item to the chain of nodes in the view of the one or more sub-graph data structures. In some implementations, the system can determine the chain of nodes fails to meet a first threshold corresponding to emission values at the chain of nodes. In some implementations, the system can identify, at each node of the chain of nodes, an emission value for the node of the chain of nodes. In some implementations, the system can execute a model using each of the emission values to identify an at-risk node of the chain of nodes for replacing. In some implementations, the system can replace the at-risk node with a new node corresponding to a new emission value below a second threshold. In some implementations, the system can include, in the view of the one or more sub-graph data structures, a flag for each of the chain of nodes indicating whether the node satisfies a defined set of criteria. In some implementations, the indication that the chain of nodes does not meet the one or more thresholds can be based on the flags indicating whether the nodes satisfy the defined set of criteria. In some implementations, the system can modify the sequence of connected nodes by identifying a second sub-graph data structure comprising a second chain of nodes linked to a second digital record. In some implementations, the system can merge the second chain of nodes with the chain of nodes of the digital record to form a composite path satisfying the one or more thresholds. In some implementations, the system can modify the sequence of connected nodes by detecting a missing attribute in a node of the chain of nodes by comparing node metadata against a schema of required field-value pairs. In some implementations, the system can insert the missing attribute into the node metadata to cause the chain of nodes to satisfy the one or more thresholds. In some implementations, the system can generate a Uniform Resource Locator comprising a Hypertext Transfer Protocol link referencing the digital record. In some implementations, the system can transmit the Uniform Resource Locator to the computing device for rendering in a browser-based interface. In some implementations, the system can append an authentication token to the digital record responsive to modifying the sequence of connected nodes to satisfy the one or more thresholds. In some implementations, the system can receive a second request with an identification of the networked item from the computing device or a second computing device. In some implementations, the system can identify the digital record for the networked item with the appended authentication token based on the second request. In some implementations, the system can transmit the digital record with the appended authentication token to a requesting device, the token configured to trigger automated approval logic for a network operation involving the networked item. In some implementations, the system can receive one or more thresholds from the computing device. In some implementations, the system can modify the sequence of connected nodes forming the path by identifying a first subset of nodes within the chain of nodes that fail to satisfy a defined rule set of the one or more thresholds, the defined rule set comprising one or more node-level attribute constraints and edge-level transaction metadata. In some implementations, the system can perform a search of nodes of the network graph data structure outside of the chain of nodes using the defined rule set to identify a second subset of nodes that satisfy the defined rule set. In some implementations, the system can replace the first subset of nodes with the second subset of nodes based on the search.

At least one other aspect relates to a method. The method can be performed, for example, by one or more processors coupled to non-transitory memory. The method can include identifying a digital record for a networked item, the digital record identifying one or more sub-graph data structures of a network graph data structure, each sub-graph data structure linked to a node of a profile for the networked item and comprising a chain of nodes, the chain of nodes comprising a sequence of connected nodes forming a path of one or more instances of the networked item from a source node to a destination node. The path can represent network operations of the one or more instances of the networked item through the sequence of connected nodes. Each node of the sequence of connected nodes can represent an entity performing a network operation on the one or more instances of the networked item. Each edge between one or more pairs of the sequence of connected nodes can represent movement of the one or more instances of the networked item from a first node of the pair of nodes to a second node of the pair of nodes. The method can include transmitting a message containing a link to the digital record for the networked item to a computing device. The method can include provisioning a view of the one or more sub-graph data structures responsive to receipt of a selection of the link. The method can include receiving an indication from the computing device via the view of the one or more sub-graph data structures that the chain of nodes does not meet one or more thresholds. The method can include modifying the sequence of connected nodes forming the path based on the indication, the modification causing the chain of nodes to satisfy the one or more thresholds.

In some implementations, the method can include receiving a rule set comprising geographic exclusion parameters encoded in a structured compliance schema. In some implementations, the method can include modifying the sequence of connected nodes by replacing a node tagged with a geolocation attribute matching a restricted region with a substitute node having a geolocation attribute outside the restricted region. In some implementations, the method can include generating for each node in the chain of nodes a compliance flag based on evaluation of node attributes against a rule set comprising structured criteria. In some implementations, the method can include receiving the indication from the computing device based on one or more compliance flags failing to satisfy the structured criteria. In some implementations, the method can include identifying a second sub-graph data structure comprising a second chain of nodes linked to a second digital record. In some implementations, the method can include merging the second chain of nodes with the chain of nodes of the digital record to form a composite path satisfying the one or more thresholds. In some implementations, the method can include detecting a missing attribute in a node of the chain of nodes by comparing node metadata against a schema of required field-value pairs. In some implementations, the method can include inserting the missing attribute into the node metadata to cause the chain of nodes to satisfy the one or more thresholds. In some implementations, the method can include appending an authentication token to the digital record responsive to modifying the sequence of connected nodes to satisfy the one or more thresholds. In some implementations, the method can include receiving a second request with an identification of the networked item from the computing device or a second computing device. In some implementations, the method can include identifying the digital record for the networked item with the appended authentication token based on the second request. In some implementations, the method can include transmitting the digital record with the appended authentication token to a requesting device, the token configured to trigger automated approval logic for a network operation involving the networked item. In some implementations, the method can include receiving one or more thresholds from the computing device. In some implementations, the method can include identifying a first subset of nodes within the chain of nodes that fail to satisfy a defined rule set of the one or more thresholds, the defined rule set comprising one or more node-level attribute constraints and edge-level transaction metadata. In some implementations, the method can include performing a search of nodes of the network graph data structure outside of the chain of nodes using the defined rule set to identify a second subset of nodes that satisfy the defined rule set. In some implementations, the method can include replacing the first subset of nodes with the second subset of nodes based on the search.

At least one other aspect relates to a non-transitory computer-readable medium. The computer-readable medium can store instructions that, when executed by one or more processors of a server, cause the server to identify a digital record for a networked item, the digital record identifying one or more sub-graph data structures of a network graph data structure. Each sub-graph data structure can be linked to a node of a profile for the networked item and can include a chain of nodes, the chain of nodes comprising a sequence of connected nodes forming a path of one or more instances of the networked item from a source node to a destination node. The computer-readable medium can store instructions to transmit a message containing a link to the digital record to a computing device. The computer-readable medium can store instructions to provision a view of the one or more sub-graph data structures responsive to receipt of a selection of the link. The computer-readable medium can store instructions to receive, via the view, an indication that the chain of nodes does not meet one or more thresholds. The computer-readable medium can store instructions to modify the sequence of connected nodes forming the path based on the indication, the modification causing the chain of nodes to satisfy the one or more thresholds.

In some implementations, the computer-readable medium can store instructions to identify a first subset of nodes within the chain of nodes that fail to satisfy a defined rule set comprising node-level attribute constraints and edge-level transaction metadata. In some implementations, the computer-readable medium can store instructions to perform a search of nodes of the network graph data structure outside of the chain of nodes using the defined rule set to identify a second subset of nodes that satisfy the defined rule set. In some implementations, the computer-readable medium can store instructions to replace the first subset of nodes with the second subset of nodes based on the search. In some implementations, the computer-readable medium can store instructions to append an authentication token to the digital record responsive to modifying the sequence of connected nodes. In some implementations, the computer-readable medium can store instructions to receive a second request from a computing device identifying the networked item. In some implementations, the computer-readable medium can store instructions to identify the digital record with the appended authentication token. In some implementations, the computer-readable medium can store instructions to transmit the digital record with the authentication token to the computing device, the authentication token configured to trigger automated approval logic for a network operation involving the networked item.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated in and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular form of ‘a,’ ‘an,’ and ‘the’ include plural referents unless the context clearly dictates otherwise.

### BRIEF DESCRIPTION OF THE DRAWINGS

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles, and concepts. The drawings are not intended to limit the scope of the claims included herewith.

FIG. 1A illustrates an example block diagram depicting a computing device, in accordance with one or more embodiments.

FIG. 1B illustrates an example block diagram depicting a computing environment comprising a client device in communication with cloud service providers, in accordance with one or more embodiments.

FIG. 2A illustrates an example block diagram depicting a system using supervised learning, in accordance with one or more embodiments.

FIG. 2B illustrates an example block diagram depicting a simplified neural network model, in accordance with one or more embodiments.

FIG. 3A is an illustration of an example system for network graph data structure-based transportation networking, in accordance with an implementation.

FIG. 3B illustrates an example network graph data structure, in accordance with an implementation.

FIG. 3C illustrates example sub-graph data structures of the example network graph data structure of FIG. 3B, in accordance with an implementation.

FIG. 3D illustrates an example sub-graph data structure of the example network graph data structure of FIG. 3B, in accordance with one or more embodiments.

FIG. 3E illustrates a hub and spoke infrastructure for managing a network graph data structure that allows sharing of insights without transmission of sensitive data, in accordance with one or more embodiments.

FIG. 3F illustrates an example flowchart of a process for network graph data structure-based transportation networking, in accordance with an implementation.

FIG. 4A illustrates a sequence diagram of a system for dynamically revising a structure of a graph data structure using selected views of the graph data structure, in accordance with one or more embodiments.

FIG. 4B illustrates a digital record for a networked item profile, in accordance with one or more embodiments.

FIG. 4C illustrates a flowchart of a method for dynamically revising a structure of a graph data structure using selected views of the graph data structure, in accordance with one or more embodiments.

FIG. 4D illustrates a sequence diagram of a system for dynamically modifying a network graph data structure to satisfy a threshold, in accordance with one or more embodiments.

FIG. 4E illustrates a flowchart of a method for dynamically modifying a network graph data structure to satisfy a threshold, in accordance with one or more embodiments.

### DETAILED DESCRIPTION

For purposes of reading the description of the various embodiments below, the following descriptions of the sections of the specification and their respective contents can be helpful:
Section A describes a computing environment and network environment that can be useful for practicing embodiments described herein.
Section B describes an artificial intelligence environment that can be useful for practicing embodiments described herein.
Section C describes a computing device for network graph data structure-based networking in accordance with embodiments described herein.
Section D describes systems and methods for dynamically revising a network graph data structure.

### A. Computing and Network Environment

Prior to discussing the specifics of embodiments of dynamic management of a network graph data structure for value chain management, it may be helpful to discuss the computing environments in which such embodiments may be deployed.

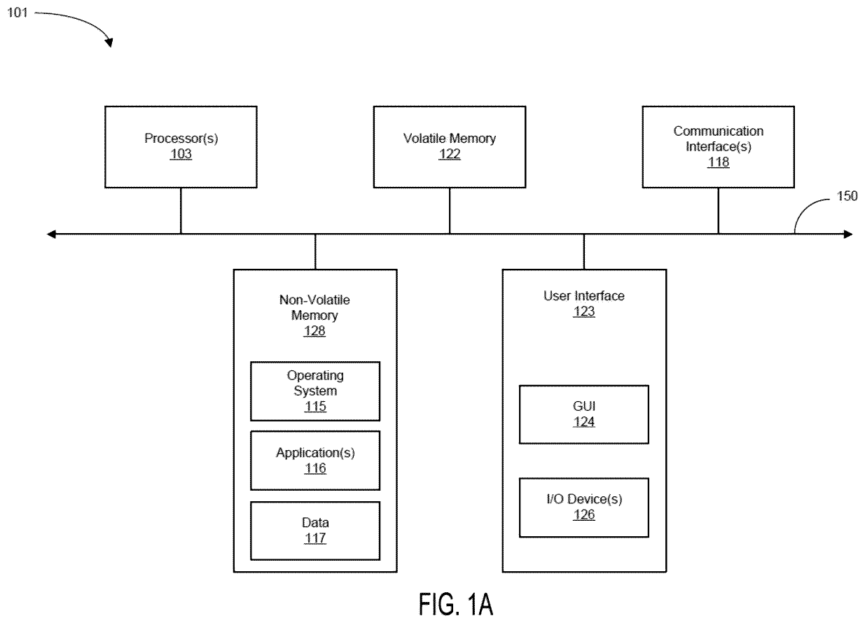

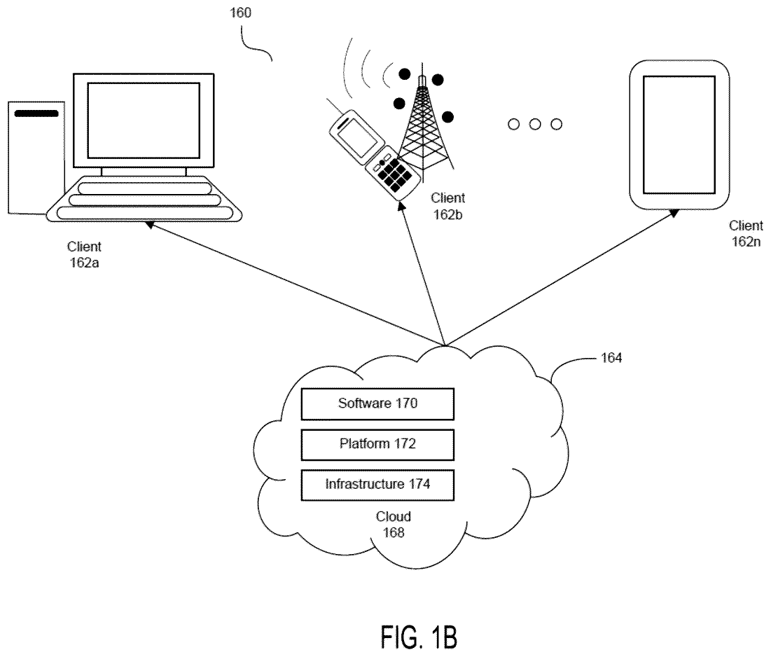

As shown in FIG. 1A, computer 101 may include one or more processors 103, volatile memory 122 (e.g., random access memory (RAM)), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, a microphone, one or more speakers, one or more cameras, one or more biometric scanners, one or more environmental sensors, one or more accelerometers, etc.). Non-volatile memory 128 stores operating system 115, one or more applications 116, and data 117 such that, for example, computer instructions of operating system 115 and/or applications 116 are executed by processor(s) 103 out of volatile memory 122. In some embodiments, volatile memory 122 may include one or more types of RAM and/or a cache memory that may offer a faster response time than a main memory. Data may be entered using an input device of GUI 124 or received from I/O device(s) 126. Various elements of computer 101 may communicate via one or more communication buses, shown as communication bus 150.

Computer 101 as shown in FIG. 1A is shown merely as an example, as clients, servers, intermediary and other networking devices and may be implemented by any computing or processing environment and with any type of machine or set of machines that may have suitable hardware and/or software capable of operating as described herein. Processor(s) 103 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A “processor” may perform the function, operation, or sequence of operations using digital values and/or using analog signals. In some embodiments, the “processor” can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors. A processor including multiple processor cores and/or multiple processors multiple processors may provide functionality for parallel, simultaneous execution of instructions or for parallel, simultaneous execution of one instruction on more than one piece of data.

Communications interfaces 118 may include one or more interfaces to enable computer 101 to access a computer network such as a Local Area Network (LAN), a Wide Area Network (WAN), a Personal Area Network (PAN), or the Internet through a variety of wired and/or wireless or cellular connections.

In described embodiments, the computing device 101 may execute an application on behalf of a user of a client computing device. For example, the computing device 101 may execute a virtual machine, which provides an execution session within which applications execute on behalf of a user or a client computing device, such as a hosted desktop session. The computing device 101 may also execute a terminal services session to provide a hosted desktop environment. The computing device 101 may provide access to a computing environment including one or more of: one or more applications, one or more desktop applications, and one or more desktop sessions in which one or more applications may execute.

Referring to FIG. 1B, a computing environment 160 is depicted. Computing environment 160 may generally be considered implemented as a cloud computing environment, an on-premises (“on-prem”) computing environment, or a hybrid computing environment including one or more on-prem computing environments and one or more cloud computing environments. When implemented as a cloud computing environment, also referred as a cloud environment, cloud computing or cloud network, computing environment 160 can provide the delivery of shared services (e.g., computer services) and shared resources (e.g., computer resources) to multiple users. For example, the computing environment 160 can include an environment or system for providing or delivering access to a plurality of shared services and resources to a plurality of users through the internet. The shared resources and services can include, but not limited to, networks, network bandwidth, servers, processing, memory, storage, applications, virtual machines, databases, software, hardware, analytics, and intelligence.

In embodiments, the computing environment 160 may provide client 162 with one or more resources provided by a network environment. The computing environment 162 may include one or more clients 162a-162n, in communication with a cloud 168 over one or more networks 164. Clients 162 may include, e.g., thick clients, thin clients, and zero clients. The cloud 108 may include back end platforms, e.g., servers 106, storage, server farms or data centers. The clients 162 can be the same as or substantially similar to computer 101 of FIG. 1A.

The users or clients 162 can correspond to a single organization or multiple organizations. For example, the computing environment 160 can include a private cloud serving a single organization (e.g., enterprise cloud). The computing environment 160 can include a community cloud or public cloud serving multiple organizations. In embodiments, the computing environment 160 can include a hybrid cloud that is a combination of a public cloud and a private cloud. For example, the cloud 108 may be public, private, or hybrid. Public clouds 108 may include public servers that are maintained by third parties to the clients 162 or the owners of the clients 162. The servers may be located off-site in remote geographical locations as disclosed above or otherwise. Public clouds 168 may be connected to the servers over a public network 164. Private clouds 168 may include private servers that are physically maintained by clients 162 or owners of clients 162. Private clouds 168 may be connected to the servers over a private network 164. Hybrid clouds 168 may include both the private and public networks 164 and servers.

The cloud 168 may include back end platforms, e.g., servers, storage, server farms or data centers. For example, the cloud 168 can include or correspond to a server or system remote from one or more clients 162 to provide third party control over a pool of shared services and resources. The computing environment 160 can provide resource pooling to serve multiple users via clients 162 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In embodiments, the computing environment 160 can provide on-demand self-service to unilaterally provision computing capabilities (e.g., server time, network storage) across a network for multiple clients 162. The computing environment 160 can provide an elasticity to dynamically scale out or scale in responsive to different demands from one or more clients 162. In some embodiments, the computing environment 160 can include or provide monitoring services to monitor, control and/or generate reports corresponding to the provided shared services and resources.

In some embodiments, the computing environment 160 can include and provide different types of cloud computing services. For example, the computing environment 160 can include Infrastructure as a service (IaaS). The computing environment 160 can include Platform as a service (PaaS). The computing environment 160 can include serverless computing. The computing environment 160 can include Software as a service (SaaS). For example, the cloud 168 may also include a cloud based delivery, e.g., Software as a Service (SaaS) 170, Platform as a Service (PaaS) 172, and Infrastructure as a Service (IaaS) 174. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Washington, RACKSPACE CLOUD provided by Rackspace US, Inc., of San Antonio, Texas, Google Compute Engine provided by Google Inc. of Mountain View, California, or RIGHTSCALE provided by RightScale, Inc., of Santa Barbara, California. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Washington, Google App Engine provided by Google Inc., and HEROKU provided by Heroku, Inc. of San Francisco, California. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, California, or OFFICE 365 provided by Microsoft Corporation. Examples of SaaS may also include data storage providers, e.g., DROPBOX provided by Dropbox, Inc. of San Francisco, California, Microsoft SKYDRIVE provided by Microsoft Corporation, Google Drive provided by Google Inc., or Apple ICLOUD provided by Apple Inc. of Cupertino, California.

Clients 162 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 162 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 162 may access SaaS resources through the use of web-based user interfaces, provided by a web browser (e.g., GOOGLE CHROME, Microsoft INTERNET EXPLORER, or Mozilla Firefox provided by Mozilla Foundation of Mountain View, California). Clients 162 may also access SaaS resources through smartphone or tablet applications, including, e.g., Salesforce Sales Cloud, or Google Drive app. Clients 162 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

### B. Artificial Intelligence Environment

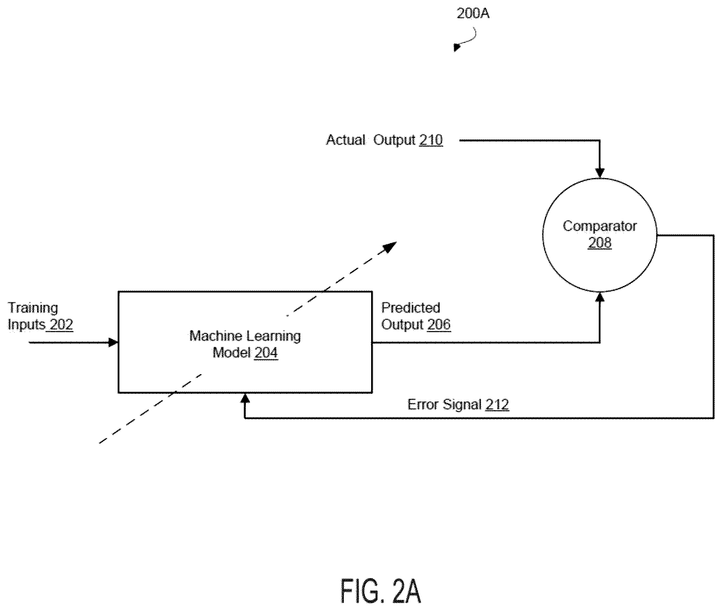

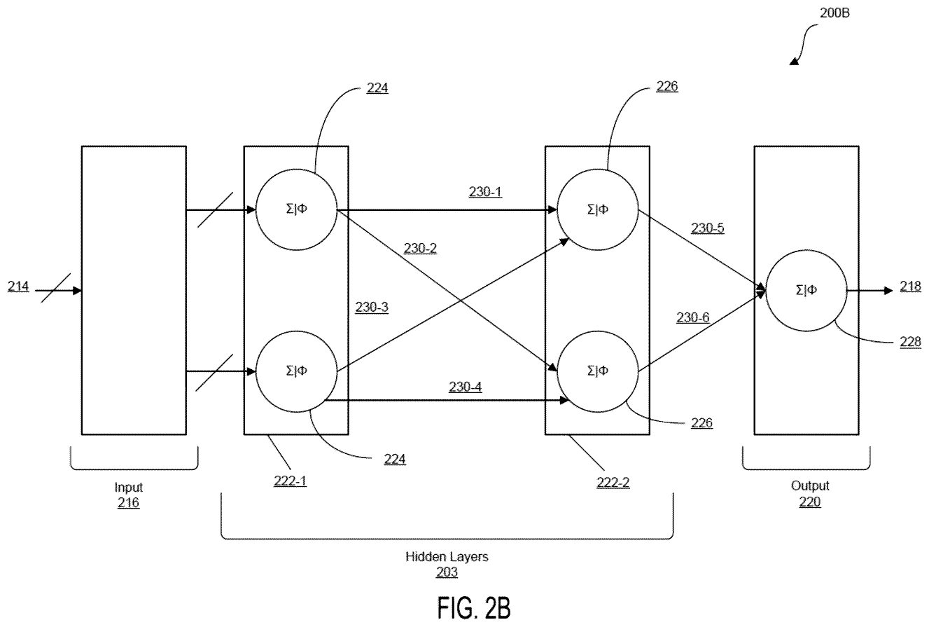

Referring to FIG. 2A, an embodiment of an artificial intelligence environment 200A is depicted. The artificial intelligence environment 200A may incorporate various machine learning models to process data, identify patterns, and generate predictions or decisions. By way of example, machine learning models can comprise supervised learning models, clustering models, neural network models, deep learning models, reinforcement learning models, unsupervised models, decision trees, support-vector machines, Bayesian networks, Gaussian processes, genetic algorithms models, generative models, image and text processing models, video processing models, any other models that can be used by one or more machine learning algorithms, any other models that can learn from data (e.g., training data) to perform tasks without explicit instructions, or various combinations thereof. They can also involve combinations of the above and agentic systems that leverage models and underlying data. The neural network models can comprise, for example and without limitation, artificial neural networks (ANNs), deep neural networks (DNNs), deep belief networks (DBNs), one or more language models, large language models (LLMs), attention-based neural networks, transformer-based neural networks, generative pretrained transformer (GPT) models, bidirectional encoder representations from transformers (BERT) models, encoder/decoder models, sequence to sequence models, autoencoder models, generative adversarial networks (GANs), convolutional neural networks (CNNs), recurrent neural networks (RNNs), diffusion models (e.g., denoising diffusion probabilistic models (DDPMs)), any other models that can learn patterns and make predictions or decisions, or various combinations thereof.

The machine learning models can be configured, learned, or trained using various learning or training operations, such as unsupervised learning, weakly supervised learning, semi-supervised learning, supervised learning, or any other learning or training operations that can learn from data (e.g., training data) and generalize to unseen data, or various combinations thereof. For example, parameters of nodes of a neural network model, such as weights, biases, and/or thresholds, can be configured, learned, or trained using various learning or training operations, such as unsupervised learning, weakly supervised learning, semi-supervised learning, or supervised learning. A machine learning model can be configured using training data from various domain-agnostic and/or domain-specific data sources. The training data can include a plurality of training data elements (e.g., training data instances). Each training data element can be arranged in structured or unstructured formats; for example, the training data element can include an example output mapped to an example input. The training data can include data that is not separated into input and output subsets (e.g., for configuring the machine learning model to perform clustering, classification, or other unsupervised machine learning operations). The training data can include data describing network structure, such as a supply chain network, and the greater network situation of a given observation. The training data can include human-labeled information, including but not limited to feedback regarding outputs of the machine learning model, which can allow the machine learning model to generate more human-like outputs.

Referring back to FIG. 2A, a block diagram of an example system using supervised learning is shown. Supervised learning is a method of training a machine learning model given input-output pairs. An input-output pair is an input with an associated known output (e.g., an expected output).

Machine learning model 204 may be trained on known input-output pairs such that the machine learning model 204 can learn how to predict known outputs given known inputs. Once the machine learning model 204 has learned how to predict known input-output pairs, the machine learning model 204 can operate on unknown inputs to predict an output.

The machine learning model 204 may be trained based on general data and/or granular data (e.g., data based on a specific user 132) such that the machine learning model 204 may be trained specific to a particular user 132.

Training inputs 202 and actual outputs 210 may be provided to the machine learning model 204. Training inputs 202 may include features such as numerical data, categorical variables, text, images, audio signals, and the like.

The inputs 202 and actual outputs 210 may be received from various data repositories. For example, a data repository may contain labeled datasets with example data points and their corresponding correct outputs. The data repository may also contain data associated with specific users or general populations. Thus, the machine learning model 204 may be trained to predict outcomes based on the training inputs 202 and actual outputs 210 used to train the machine learning model 204.

The example system may include one or more machine learning models 204. In an embodiment, a first machine learning model 204 may be trained to predict data using a classification or regression technique. For example, the first machine learning model 204 may use the training inputs 202 to predict outputs 206 by applying the current state of the first machine learning model 204 to the training inputs 202. The comparator 208 may compare the predicted outputs 206 to actual outputs 210 to determine an amount of error or differences. For example, the predicted output 206 may be compared to the actual output 210 to calculate a loss function or error metric.

In other embodiments, a second machine learning model 204 may be trained to make one or more recommendations to the user 132 based on the predicted output from the first machine learning model 204. For example, the second machine learning model 204 may use the training inputs 202 and the predicted outputs from the first machine learning model 204 as its own input to predict outputs 206 in the form of personalized recommendations by applying the current state of the second machine learning model 204 to the training inputs 202. The comparator 208 may compare the predicted outputs 206 (e.g., the recommended actions or networked items) to actual outputs 210 (e.g., user choices or feedback on previous recommendations to determine an amount of error or differences.

The actual outputs 210 may be determined based on historic data of recommendations made to the user 132 and the resulting outcomes in the supply chain. In an illustrative non-limiting example, the machine learning model 204 may be continuously trained to improve its quality and accuracy in predicting and improving supply chain operations. The machine learning model 204 can take into account various inputs such as forecasted demand, inventory data, customer preferences, and distributor preferences to model, recommend, and execute operations. The actual outputs 210 may then be determined by measuring the real-world outcomes after implementing these recommendations, such as the resulting stockout rate, inventory carrying costs, and overall supply chain efficiency.

In some embodiments, a single machine learning model 204 may be trained to make one or more recommendations to the user 132 based on current user 132 data received from enterprise resources 128. That is, a single machine learning model may be trained using the training inputs 202, which include historical data and current user data, to predict outputs 206 in the form of personalized recommendations by applying the current state of the machine learning model 204 to the training inputs 202. The comparator 208 may compare the predicted outputs 206 to actual outputs 210 to determine an amount of error or differences. The actual outputs 210 may be determined based on historic data associated with the recommendation to the user 132 and their subsequent actions or outcomes. The machine learning model 204 may use the data to learn patterns and make increasingly accurate recommendations over time. For instance, if the machine learning model 204 recommends ordering 1000 units of a product and a user 132 follows the recommendation, the actual output 210 may include data on whether the quantity was sufficient, excessive, or inadequate based on subsequent demand and inventory levels. This feedback loop can allow the machine learning model 204 to continuously refine its predictions and adapt to changing conditions and user preferences in the supply chain ecosystem.

During training, the error (represented by error signal 212) determined by the comparator 208 may be used to adjust the weights in the machine learning model 204 such that the machine learning model 204 changes (or learns) over time. The machine learning model 204 may be trained using a backpropagation algorithm, for instance. The backpropagation algorithm operates by propagating the error signal 212. The error signal 212 may be calculated each iteration (e.g., each pair of training inputs 202 and associated actual outputs 210), batch and/or epoch, and propagated through the algorithmic weights in the machine learning model 204 such that the algorithmic weights adapt based on the amount of error. The error is minimized using a loss function. Non-limiting examples of loss functions may include the square error function, the root mean square error function, and/or the cross entropy error function.

The weighting coefficients of the machine learning model 204 may be tuned to reduce the amount of error, thereby minimizing the differences between (or otherwise converging) the predicted output 206 and the actual output 210. The machine learning model 204 may be trained until the error determined at the comparator 208 is within a certain threshold (or a threshold number of batches, epochs, or iterations have been reached). The trained machine learning model 204 and associated weighting coefficients may subsequently be stored in memory 116 or other data repository (e.g., a database) such that the machine learning model 204 may be employed on unknown data (e.g., not training inputs 202). Once trained and validated, the machine learning model 204 may be employed during a testing (or an inference) phase. During testing, the machine learning model 204 may ingest unknown data to predict future data (e.g., future demand, inventory levels, supplier performance, delivery times, and the like).

Referring to FIG. 2B, a block diagram of a simplified neural network model 200B is shown. The neural network model 200B is only an example architecture. The neural network 200B can be any type of neural network, such as a feedforward neural network, a recurrent neural network, a convolutional neural network, a long short-term memory neural network, etc. The neural network model 200B may include a stack of distinct layers (vertically oriented) that transform a variable number of inputs 214 being ingested by an input layer 216 into an output 218 at the output layer 220.

The neural network model 200B may include a number of hidden layers 222 between the input layer 216 and output layer 220. Each hidden layer has a respective number of nodes (224, 226, and 228). In the neural network model 200B, the first hidden layer 222-1 has nodes 224, and the second hidden layer 222-2 has nodes 226. The nodes 224 and 226 perform a particular computation and are interconnected to the nodes of adjacent layers (e.g., nodes 224 in the first hidden layer 222-1 are connected to nodes 226 in a second hidden layer 222-2, and nodes 226 in the second hidden layer 222-2 are connected to nodes 228 in the output layer 220). Each of the nodes (224, 226, and 228) sum up the values from adjacent nodes and apply an activation function, allowing the neural network model 200B to detect nonlinear patterns in the inputs 214. Each of the nodes (224, 226, and 228) are interconnected by weights 230-1, 230-2, 230-3, 230-4, 230-5, 230-6 (collectively referred to as weights 230). Weights 230 are tuned during training to adjust the strength of the node. The adjustment of the strength of the node facilitates the neural network's ability to predict an accurate output 218.

In some embodiments, the output 218 may be one or more numbers. For example, output 218 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As such, the softmax classifier may be employed because of the classifier's ability to classify various classes. Other classifiers may be used to make other classifications. For example, the sigmoid function makes binary determinations about the classification of one class (i.e., the output may be classified using label A or the output may not be classified using label A).

### C. Computing Device for Node Transportation Networking

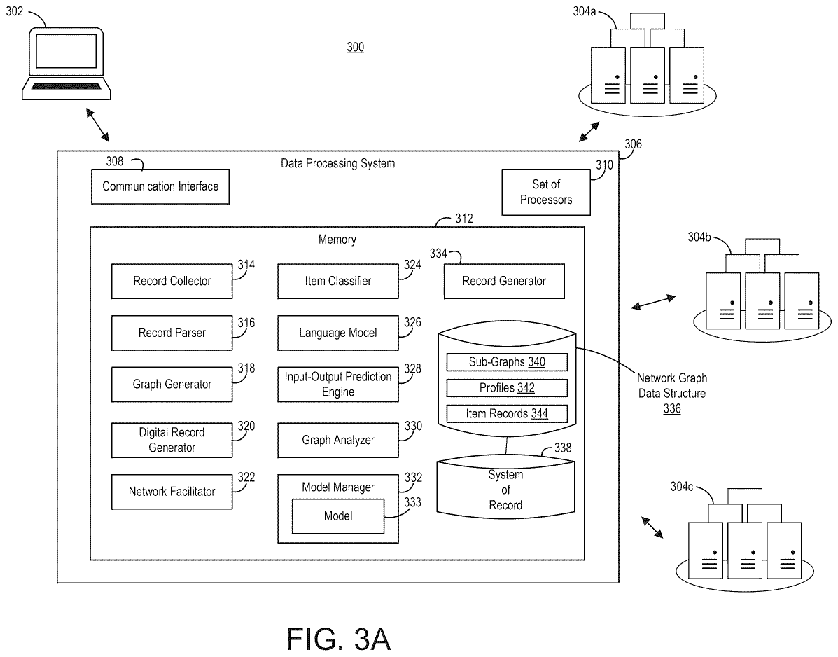

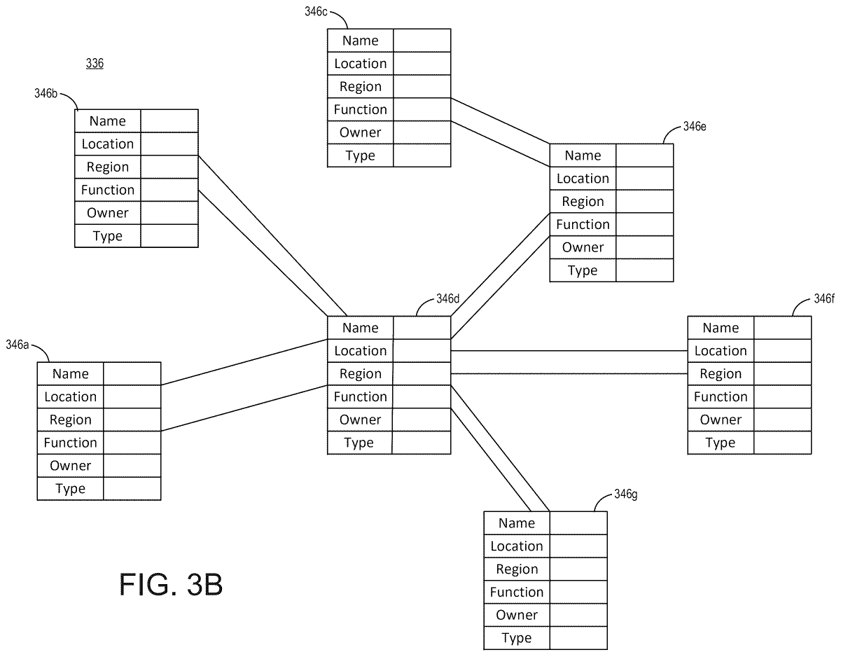

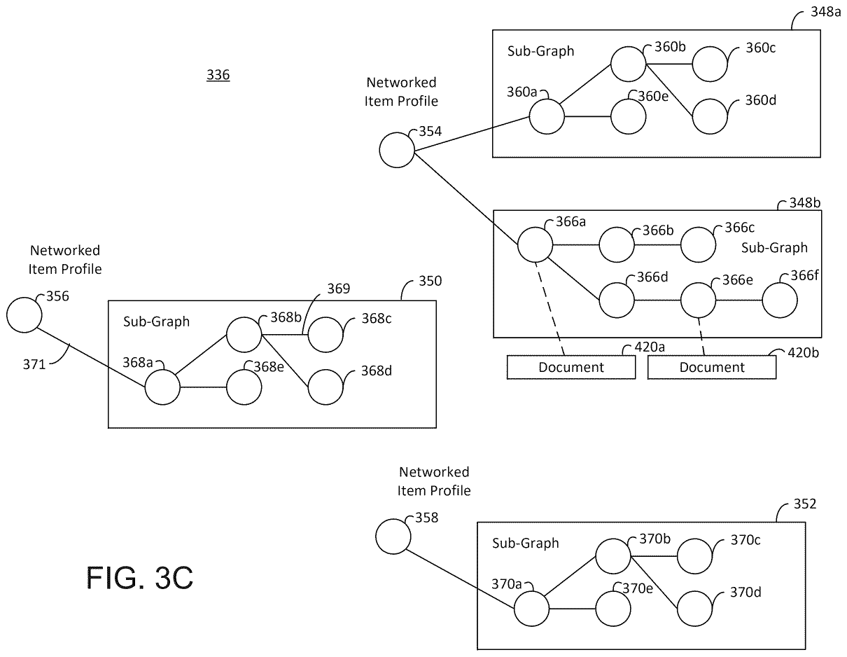

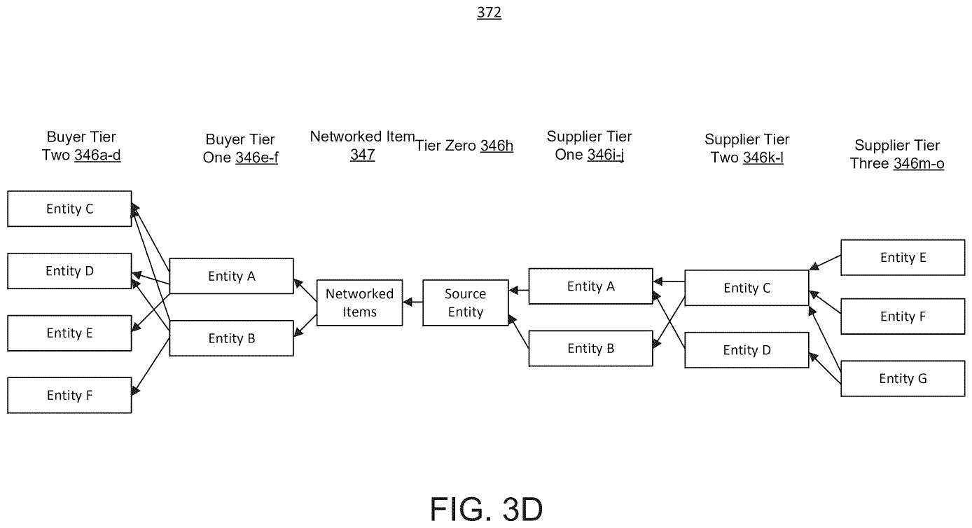

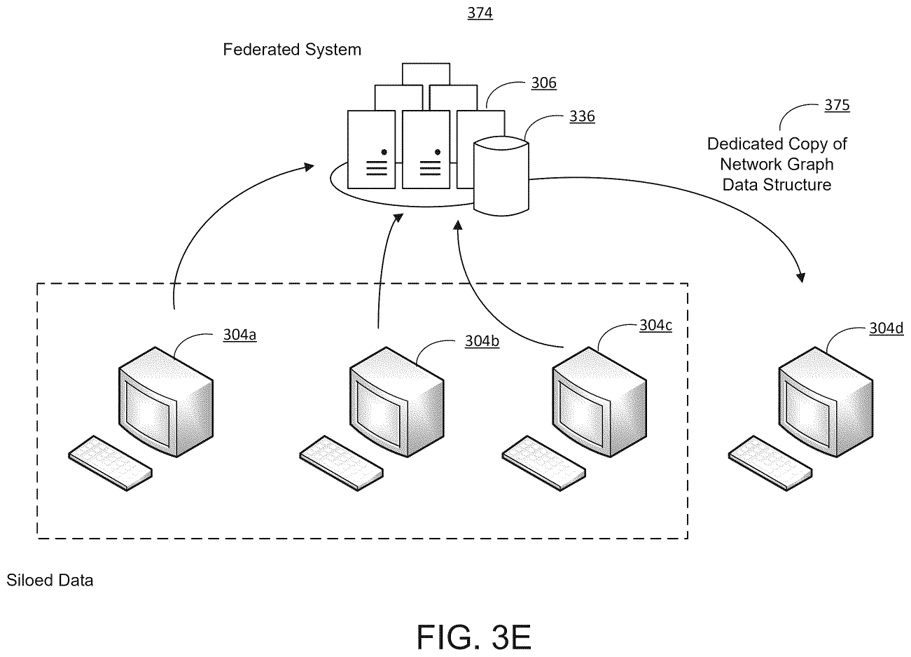

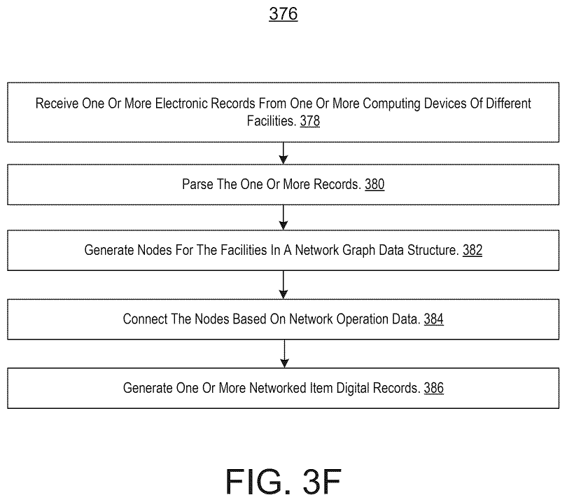

FIG. 3A is an illustration of an example system 300 for network graph data structure-based transportation networking, in accordance with an implementation. In brief overview, the example system 300 can include a client device 302, computing devices 304a-304c (individually, computing device 304, and together, computing devices 304), and a data processing system 306. The system 300 can include more or fewer components than illustrated in FIG. 3A, depending on the implementation. Each of the computing devices 304 can be configured to store various types of data and perform various types of operations discussed in this disclosure. The data processing system 306 can execute a language processing model (e.g., a large language model) to receive and/or process contextual information regarding database transactions or other communications from a user (e.g., a user accessing the client device 302) of the data processing system 306 and/or data received from the computing devices 304. The data processing system 306 can transmit the contextual information to the computing devices 304 for storage.

The client device 302 can be an electronic computing device (e.g., a cellular phone, a laptop, a tablet, a personal computer, or any other type of computing device). The client device 302 can include a display with a microphone, a speaker, a keyboard, a touchscreen, or any other type of input/output device. A user can access a platform provided by the data processing system 306 through the client device 302 to view outputs of machine learning models and/or otherwise access a portions of a network graph data structure (e.g., a knowledge graph or a graph data structure storing nodes and edges) provided generated and/or provided by the data processing system 306. In one example, the user can transmit a request including an identification of a networked item to the data processing system 306. The data processing system 306 can receive the request and retrieve data from a network graph data structure hosted or maintained by the data processing system to generate context or other requested information regarding the identified networked item. The data processing system 306 can transmit the generated context or requested information back to the client device 302. The data processing system 306 can receive and/or transmit such data over a network (e.g., a synchronous or asynchronous network).

The computing devices 304 can each be or correspond to facilities or locations in a transportation network. The facilities can be or include physical locations or sites within a value chain in which operations or processes take place to generate, modify, assemble, store, distribute, or otherwise deliver products or services. Facilities may include manufacturing plants, warehouses, distribution centers, transportation hubs, retail outlets, data centers, or other relevant infrastructure locations. Collectively, these facilities can facilitate the efficient movement and transformation of goods and services across various stages of the value chain, from initial sourcing and supply, through intermediate processing or logistics, and ultimately to the end user or consumer. The transformation and movement can each be a network operation indicating an operation performed on networked items as they move or are transformed across a network of facilities.

For example, a value chain for a consumer electronics product such as a smartphone may include the transportation and transformation of the smartphone across different facilities of the value chain. In the value chain, a first facility in the value chain can be a manufacturing plant, where components are initially assembled into finished products, such as the smartphone. The components of the smartphone can each originate at other facilities of the value chain, such that each facilitate may include multiple inputs to generate one or more outputs for the value chain for a single product. The smartphone can be transported to another facility in the value chain, such as a warehouse facility, which can store completed products awaiting orders from distributors or retailers. From the warehouse facility, the smartphone may be transported to another facility, such as a distribution center or transportation hub, where products are sorted, packaged, and dispatched to retail outlets or directly to end users.

A second example can be a value chain for food products. In this example, facilities may include food processing plants, which can transform raw agricultural produce into packaged and marketable food networked items. From these processing plants, the products may be transported to cold storage or refrigerated warehousing facilities for product freshness and safety. subsequently, transportation hubs or logistics centers can coordinate the distribution of the food products to supermarkets, grocery stores, or directly to consumers, completing the flow from farm to table for the value chain for the food products.

Facilities within a value chain can provide electronic documentation about their roles and operations in the value chain by transmitting relevant data from their respective computing devices 304 to the data processing system 306. For example, a manufacturing plant can use its computing device 304 to transmit detailed production reports that include finished quantities, malfunction logs, quality assurance metrics, and resource consumption data to the data processing system 306. Similarly, warehouse and storage facilities can utilize their respective computing devices 304 to regularly provide inventory updates, storage conditions, inbound delivery notifications, outbound shipment records, and product-handling information to the data processing system 306. By electronically transmitting ongoing documentation regarding inventory status, product movements, batch numbers, expiration dates, and environmental conditions (for example, temperature or humidity sensor readings), these facilities allow the data processing system 306 to maintain continuous visibility into different value chains in which the facilities are a part and the network operations performed by the facilities.

Additionally, logistics hubs and distribution centers may similarly rely upon their computing devices 304 to relay shipping and transportation documentation to the data processing system 306. The computing devices 304 for the logistics hubs and distribution centers can transmit information, such as shipment tracking data, freight bills, estimated delivery timelines, route details, transport conditions, and real-time status updates on transit delays or incidents can be to the data processing system 306.

The data processing system 306 may include one or more processors that are configured to maintain and update a network graph data structure, such as for transportation network management. The data processing system 306 may include a communication interface 308, a set of processors 310, and a memory 312. The data processing system 306 may communicate with the computing devices 304 via the communication interface 308, which may be or include an antenna or other network device that enables communication across a network and/or with other devices. The memory 312 may include a record collector 314, a record parser 316, a graph generator 318, a digital record generator 320, a network facilitator 322, an item classifier 324, a language model 326, an input-output prediction engine 328, a graph analyzer 330, a model manager 332, a record generator 334, a network graph data structure 336, and/or a system of record 338.

The set of processors 310 may be or include an application-specific integrated circuit (ASIC), a set of field programmable gate arrays (FPGAs), a set of digital signal processors (DSPs), circuits containing one or more processing components, circuitry for supporting a microprocessor, a group of processing components, or other suitable electronic processing components. In some embodiments, the set of processors 310 may execute computer code or modules (e.g., executable code, object code, source code, script code, machine code, etc.) stored in the memory 312 to facilitate the operations described herein. The memory 312 may be or include any volatile or non-volatile computer-readable storage medium capable of storing data or computer code.

One or more of the computing devices 304 or the data processing system 306 can include or utilize at least one processing unit or other logic devices such as a programmable logic array engine or a module configured to communicate with one another or other resources or databases to perform one or more of the operations described in this disclosure. As described herein, computers can be described as computers, computer devices, computing devices, or client devices. One or more of the computing devices 304 may each contain their own computer resources (e.g., processor, memory, etc.), share computer resources, or be part of a distributed computer system. The components of the computing devices 304 or the data processing system 306 can be separate components or a single component. The example system 300 and its components can include hardware elements, such as one or more processors, logic devices, or circuits. The computing devices 304 or the data processing system 306 can each be a server or computer that is configured to store various types of data, such as data stream data, image data, audio data, other types of content data, etc. For example, the computing devices 304 or the data processing system 306 can each store records for different accounts in memory (e.g., in a database in memory), where such media may include non-transitory machine-readable media used to store program instructions for performing one or more operations described in this disclosure.

The record collector 314 may include instructions that, when executed by the set of processors 310, cause the set of processors 310 to aggregate and retrieve or receive data from different sources, such as the computing devices 304. The record collector 314 may perform such operations by implementing various retrieval methods such as polling, change data capture (CDC), or event-driven mechanisms to fetch real-time data updates. For handling real-time data collection, the record collector 314 may employ message queues like Apache Kafka or RabbitMQ to buffer incoming data streams and prevent data loss during high-volume periods. In some cases, the record collector 314 can receive and/or manage data reception of electronic documents or records that the computing devices 304 transmit to the data processing system 306.

The record collector 314 may store the collected electronic documents or records within the system of record 338. The collected records may be stored in a structured manner, enabling efficient indexing, querying, and retrieval of information. For example, the computing devices 304 of the different facilities involved in one or more value chains may transmit records to the data processing system 306. Examples of records that the data processing system may receive can include, in addition to any other types of records:
Manufacturing facility records, such as production run reports, quality control data, defect logs, maintenance schedules, machine downtimes, and resource utilization reports.
Warehouse and inventory management records, such as detailed inventory counts, storage condition logs (e.g., temperature and humidity readings), product expiration dates, batch numbers, incoming delivery details, and outbound shipment data.
Logistics and transportation records, including shipment tracking records, freight bills, customs declarations, delivery confirmation receipts, transportation delay reports, real-time GPS coordinates, carrier performance metrics, and incident or accident documentation.
Records relating to retail or distribution centers, such as inventory sales data, return processing documents, reorder logs, store stock levels, and customer demand forecasts.
Event-driven notifications, such as alerts of supply chain disruptions, inventory shortages, equipment failures, or transportation route changes.
Operational transaction data, including purchasing or procurement orders, invoice records, payment confirmations, and financial transaction logs.
Compliance or regulatory records documenting adherence to applicable regulations, standards, certifications, inspection reports, and audit trails from each facility.
Ownership/directorship information, including ownership and directorship by companies and individuals. Moreover, the sanctioned/denied/risk status of these related entities, their physical locations, nationalities, and similar information.
Records including sanctions lists, denied party lists, geographic information (e.g., if a network operation is a denied or sanctioned region), etc.
   The record collector 314 may receive such records as sets of data or electronic documents or files and store the records in the system of record 338.

In one example, the record collector 314 can be, include, or interface with an application programming interface (API) that facilitates communication between the data processing system 306 (e.g., via the communication interface 308 of the data processing system) and other computing devices, such as the client device 302 and/or the computing devices 304. The record collector 314 may communicate with the client device 302 and/or the computing devices 304 across a network.

For instance, the record collector 314 can establish a connection with one of the computing devices 304. The record collector 314 can establish the connection with the computing device 304 over the network. To do so, the record collector 314 can communicate with set of servers across the network. In one example, the record collector 314 can transmit a syn packet to the computing device 304 (or vice versa) and establish the connection using a TLS handshaking protocol. The record collector 314 can use any handshaking protocol to establish a connection with the computing device. The data processing system 306 can communicate with the computing device over the established connection.

Over the established connection, the computing device 304 can transmit one or more records for a facility. The records can include, for example, one or more shipment tracking records, bills of materials, freight bills, delivery confirmation receipts, transportation delay reports, real-time GPS coordinates, carrier performance metrics, or incident or accident documentation. The record collector 314 can receive the records and store the records in the system of record 338.

The record parser 316 may include instructions that, when executed by the set of processors 310, cause the set of processors 310 to parse the records received by the record collector 314 and/or retrieved from the system of record 338. In some cases, the record parser 316 can parse the records using machine learning (including techniques such as natural language processing, image processing, and usage of contextual graph information) techniques, such as by extracting relevant operational data elements and facility-specific details from the electronic records transmitted by computing devices 304 of different facilities within the value chain. For example, the record parser 316 may use natural language processing techniques such as named entity recognition to identify (e.g., automatically identify) facility names, locations, equipment identifiers, product batch numbers, or shipment tracking numbers from textual records. Relationship extraction methods may be employed to identify connections between different entities, for instance, associating product batch information with manufacturing dates, quality inspection results, or origin/destination details from logistics records. Additionally, the record parser 316 may apply text classification or rule-based parsing methods to categorize records based on facility roles (e.g., manufacturing, warehousing, transportation, etc.). In some cases, the record parser 316 can normalize extracted data into standardized formats to aggregate, index, analyze, and report across datasets from multiple facilities consistently and efficiently. In some embodiments, domain-adapted machine learning models trained specifically on facility-generated documentation and supply chain terminology may further enhance the parsing accuracy and comprehensiveness of the data extraction process. The record parser 316 can identify or extract such information from the different records and store the extracted or identified data in the system of record 338.

The system of record 338 can be a relational or any other type of database that is configured to store records collected by the record collector 314 and/or data parsed or extracted from such records by the record parser 316. The system of record 338 may store structured and normalized operational data parsed from electronic records transmitted by computing devices 304 associated with facilities throughout the value chain. Examples of such operational data stored in the system of record 338 may include production run details, quality inspection results, detailed inventory levels, shipment tracking logs, logistics incidents and delays, product batch identifiers, facility locations, and transactional or compliance documentation. By maintaining this comprehensive and structured data repository, the system of record 338 can facilitate the data processing system 306 performance of efficient support queries, analytics, reporting, real-time decision-making, and/or proactive management of the overall value chain operations. The system of record 338 can also be configured to provide interfaces or data-access layers that allow other components or services within or external to the data processing system 306 to easily access and retrieve such stored information for downstream processing, visualization, or further analysis. In some cases, the system of record 338 can include the network graph data structure 336 and/or include different notes or comments about the network graph data structure 336.

The graph generator 318 may include instructions that, when executed by the set of processors 310, cause the set of processors 310 to generate the network graph data structure 336. The graph generator 318 can generate the network graph data structure 336 based on (e.g., based only on) records and/or parsed data stored in the system of record 338. For example, from the stored records and/or parsed data, the graph generator 318 can generate one or more nodes that each represent a different facility that is involved in at least one value chain. The graph generator 318 can generate edges between pairs of nodes representing pairs of facilities that represent or indicate the transportation of networked items or components used to create or transform individual the networked items. An edge between a pair of nodes representing a pair of facilities can indicate the output from one facility of the pair of nodes that is input into another facility of the pair of nodes. The graph generator 318 can additionally or instead generate nodes that represent different networked items (e.g., items that are transformed and/or transported across a value chain). The graph generator 318 can generate edges between the nodes for the networked items to the facilities that are involved in the transportation and/or creation of the respective networked items. The graph generator 318 can generate the edges by storing identifications of the nodes connected by the edges in the respective nodes. The graph generator 318 generate the nodes and/or edges between nodes in the network graph data structure 336.

The network graph data structure 336 can be or include a graph data structure configured to store different nodes of value chains for different networked items. The nodes can each be or include a separate data structure with node field-value pairs that each correspond to a different type of data regarding a facility represented by the node. For instance, the individual nodes can each include node field-value pairs for a name or identifier of the facility represented by the node, a type of node (e.g., manufacturing, warehousing, transportation, etc.), a description of the function of the node, a location (e.g., geographic location) of the node, a region of the node, an owner of the node, etc. Each node field-value pair can include an identification of the type of the node field-value pair and a value for the node field-value pair. The graph generator 318 can identify values for the node field-value pairs from the records and/or parsed data of the system of record 338 and store the values in the corresponding node field-value pairs.

The network graph data structure 336 can be or include one or more sub-graph data structures 340. Each of the sub-graph data structures can represent a value chain for generating a networked item. For instance, each sub-graph data structure 340 can be linked by an edge with a profile data structure or networked item profile 342 for a networked item that is generated by a value chain that the sub-graph data structure 340 represents. The individual sub-graph data structures 340 can each include a chain of nodes. The chain of nodes can be or include a sequence of connected nodes forming a path of one or more instances of the networked item from a source node (e.g., a source node or initial node of the chain of nodes or the sub-graph data structure 340) to a destination node (e.g., a destination node or last node of the chain of nodes or the sub-graph data structure 340). The path can represent network operations of one or more instances of the networked item through the sequence of connected nodes. In some cases, each node of the sequence of connected nodes represents an entity performing a network operation on the one or more instances of the networked item. Each edge between one or more pairs of the sequence of connected nodes can represent movement, transfer, or transport of the one or more instances of the networked item from a first node (e.g., a source node) of the pair of nodes to a second node (e.g., a destination node) of the pair of nodes.

In some cases, the graph generator 318 can perform entity resolution techniques to modify the network graph data structure 336. For example, the graph generator 318 can extract of facility-related references from electronic records parsed by the record parser 316. For instance, the record parser 316 can identify a facility's name, location, and equipment identifiers from shipment tracking logs and quality inspection reports. Once these references are extracted, the graph generator 318 can move to a resolution phase. In the resolution phase, the graph generator 318 can match each extracted reference to existing entities within the system of record 338 or, if no match is found, create a new entity to represent the facility or item. The graph generator 318 can generate nodes in the network graph data structure 336 for new entities that the graph generator 318 identifies. In doing so, the graph generator 318 can ensure that each node in the network graph data structure 336 corresponds to a unique, defined entity, minimizing duplication and enabling accurate representation of relationships within the network graph data structure 336.

The digital record generator 320 may include instructions that, when executed by the set of processors 310, cause the set of processors 310 to generate networked item profiles 342 and/or networked item digital records (e.g., passports) for different networked items for which value chains are represented in the network graph data structure 336. The networked item profiles 342 can be or include nodes or profiles that store data the networked items represented by the networked item profiles 342. For example, the networked item profiles 342 can be or include separate data structures that represent the respective networked items. The data structures can each be or include one or more attribute field-value pairs that each correspond to attributes of the respective networked items. Examples of attribute field-value pairs can include classifications, carbon footprint for manufacturing the networked items., revenue, origin, etc. The digital record generator 320 can generate networked item profiles 342 for different networked items using data stored for the networked items from the system of record 338. The graph generator 318 can store the networked item profiles 342 in the network graph data structure as profiles 342 as nodes of the network graph data structure 336. In doing so, the graph generator 318 can generate edges between the networked item profiles 342 and nodes representing facilities (e.g., the origin or initial facilities) of value chains involving the networked item or that are used to generate networked items of the respective networked item profiles 342.

The digital record generator 320 can generate networked item digital records for different networked items. The networked item digital records can be or include a view into the network graph data structure 336 that includes one or more sets of nodes or sub-graph data structures indicating one or more value chains of the networked items associated with the networked item digital records. The networked item digital records can each correspond to one or more networked items. The digital record generator 320 can generate the networked item digital records to each have a unique identifier (e.g., a passport identifier or a digital record identifier) that operates as an address for the networked item digital record. The digital record generator 320 can generate the networked item digital records to include identifications of one or more networked item profiles 342, identifications of individual nodes, and/or identifications of different sub-graph data structures or value chains for networked items. In some cases, the networked item digital records can include the profiles, nodes, and/or sub-graph data structures themselves.

The digital record generator 320 can generate the networked item digital records based on user selections that the digital record generator 320 receives, such as from the client device 302. For example, a user can provide an input to generate a networked item digital record for a networked item. The user can then provide an input selecting a networked item profile for the networked item and one or more sub-graph data structures indicating sets of nodes representing value chains in which the networked item is involved. The digital record generator 320 can receive the selections and generate a networked item digital record for the networked item by generating an identifier for the networked item digital record as well as identifying identifiers for each of the selected networked item profile and the sub-graph data structures and/or nodes of the sub-graph data structures. The digital record generator 320 can store a file including the identifiers and/or the data structures of the selected networked item digital record and the sub-graph data structures or nodes. The digital record generator 320 can store the file in the network graph data structure 336 as one of a plurality of networked item digital records 344.

The network facilitator 322 may include instructions that, when executed by the set of processors 310, cause the set of processors 310 to facilitate the transfer of networked items across a network nodes. The network facilitator 322 can do so, for example, by responding to requests from computing devices regarding whether networked items satisfy a set of rules. For instance, the network facilitator 322 can store a set of rules that indicate criteria that networked items can satisfy during the transfer or transportation of the networked items between facilities, in some cases across the border. In response to a request, the network facilitator 322 can identify a networked item digital record for the networked item from the network graph data structure 336. The network facilitator 322 can identify the networked item digital record, for example, by identifying the networked item digital record based on the networked item digital record containing an identification of the networked item or by identifying an address of the networked item digital record that was contained in the request. The network facilitator 322 can retrieve the networked item digital record and identify a networked item profile for the networked item and/or the nodes containing data regarding one or more transformations and/or transportations of the networked item. The network facilitator 322 can retrieve data from the respective profiles and/or data structures. The network facilitator 322 can apply the set of criteria to the retrieved data to determine whether the data for the networked item satisfies the set of criteria. Responsive to determining the set of criteria is satisfied, the network facilitator 322 can generate a flag indicating the transfer or transport of the networked item is allowed. Otherwise, the network facilitator 322 can restrict the transfer or transport of the networked item by generating an alert or otherwise operating a machine to restrict the movement of a vehicle from transferring or accepting the networked item.

The item classifier 324 may include instructions that, when executed by the set of processors 310, cause the set of processors 310 to generate classifications for networked items. The item classifier 324 can generate classifications for networked items in response to requests from computing devices, such as the client device 302. For example, the item classifier 324 can receive a request containing an identification of a networked item. The request can be for a classification (e.g., a harmonized system (HS) code for the time) for the networked item. The item classifier 324 can receive the request and identify one or more sub-graph data structures from the network graph data structure 336 that correspond to the networked item (e.g., correspond to facilities that facilitate the transformation and/or transport of the networked item and/or components of the networked item). The item classifier 324 can use edges between the sub-graph data structures to identify different information about the networked item, such as a source node (e.g., source facility) for the networked item and/or a destination node (e.g., a destination facility) for the networked item.

The item classifier 324 can use the retrieved data from the network graph data structure 336 to generate either a prompt or a prompt augmented for the language model. The language model 326 can be or include a large language model, a transformer, a neural network, etc., that is trained to generate responses to input containing different types of content, such as images, text, or videos. The item classifier 324 can generate a prompt containing the identification of the networked item and/or any information retrieved from the network graph data structure 336 regarding the networked item in response to the request. In some cases, the item classifier 324 can include features (e.g., textual, numeric, categorical, graph-based features, or image features) of the networked item in the prompt. This description may be augmented with graph context (buyers and suppliers of the good, their extended relationships) as well as characteristics such as the weight, value, and similar of the good. The item classifier 324 may receive the description in the request or by retrieving the text description from the networked item profile for the networked item stored in the network graph data structure 336. The item classifier 324 can generate such a prompt and input the prompt into the language model 326. The item classifier 324 can execute the language model 326 based on the input to cause the language model 326 to output a classification for the networked item and/or a confidence score for the classification for the networked item.

The item classifier 324 can compare the confidence score for the classification to a threshold. Responsive to determining the confidence score exceeds the threshold, the item classifier 324 can generate a visual representation of the classification and/or the confidence score for the classification. The item classifier 324 can transmit the visual representation of the classification to the client device that transmitted the request.

In cases in which the item classifier 324 determines the confidence score is less than the threshold, the item classifier 324 can retrieve further information regarding the networked item. The item classifier 324 can do so, for example, by querying a network (e.g., the Internet) for one or more databases that store data regarding networked items that contain matching identifiers to the identifier received in the request. The item classifier 324 can retrieve information regarding the networked item from such databases enrich the prompt with the retrieved data. The item classifier 324 can input the enriched prompt into the language model 326 and execute the language model 326 to generate a classification and/or a confidence score for the classification. The item classifier 324 can repeat this process any number of times until determining or identifying a confidence score for a classification that exceeds the threshold.

The item classifier 324 can use any type of machine learning model to generate classifications for networked items of network operations. The item classifier 324 can do so using the retrieved data from the network graph data structure 336. The item classifier 324 can use the retrieved data to generate a feature vector for input into any type of machine learning model. For example, the item classifier 324 can generate a feature vector of numeric values from the records. The item classifier 324 can do so by inserting extracted numeric values from the records and/or converting text or other attributes from the records into the numbers for inclusion in the feature vector. The item classifier 324 can insert the feature vector into a neural network configured or trained to generate classifications of network items of networked operation. The item classifier 324 can execute the neural network based on the input to cause the neural network to generate a classification for the networked item and a confidence score for the classification. Responsive to determining the confidence score does not exceed a threshold, the data processing system can retrieve further data about the networked item and execute the neural network again to determine a classification and a new confidence score. The data processing system can repeat this process until identifying a classification and a corresponding confidence score that exceeds or satisfies a threshold. The item classifier 324 can use any type of machine learning model for classification.

The input-output prediction engine 328 may include instructions that, when executed by the set of processors 310, cause the set of processors 310 to generate predictions for inputs and/or outputs of nodes of the network graph data structure 336. For instance, the input-output prediction engine 328 can be or include one or more machine learning models (e.g., neural networks, support vector machine, random forests, etc.) that are each configured to generate a prediction regarding an input to a node and/or an output of a node. Examples of inputs can be or include different types of energy (e.g., coal, electricity, gas, etc.) the facilities represented by the nodes use for operation, the amount of energy the facilities use for a defined time interval, components that the facilities receive from other facilities, types of transportation through which the facilities receive inputs, the facilities that provide the inputs, etc. The outputs can be the types of networked items or components the facilities produce, environmental emissions or outputs the facilities produce, etc. The input-output prediction engine 328 can predict such inputs and/or outputs based on any type of data or metadata regarding the facilities, such as based on identification of the technology the facilities use, identifications of the inputs and/or outputs of the facilities, the number of employees, the geography or region of the facilities, the number of network operations that the facilities are involved in, etc. The input-output prediction engine 328 can generate predictions based on such inputs or outputs. The input-output prediction engine 328 can store the predictions in the data structures or nodes of the network graph data structure 336 for which the input-output prediction engine 328 generated the predictions.

In some cases, the input-output prediction engine 328 can store and/or include an input-output matrix. The input-output matrix can map input items with classifications or directly to determine relevance for target item generation. This matrix can operate as a lookup table that facilitates fast identification of pertinent input/output relationships without requiring extensive graph traversal. The system can perform classification-based queries against this matrix, in some cases using item classifications or other types of data (e.g., textual description, numeric characteristics, categorical values, and/or graph connections) as keys to identify which inputs should be included in or discarded from the sub-graph generation process. Generating and using the input-output matrix in this way can transform the conventionally recursive and computationally expensive process of dependent graph traversal into an efficient and direct lookup operation that scales with the size of the network graph data structure.

Additionally, the input-output prediction engine 328 can implement one or more semantic models, such as generative models, foundational neural net models, transformer models, convolutional or recurrent neural networks, BERT models, SBERT models, etc., that analyze textual descriptions of items to make more nuanced determinations about input-output relationships. These semantic models can provide an additional layer of intelligence beyond classification matching using the input-output matrix, facilitating the data processing system 306's ability to understand contextual relationships between items based on their descriptive content. The semantic analysis can aid in resolving ambiguous cases where matrix-based filtering alone might be insufficient, ensuring that the generated sub-graphs capture the most accurate and relevant dependency relationships for the corresponding target items.

Moreover, the model manager 332 can continuously increase the accuracy of the models involved in evolving operational environments through continuous learning. For example, the model manager 332 can train and retrain large language models or other type of machine learning model or generative model, including those with graph based and contextual features, using records of actual network operations and item transfers. The model manager 332 can use the trained large language models or machine learning models to enable the input-output matrix to adapt to changing operational patterns. This dynamic updating capability ensures that the sub-graph generation process remains accurate as new items are introduced, relationships change, or operational procedures evolve. The continuous learning approach prevents the degradation of system accuracy.

The graph analyzer 330 may include instructions that, when executed by the set of processors 310, cause the set of processors 310 to generate metrics for the network graph data structure 336. The graph analyzer 330 can generate the metrics for individual nodes in the network graph data structure 336, individual networked item profiles of the network graph data structure 336, individual sub-graph data structures of the network graph data structure 336, etc. The graph analyzer 330 can generate the metrics based on the data stored in the network graph data structure 336 for the respective nodes, sub-graph data structures, and/or networked item profiles. The graph analyzer 330 can generate the metrics and store the metrics in network graph data structure 336 and/or the system of record 338.

The model manager 332 may include instructions that, when executed by the set of processors 310, cause the set of processors 310 to generate manage the different computer models (e.g., optimization models, machine learning models, etc.) stored by the data processing system. The model manager 332 may execute and/or train the different machine learning models and/or other types of computer models to generate outputs based on data stored in the network graph data structure 336, the system of record 338, and/or any other data sources.

The model manager 332 may be or include a task agent that is configured to execute different applications and/or models stored by the data processing system 306 to perform different tasks. For instance, the task agent can be or include one or more large language models and/or other types of machine learning models. The task agent can determine the intents of queries (e.g., natural language queries) and use the intents to determine one or more tasks to perform. The task agent can identify a relevant sets of instruction, model, and/or application of the components 314-330 and/or 334 to use to perform a task, execute the identified set of instructions, model, and/or application, determine if the task are completed based on the execution, identify another set of instructions responsive to determining the task is not completed, and repeat this process until determining the task and/or each task is completed, model, or application or applications.

The model manager 332 may include a model 333. The model 333 can include one or more of the models described herein as being processed or executed by the data processing system 306, such the language model 326 and/or the models for classification of the input-output prediction engine 328. The model manager 332 can execute and/or train the model 333 to perform different tasks, such as classifying networked items, generating risk scores for network operations, generating risk scores for entity nodes, etc. The model manager 332 can train such models using data from the network graph data structure 336 and/or ground truth information (e.g., from the network graph data structure 336 or from another source, such as the system of record 338 or an external database or data source). The model manager 332 may do so as a task agent or any type of model or application that the data processing system 306 can execute.

The record generator 334 may include instructions that, when executed by the set of processors 310, cause the set of processors 310 to generate records (e.g., user interfaces, databases, tables, files, etc.). The record generator 334 can generate records containing data that is requested by different computing devices. In some cases, the record generator 334 can generate the records to include data generated by one or more of the network facilitator 322, the item classifier 324, the language model 326, the input-output prediction engine 328, and/or the graph analyzer 330. The record generator 334 can (e.g., through the record collector 314) transmit such records to the requesting computing devices and/or store the records in the system of record 338 and/or the network graph data structure 336.

FIG. 3B illustrates an example of the network graph data structure 336 storing nodes representing the networking of the transportation and/or transformation of different networked items across a network, in accordance with an implementation. As illustrated, the network graph data structure 336 can include one or more nodes 346a-g (individually, node 346 and together, nodes 346) that represent different facilities. The nodes 346 can be connected by edges that each represent network operations (e.g., transfers, transformations, or transportation instances) between the respective nodes 346. The nodes 346 can each include one or more node field-value pairs for different types of characteristics or attributes of the facilities represented by the nodes 346. The nodes 346 can include one or more attributes such as, for example, name, location, region, function, owner, type, etc.

The edges of the network graph data structure 336 can be or include data structures (e.g., edge data structures). For example, the edge data structures can each include one or more edge field-value pairs for different types of characteristics or attributes of the network operations represented by the edges. The edges can include one or more attributes such as, for example, identifier or name of the networked item being transported or transferred, quantity (e.g., number of networked items of a shipment and/or weight of an individual network item and/or weight of the total networked items being transferred in the network operation), a time and/or date of the network operation, a classification (e.g., an HS classification) of the networked item, a description (e.g., a text string description) of the networked item, a method of transport, etc. The edge data structures can each include identifiers of the nodes that the edges are connecting, in some cases forming the edge in a structured manner.

### Master Data Objects

The network graph data structure 336 can include master data objects that store data for specific types of networked items represented in the network graph data structure 336. Non-limiting examples of networked items for which the network graph data structure 336 may store master data objects include products, organizations, locations, customers, users, suppliers, orders, directors, shareholders, shipments, and customs entries. Details regarding these data objects are below.
Product
   The “output” Product is the primary focus in the Catalog and in the overall value chain management system design
   Input Products are also linked to the output Product via a Bill of Materials
   Products can be linked across value chains networks, and specifically through the Systems of Record of “active” registered organizations, via product passports
   Attributes
      Revenue (for output Products)
      Spend (for input Products)
      Bill of Materials
      Certificate of Origin
      Free trade agreement qualification
      Product Carbon Footprint
      HS codes (by jurisdiction)
      Duty/tariff owed by jurisdiction and date
      Deforestation impact
      Forced labor risk
      Material Safety Data Sheet
      Third Party Certifications
      Images
      Reports/Attestations generated within the system
      The system ID and system-generated QR Code
      Any other attributes can be specified by users involved (e.g., the parties involved) in the need for the product passport.
Organizations
   Registered Organization
      This organization type is meant to capture the general sense of a “counterparty” entity in a global b2b or B2g interaction. I sell to Crystal and Stone Co., and not the Smith family. I import my goods with the customs agency and not the government. I buy jet engines from Acme Co. and not the parent company Globex. I fly on Jets Airways and not the regionally-licensed subsidiary.
      Registered organizations include 1) any customer-provided company counterparty node listed in their Catalog, and/or 2) system-created registered organizations generated through AI systems operating on customer and third party data, but not in reliance on, or re-constituting, any one corporate firmographic dataset.
         Registered organizations can have one or more Legal Organizations, Legal Entities, and Facilities linked to them.
      Government, non-profits, academic institutions, etc. can be registered organizations—not just corporate entities
      Attributes of registered organizations:
         Website
         Brands
         Legal Organizations linked through ownership
         Facilities
         User registries
         Sanctions/denied party status
         Revenue
      A canonical legal entity provided by a third party corporate register
Locations
   Facility
      A system-generated entity that is comprised of a 1) physical address, and 2) a business relationship edge (mostly shipments, but summary buyer-supplier edges work too)
   Area
      Polygon
      Attributes:
         Land use
         Deforestation risk
Customers
   Customers are registered organizations, and can be linked to one or more output Products in the Catalog
Suppliers
   Suppliers are registered organizations, and can be linked to one or more input Products in the Catalog
Orders
Shipments
Customs Entries

### Insight Objects

The network graph data structure 336 can include or be associated with insight objects. The insight objects can store data generated from metrics or analytics performed on the nodes or objects of the network graph data structure 336. Examples of insights for which the network graph data structure 336 may store insight data objects include exposure, event, opportunity, and change. Details regarding these data objects are below.
Exposure
   Compliance risk
   Business interruption risk
   Geopolitical risk
Event
   AI event
      Subcategories thereof
   System network event
      Placeholder for events we generate off of the network graph data structure 336 and/or network
Opportunity
   Placeholder for an insight type that is an opportunity, such as a “recommended supplier” or “recommended customer”
Change
   A graph change that affects a customer's VC network

### Task Objects

The network graph data structure 336 can include or be associated with task objects. The task objects represent or include data for any type of data object of the network graph data structure 336 or associated with the network graph data structure 336. In some cases, task objects can be grouped or linked into a larger “job” data structure representing different actions to be performed to accomplish a job associated with the job data structure. Details regarding task data objects are below.
Tasks can be collaborative pages that allow for internal and external collaboration/communication and role-based abilities to:
   Edit, annotate, and append Master Data Objects
   Disposition Insight Objects
   Share or request Passports, including designating data and documents to share or request within the Passport
Examples of tasks can include
   Exposure Assessment, which may be subdivided into two tasks that include:
      Network Validation
      Exposure Validation
   Event Assessment, which may be subdivided into two tasks that include:
      Network Validation
      Event Characterization
   Duty/tariff assessment
   Free trade agreement qualification
   Proving deforestation free production
   Calculating and proving embodied carbon impact
   Classification
   Connection
      Facilitation (cross-border voluntary trade facilitation)
      Survey (upstream and downstream data gathering)
      Reporting (customer and/or regulator) as recipient
   Screening
      For screening entities not in my System of Record for exposures
   Network Update
      Network Validation action associated with a Change insight

In some cases, the data processing system may include different AI agents that facilitate users requesting an agent to establish or generate a workspace or different tasks.

FIG. 3C illustrates another view of the network graph data structure 336 storing nodes representing the networking of the transportation and/or transformation of different networked items across a network, in accordance with an implementation. As illustrated, the network graph data structure 336 can include one or more sub-graph data structures 348a-b, 350, and 352. Each sub-graph data structure can represent or otherwise correspond to a value chain including a path for generating a respective networked item.

The respective sub-graph data structures 348a-b, 350, and 352 can each include a chain of nodes that represent different locations of facilities of a path for generating a networked item. For example, the sub-graph data structure 348a can include nodes 360a-e (together, nodes 360, and, individually, node 360). One or more, or all, of the nodes 360 can be the same as or similar to the nodes 346. The nodes 360 can be linked by edges to indicate the outputs and/or inputs of the nodes 360 to other nodes of the sub-graph data structure 348a to generate a networked item. The nodes 360c, d, and e can each be a source node of the sub-graph data structure because the nodes 360c, d, and e do not receive any inputs from another node (e.g., specifically for the sub-graph data structure 348a). The node 360a can be the last facility (e.g., the destination node) of the value chain represented by the sub-graph data structure 348a because the node 360a may not provide any inputs to another node of the sub-graph data structure 348a. The destination node 360a can be linked with a node 354 associated with the networked item generated by the value chain of the sub-graph data structure 348.

The sub-graph data structure 348b can be configured in a similar manner to the sub-graph data structure 348a. For example, the sub-graph data structure 348b can include nodes 366a-f (together, nodes 366, and, individually, node 366). One or more, or all, of the nodes 366 can be the same as or similar to the nodes 346. The nodes 366 together can represent a value chain for generate the same networked item as the nodes 360 of the sub-graph data structure 348a. The nodes 366 can include one or more common nodes (e.g., the same node) to the nodes 360, such as nodes that are configured to generate the same outputs as each other. The sub-graph data structure 348b can be linked with the node 354 for the profile of the networked item that the nodes 366 are configured to generate together.

A document 420a can be linked with the node 366a of the sub-graph data structure 348b and/or a document 420b can be linked with the node 366e of the sub-graph data structure 348b. The document links are optional. More or fewer document links with nodes can be included than shown. The documents 420a and/or 420b can be records (e.g., electronic records) that were used to generate the respective nodes 366a and/or 366e. For example, the documents 420a and/or 420b can be or include attestations about the nodes 366a and/or 366e, attestations about networked items and/or outputs generated by the nodes 366a and/or 366e, bills of materials provided or associated with the respective nodes 366a and/or 366e, or any other types of documents or electronic records containing data about the respective nodes 366a and/or 366e and/or from which the data (e.g., attributes) of the nodes 366a and/or 366e was generated.

The sub-graph data structure 350 can be configured in a similar manner to the sub-graph data structure 348a. For example, the sub-graph data structure 350 can include nodes 368a-e (together, nodes 368, and, individually, node 368). One or more, or all, of the nodes 368 can be the same as or similar to the nodes 346. The nodes 368 together can represent a value chain for generating or creating the same networked item as the nodes 360 of the sub-graph data structure 348a. The nodes 368 can include one or more common nodes (e.g., the same node) to the nodes 360, such as nodes that are configured to generate the same outputs as each other. The sub-graph data structure 350 can be linked with the node 356 for the profile of the networked item that the nodes 370 are configured to generate together.

The node 368a can be connected with the node 356 for the profile of the networked item that the nodes 368 are configured to generate together. The node 368a can be connected with the node 356 by an edge 371. The edge 371 can be or include a data structure (e.g., an edge data structure) that is configured to identify the type of the connection. In this case, the edge 371 can store data indicating that the node 368 is the final node of the sub-graph data structure 350, an identifier of the sub-graph data structure 350 itself, an identifier of the networked item generated by the sub-graph data structure 350, an indication that the edge connects a node for a location or facility of the sub-graph data structure 350 with a node for a profile (e.g., a profile node) instead of representing a network operation, etc. The different sub-graph data structures 348a, 348b, and/or 352 may each be connected with a node for a profile of a networked item with a similar edge to the edge 371.

The nodes 368b and 368c may be connected by an edge 369. The edge 369 can be or include a data structure (e.g., an edge data structure) that includes data indicating a network operation between the entity represented by the node 368c (e.g., a source node) and the entity represented by the node 368b (e.g., a destination node). The network operation can be a transfer or a transportation of an instance of the network item (e.g., a portion of the networked item that will be eventually be transformed into the networked item or the networked item itself) from the entity of the node 368c to the entity of the node 368b. Together, the nodes 368b and 368c can be a pair of nodes because they are connected by an edge (e.g., the edge 369). The nodes 368b and 368c can be connected by any number of edges, as each edge may correspond to a different network operation. In some cases, the nodes 368b and 368c may be connected by different sets of edges that each correspond to a particular sub-graph data structure. Such may be the case when the nodes 368b and 368c are connected to generate different networked items as part of different value chains (e.g., in different sub-graph data structures). Thus, the edges may be specific to the sub-graph data structures in which the edges are depicted. The nodes of the different sub-graph data structures 348a, 348b, and/or 352 may respectively be connected with each other with edges similar to the edge 369.

The sub-graph data structure 352 can be configured in a similar manner to the sub-graph data structure 350. For example, the sub-graph data structure 352 can include nodes 370a-e (together, nodes 370, and, individually, node 370). One or more, or all, of the nodes 370 can be the same as or similar to the nodes 346. The nodes 370 together can represent a value chain for generate the same networked item as the nodes 368 of the sub-graph data structure 350. The nodes 368 can include one or more common nodes (e.g., the same node) to the nodes 370, such as nodes that are configured to generate the same outputs as each other. The sub-graph data structure 352 can be linked with the node 358 for the profile of the networked item that the nodes 368 are configured to generate together.

FIG. 3D is a sub-graph data structure 372 that represents an example value chain for the production of networked items (e.g., vehicle gearboxes). The sub-graph data structure 372 can represent supply and consumption tiers for generating or creating networked items and then distributing the generated networked items, in some implementations. For example, the sub-graph data structure 372 can include supplier nodes 346m-o that provide inputs to supplier nodes 346k-1 as indicated by the edges and arrows between the nodes 346m-o and the nodes 346k-l. The supplier nodes 346k-1 can use or transform the inputs to generate outputs that are input into the nodes 346i-j. The nodes 346i-j can use or transform the inputs to generate outputs that are input into the node 346h, as the source entity node. The source entity node 346h can generate the networked items 347 based on (e.g., by transforming) the inputs from the nodes 346i-j. The source entity node 346 can transfer the networked items 347 to nodes 346e-f The nodes 346e-f can distribute or transfer the networked items 347 or a transformed version of the networked items 347.

The data processing system 306 can implement the systems and methods described herein to generate the network graph data structure 336 representing one or more value chains in the sub-graph data structures 340, such as sub-graph data structures 340 with the following characteristics:
Accurate: The network graph data structure 336 may accurately describe the physical production and transportation processes, even if they are described in disparate messy documents in multiple languages.
Granular down to the part-site level: the part-site level is necessary to truly manage supply chains. Previous approaches have focused on the business network level or connection level, but these approaches fail to understand the fundamental physicality (locations and products) of the underlying value chains. The network graph data structure 336 may include specific details to ascertain what was the specific flow of a given product from raw materials to production, distribution, and sale. Failure to achieve this part-site level view results in such high levels of false-positives (erroneous links) that value chain analysis is impossible—participants are stuck in a mire of analyzing irrelevant business relationships.
Dynamically updating: the supply chain is constantly changing. To provide actionable intelligence, the network graph data structure 336 may evolve as production networks, site locations, and corporate relationships evolve. Thus, the system can automatically update while not losing track of relationship histories.
Consistent: To facilitate collaboration between participants whether their role in a value chain is suppliers, buyers, transporters, regulators, banks, insurers, or more, all participants may operate on a shared source of truth. One-off customer specific representations may fail to enable value chain management—they cannot be used as a basis for collaboration. The supply chain graph has to be consistent and linkable across all parties.
   To achieve these attributes the network graph data structure 336 may have the following characteristics.
1. Assembly: The intelligence on global value chains be assembled while respecting data sovereignty, security, and privacy. In other words, the system can have shared value-chain intelligence without sharing data.
2. Construction: The information can be harmonized into a network representation with the correct nodes and links.
3. Customization: Users can customize the resultant value chain maps with their organization specification information, groupings, and similar.
4. Value-chain specificity: The information can allow understanding of specific value chains at the part-site level of understanding. In other words, value chain understanding that is not at the company level, but rather facility-to-facility network operations can be understood in the context of the inputs they provide for the final product.

Nodes may include not only companies, but facilities, ports, products, individuals, vessels, countries, geographies, and more. Edges may cover movement of goods, locations of facilities, ownership of companies, directorship of companies, and more. Value chain management can include constructing a network graph data structure that covers more than just corporate relationships, but also the fundamental input-output relationships of product production. Such a part-site specific graph may allow part-site specific understanding of value chains at scale.

The network graph data structure 336 illustrated in FIGS. 3B and 3C can be constructed from both commercial and proprietary data. To do so, the system can obtain publicly and commercially available supply chain data. The system can focus upon datasets that describe physical movement of goods from facility to facility, rather than more abstract “business relationships.” In other words, documents such as bills of lading, manifests, customs declarations, and purchase orders. These documents can contain information on the sender, receiver, their addresses, the goods transported (both in free text and harmonized-system product category form), the ports, the vessels, and more. The system can augment the documents with commercially available information on corporate registries, embargoes lists, tariff incentives, free trade agreemtn qualification, and more. Such information can be identified with publicly/privately reported business relationships as appropriate.

However, public and commercially available data can be limited. For instance, such data may only be available for certain geographies and certain modes of transport. Operating on public data alone may not achieve the visibility necessary to solve the world's value chain problems—a disconnected, erroneous, or low-fidelity network doesn't help the participants. To understand value chains, system may need to be able to understand and connect the multiple stages of production from raw extraction through final distribution.

To do so, in some cases, the data processing system 306 can implement a federated system that permits each participant to have their own private “spoke” in which their data is secure and safe, but where derived analytics can be shared across desired participants. FIG. 3E demonstrates such a hub and spoke federated system 374, where all participants benefit from the derived analytics but sensitive information stays only with the participant that owns the information. Every participant can have a private enclave, in their jurisdiction of choice, where only they can see the entirety and fidelity of the data they put into the platform. Such participants are depicted in FIG. 3E as computing devices 304a-c, respective. Product details such as names, revenue, bills of materials, costs, supplier and customer experiences, and analytics on their supply chain are always private, never shared and only exist within each enclave. Third-party data procured by participants such as ESG scores, revenue importance, and custom calculations similarly privately enriches the individualized deployments. This functionality allows participants to wire in their own private information to the network graph data structure so they see a unified view of their world connected into the global map. Each participant benefits from seeing their data, kept for their private usage in their private enclave, bound to more visibility than any one country, let alone one company, has access to.

Participants can publish and share minimal information on linkages to allow mutual engagement and tracing of value chains. By sharing this minimal information on linkages, all participants can benefit from connectivity of the network graph data structure 336—the ability to traverse through multiple tiers. This connectivity can provide essential value to all participants, as it allows the participants to understand and manage their value chains across all stages of production. For this reason, the network graph data structure 336 can enable a collaborative supply chain graph, while preserving contributors' privacy, and competitive advantages.

The shared graph of intelligence assembled via the hub and spoke architecture can be constructed from documents with erroneous or woefully incomplete information. They frequently lack the detail necessary to go down to the part-site level. The data processing system can extract signal from the noise through the following steps: (1) recognizing and matching entities such as companies, addresses, ports, and products in many languages, robust to misspellings; identifying and correcting erroneous information, such as incorrect addresses, values, product categories (e.g., HS codes), and more; (2) imputing missing information, whether that is missing product categories, address components, values, or otherwise; and (3) solving these challenges can involve state-of-the-art machine translation, entity resolution, link resolution, deduplication, cross-linking of information, and domain specific optimizations to connect the data together in both a granular and scalable manner.

The data processing system 306 can leverage both classic machine learning and modern deep learning, including graph based approaches. Table 1 below provides an example of transformations of raw messy shipment information into canonicalized standardized representations.

| | | Canonicalized |
|---|---|---|
| Type | Original raw text | representation |
| Company | from warehaus rivilogistics by Globex | Globex |
| Company | [symbol] [symbol] | Acme Co. |
| Address | 2 a calle 8 s n 53370 naulcalpan de juarez | Calle 8 No. 2 A, Industrial |
| | naucalpan de juarez | Alce Blanco, Naucalpan De |
| | | Juarez, Mexico, 53370, |
| | | Mexico |
| Product | Ladies 90% cotton 7% tencel 3% elastane | 6204.62.8011 (US |
| | woven denim pant | Harmonized Tariff System |
| | | Code) |
| | | Articles of apparel and |
| | | clothing accessories, not |
| | | knitted or crocheted—women's |
| | | or girls' suits, |
| | | ensembles, suit-type jackets, |
| | | blazers, dresses, skirts, |
| | | divided skirts, trousers, bib |
| | | and brace overalls, breeches |
| | | and shorts (other than |
| | | swimwear):—trousers, bib |
| | | and brace overalls, breeches |
| | | and shorts: of cotton:—other: |
| | | other: other: other—other: |
| | | women's trousers and |
| | | breeches: blue denim (348) |
| Product | [symbol] | 3006.20.00 |
| | | (Gulf Cooperation Council |
| | | Harmonized System Code) |
| | | [symbol] |
| | | [symbol] |
| | | [symbol] |
| | | [symbol] Blood-grouping |
| | | reagents |

The data processing system 306 can perform the following operations to generate Table 1 and similar tables:
map the raw fields to standardized fields;
use one or more artificial intelligence (AI) systems to parse fields with multiple values (e.g., name+address) concatenated into one field;
use AI systems to structure unstructured fields (e.g., address not structured by administrative granularity) into structured representations (e.g., a structured address);
use AI driven search systems to take obscure/opaque/vague descriptions and expand them (e.g., take a goods description that is just a parts number from a company specific parts database and replace it with a detailed description of that product); and
use AI systems to match to canonical representations based on a semantic understanding of the entity (e.g., company, address, product) regardless of what language/misspellings it has.

The data processing system 306 can perform this canonicalization based on the features (textual, numeric, categorical, graph) and contextual information such as involved parties, involved products, etc., in the raw document. The end result is both a canonical description of the entity and a canonical ID by which the entity can be referenced. If no canonical entity already exists, the data processing system 306 can create one.

The data processing system 306 can identify and correct erroneous or missing information functions in a similar manner. For example, the data processing system 306 can use AI systems to predict the field's information. If it differs from the provided original information, the data processing system 306 can flag and correct the discrepant information (e.g., an erroneous product code or monetary value). If it's empty, the data processing system 306 can predict the correct value. In both cases, there is a measure of confidence in the prediction that is calibrated for at least a threshold accuracy/quality. One particularly notable correction is for supplier addresses. In some cases, customers have supplier lists that either have no address information or provide the supplier's HQ, not the true production facility address. The distinction, and the data processing system 306's systemic correction of this error can be used accurate construction of part-site specific value chains.

Users of the network graph data structure 336 may customize the network graph data structure 336 with their organization and user-specific information. Users may do so, for example, through:
1. Addition of organization-specific scores and values: For example, internal parts numbers for products, ESG scores for different facilities, previous return rates on investment in trade financement.
2. Organization/user-specific groupings of entities: the ability to group multiple entities (e.g., companies, facilities, products) represented in the network graph data structure into one grouping. For example, an organization may wish to see all the activity of a given supplier cohort grouped together, ignoring distinctions between the underlying companies.
3. Attachment of source documents and files: Backing files serving as backing information for the entities.
4. Storage of notes: Specific additional information provided by users and organizations on the entities.

The data processing system 306 can provide above capability in customer private-enclave-specific (e.g., spoke specific) instances. In doing so, the data processing system 306 can provide each customer with the capability to customize the network graph data structure 336 as necessary for their organization. The sensitive information described herein may stay in each private deployment and, in some cases may never transmitted back to the hub.

Additionally, understanding physical production and acting upon the physical production can require understanding the steps from raw material extraction through final distribution. Within their private enclave, customers may have their bill of materials for their products. However, they may not have the recursive bill of materials—the inputs for their inputs or the inputs resulting from their outputs. This information may be required to understand the original and intermediate processing that led to the product, as well as the intermediate and final consumption, as illustrated in FIG. 3D.

To construct this understanding, the data processing system 306 can integrate, in the private enclave, the customer's bill of material information. Combined with the customer's supplier list, this gives the first tier understanding of production facilities and inputs for each customer product. Then, the data processing system 306 can apply an AI-based understanding of input-output relationships to understand value chains to understand the network of production conditional on the good being produced. The data processing system 306 can use the network graph data structure 336 to filter a set of relationships to only include the value chain for a vehicle gearbox, for example, while disregarding all irrelevant links and associations related to other goods at the same facility. The data processing system 306 can do so by producing and applying a recursive map of the relationship between inputs and outputs, a function estimating the “bill of materials” for all physical goods. Using deep learning, graph information/modeling, and generative AI, the data processing system 306 can derive this input-output relationship for all goods, thus allowing the refinement of site-specific exchange of goods to be conditional on specific products. This understanding can then be refined, in some cases, by a human collaborating with internal and external parties.

The resultant graph of global value chains may be, post-harmonization, gigantic in size, in some cases including billions of transactions linking 100s of millions of entities. The data processing system 306 can identify the most relevant parts of the network graph data structure, individual entities, shipments or sub-networks (“sub-graph data structures”) involving companies, addresses, products, shipments, ports. The data processing system 306 can do so using cutting edge AI, exceptional engineering, deep product understanding, and insightful design to achieve these tasks. The underlying systems and industrial ecosystems represented by the network graph data structure are complex, and easy answers are uncommon. The data processing system 306 can implement the systems and methods described herein to generate and process the network graph data structure 336 for:
Compliance: Complying with and enforcing environmental (e.g., Scope 3, deforestation, etc.), human rights (e.g., forced labor), tax/tariff/duty, export controls, sanctions, national security, and other laws and regulation across multiple country's regulatory environments.
Sourcing and procurement: Analyzing existing and potential suppliers and buyers at scale across 10s of thousands or more relationships.
Resiliency: Proactively and reactively understanding potential disruption to value chains at the scale of multinational corporations or nations. Analyses include understanding bottlenecks, exposure to current or potential adverse events (e.g., a factory being destroyed), multi-tier exposure to geopolitically risk geographies, and more. Such resiliency is critical to continued corporate operation as well as economic and national security.
Insurance: Usage of the above resiliency information to offer and price novel forms of business-interruption coverage. Understanding resiliency at scale enables origination and pricing of insurance that could not profitably previously be offered due to lack of information on the extended value chain. Contingent business interruption insurance, insuring against extended disruptions in the value chain, was previously unavailable at desired volumes due to the difficulty of understanding extended value chain relationships. Insurers can now offer such insurance while understanding extended risk and concentrations, and insureds can benefit from the surety that such insurance brings.
Trade facilitation and prevention of illicit activity across borders: Logistics parties, multinational corporations, and governments can collaborate together to ensure facilitation of legitimate cargoes and targeting of illicit activity. Positive value chains are promoted and aided in filing of required paperwork, negative value chains (such as narcotics production) are impeded.

The data processing system 306 has several features that facilitates generation and processing of a network graph data structure that represents a real-time version of multiple value chains. For example, the data processing system 306 can use security features such that the represented data remains safe using information security programs, secure software development lifecycle, and segmenting customer accounts. The data processing system 306 may be deployed into various secure environments across the globe. These controls help service the goal of securing data.

Another advantage is that the system supports granular role-based access controls to put individual organization's administrators in control of who in the organization can see which details, as well as external collaboration with other parties.

In some cases, in the context of sensitive applications, the data processing system 306 can support selection and vetting of which specific users (e.g., government-associated users) can access private deployments. The most standard use case is for public sector deployments where all access must be done by vetted/security-cleared individuals, often from that nation.

In some cases, the data processing system 306 may never share raw data between spokes without explicit instructions for collaboration between trusted parties. The default may be that no direction is enabled. Rather, the system can facilitate sharing of network visibility, analytics, and shared AI models without moving raw data.

The data processing system 306 can provide individual customers a private enclave where they, and only they, can see the entirety of the data their organization puts into the platform. Product details such as name, revenue, bill of materials, costs, supplier and customer experiences, and analytics on the customer's supply chain are always private, never shared and only exist in the private enclave. They are processed and harmonized with the network graph data structure's broader multi-tier view while remaining within that individual enclave.

To facilitate the value chain network function, and connections between buyers and suppliers in multi-tier value chains, the data processing system 306 can facilitate minimal linkages necessary for engagement. After normalizing and canonicalizing the entities to the network graph data structure in the private-enclave, the data processing system 306 can anonymously connect the minimal details of a supply chain linkage to our central network graph data structure. These details include: the sender and receiver companies and locations; an intentionally vague description of the goods such as an HS code or summarized description; and the month of the transaction.

The source of the derived links derived via this canonicalization and anonymization may not be revealed to any other clients. This shared intelligence may allow each customer to in turn receive and connect to linkages provided by others.

The data processing system 306 can be, include, or otherwise interact with a federated learning system to generate the network graph data structure 336 and generate metrics and intelligence across users or entities. Federated learning is a field of machine learning focused on how to learn in a privacy preserving manner that does not share nor combine data. One example of use of federated learning is customization of suggestions when an individual types on a cell phone. The system learns across many devices by learning on the device and never transferring the raw data, only the trained model, back to a central hub. All users thus benefit without ever sharing any typing history such as passwords, loved ones' names, or full messages back to the cloud.

The data processing system 306 can implement federated learning across a number of features of generating and processing the network graph data structure 336. In doing so, the data processing system 306 can preserve user privacy while providing the benefits of aggregating data from a large number of data sources. Examples of how the data processing system 306 uses federated learning include the following:

Value chain construction: Many facilities receive shipments of coffee, but these are very unlikely to be relevant to a particular product's specific value chain for any product that is not in the coffee category. As such, the data processing system 306 can implement a process which smartly builds product value chains from the network graph data structure creating specific and granular understanding down to the material category, type of input (e.g., ingredients, capital goods, packaging). Customers can engage and refine these value chains which further contributes to quality of this machine learning construction. The customer provided feedback, as well as rich product descriptions, and relationships may all be private to the users that provide the data. The data processing system 306 can train across the feedback on those classifications in a privacy preserving manner and such that each user may benefit from other customers' refinements. This technique has shown significant improvement in quality of value chain construction both within and across industries when compared to expert review.

A value chain can be constructed as a network graph data structure to provide the technical foundations of value chain management. The network graph data structure can be used to identify missing information or deficiencies and identify risk probabilistically. Users can collaborate in a risk/impact-oriented manner on top of the network graph data structure For example, the network graph data structure 336 can be used to generate or support product passports and trade facilitation.

Harmonized System (HS) Classification: Assigning HS codes to products may determine tariff rates and other global trade related requirements. Determining the appropriate HS code for a product is difficult, however, and most practitioners outside of customs don't know how to classify products correctly. The data processing system 306 can include suite of tools for both assigning HS codes to products as well as explaining these according to the general rules of interpretation, and using previous CROSS/BTI rulings to support a classification. To properly do this requires detailed product descriptions that are private to individual users. As such, the data processing system 306 can use federated learning to achieve these processes, while preserving the privacy of users' information, and enabling users to benefit from other users' refinements of the classifications.

Tariff/duty calculation: assessing the correct tariff requires calculation based on the HS code, the country of origin, free trade agreement qualification, input material origin, and similar. The data processing system 306 uses federated learning to assemble all this information without compromising data privacy and security

Free trade agreement qualification: similarly, qualifying for a free trade agreement requires multi-tier understanding of the value chain of the goods, the companies, facilities, countries, and processes involved, and the production of a certified representation of the good's production and certification. The data processing system 306 uses federated learning to assemble all this information without compromising data privacy and security

Trust scores: Shipment fraud and illicit goods may affect all players in the logistics and shipping space. To facilitate cross border trade, the data processing system 306 can generate a trust score based on customers' shipment interdiction history, proximity to embargoes, shipper history, and other attributes. These details may be private to customer relationships, however, all participants in the space would benefit from being able to identify contraband and smuggling better. The data processing system 306 can use federated learning across our customers working in these areas to better identify shipment fraud and facilitate expedited clearance while preserving the privacy of specific customer history and never pooling any customer data together.

The hub and spoke of generating and processing the network graph data structure 336 can be applied for multiple internal departments/agencies to collaborate within or between governments. For example, the hub-spoke architecture described herein can facilitate secure collaboration within and across government agencies and governments themselves. The data processing system 306 can generate private copies of the entire architecture, and thus a private network/“intranet” of value chain information and collaboration may be generated. This architecture can thus enable collaboration between different departments/ministries without different rights to access different data. Furthermore, they can enable shared intelligence across national boundaries for sensitive national security and economic security use cases that require multi-national collaboration between cooperating/allied nations. Combined with the role-based access controls and government-ready secure deployments described above, the data processing system 306 can enable secure collaboration.

In some cases, the data processing system 306 may not synchronize any information, including derived information such as network visibility, analytics, or AI models, back to the hub from national deployments. In other words, national security users benefit from the platform provided by the data processing system 306 in support of their missions, and are given new abilities to collaborate with the private sector in service of security, economic growth, and resiliency through a shared source of truth, but maintain the classification levels and security of their agencies and departments.

In some cases, to preserve privacy and security, the data processing system 306 can transmit copies (e.g., versions, dedicated copies, dedicated version, etc.) of the network graph data structure 336 to the different computing devices 304 of the hub-and-spoke system. The copies can be dedicated copies for the respective computing devices 304, such that the computing devices 304 only receive data that the computing devices 304 are authorized (e.g., via stored permission of profiles for the computing devices 304) to receives. For example, the data processing system 306 can generate a copy 375 of the network graph data structure 336. The data processing system 306 can generate the copy 375 by identifying the data of the network graph data structure, such as the types of data, edges connected with specific nodes, specific nodes, etc., that the computing device 304d is permissioned or authorized to receive, view, or access. The data processing system 306 can identify such data by applying a schema or a set of rules or permissions stored in a profile for the computing device 304d or the entity associated with the computing device 304d. The data processing system can use such permissions to retrieve that that the computing device 304d is authorized to access, and generate a copy 375 of the network graph data structure 336 only with the retrieved data. The data processing system can transmit the copy 375 of the network graph data structure 336 to the computing device 304d. In this way, the data processing system 306 can preserve the privacy of certain types of data for different nodes, while still providing different spokes of the federated system with access to the network graph data structure 336.

By implementing the systems and methods described herein, the data processing system 306 can generate a network graph data structure using a hub-spoke federated learning system with privacy preserving techniques to provide industry-wide insights while protecting confidential information.

FIG. 3F illustrates an example flowchart of a process 376 for network graph data structure-based networking, in accordance with an implementation. A data processing system (e.g., the data processing system 306, shown and described with reference to FIG. 3A) can perform the process 376 to generate and/or update a network graph data structure representing the network between facilities for networked item transformation and/or transportation. The process 376 can include any number of operations or additional operations and the operations may be performed in any order.

At operation 378, the data processing system can receive one or more electronic records. The data processing system may receive the electronic records from one or more computing devices of different facilities that are involved in a network of value chains representing the transport and/or transformation of networked items.

At operation 380, the data processing system can parse the one or more electronic records. The data processing system can parse the records using natural language processing techniques and/or language processing models to identify specific entities or data included in the electronic records. The data processing system can store the parsed data in a database, such as a system of record that maintains the data for the network of value chains.

At operation 382, the data processing system can generate nodes in a network graph data structure. The data processing system can generate the nodes based on the electronic records and/or the parsed data such that each of the facilities corresponds to a different node in the network graph data structure. Each of the nodes can include node field-value pairs for different characteristics or attributes of the facilities represented by the respective nodes.

At operation 384, the data processing system can connect nodes in the network graph data structure. The data processing system can connect the nodes in the network graph data structure with edges. Each edge can represent a different network operation or transaction. For example, an edge between two nodes can represent transport of a networked item or component from one facility to another facility. The data processing system can generate any number of edges between pairs of nodes.

Each edge can be or include a data structure. The data structure can include data about the relationship indicated by the edge between the nodes. For instance, the data structure can include an identification of the networked item transported between nodes, a time and/or date of the transportation, a quantity, etc.

At operation 386, the data processing system can generate one or more networked item digital records. The data processing system can generate the networked item digital records in response to one or more requests to generate the passports, for example. The data processing system can generate a networked item digital record by identifying one or more nodes or sub-graph data structures of the network graph data structure to include in the networked item digital record. The data processing system can identify such nodes or sub-graph data structures based on identifications of the nodes or sub-graph data structures in a request. The data processing system can generate the networked item digital record to include identifications of each of the identified or nodes or sub-graph data structures and/or the data structures of the nodes or sub-graph data structures themselves. In some cases, the data processing system can include an identification of a networked item profile or the networked item profile itself in the networked item digital record. The data processing system can generate and store such networked item digital records in the network graph data structure or a separate database in a file. Subsequently, the data processing system can transmit the networked item digital record to another computing device to either provision the computing device with access to the data structures (e.g., the nodes, the networked item profiles, the sub-graph data structures, etc.) identified in the network graph data structure and/or provision a copy of the data structures included in the networked item digital record to provide a view of the data represented in the networked item digital records.

Implementations of the current solution provide systems and methods of addressing technical challenges in network systems, focusing on the real-time construction of node graphs, faster and more accurate data retrieval methods, federated system controls, and communication across network systems. First, the solution tackles the complexity involved in representing large-scale permutations of input-output relationships within node graphs. These graphs can be constructed in real-time and accommodate dynamic updates to maintain an accurate end-to-end matrix of relationships. Second, improvements to data retrieval processes are implemented by structuring node graphs into sub-graph data structures that represent specific value chains for specific networked items across networking systems. These improvements allow for targeted access to pertinent data and reduce computational overhead through intelligent navigation and traversal of the edges of the graph. Federated systems offer data privacy by implementing controls over node graph sharing. Data can be segmented within private enclaves, accessible only to authorized entities, while insights are shared without the transmission of raw or proprietary data. Furthermore, the architecture facilitates seamless communication and collaboration between systems and users across value chains over the complex network. This configuration enables efficient data updates and retrieval over the network, providing real-time synchronization, reduced latency, and improved coherence within interconnected systems.

The technological problem addressed by real-time construction of a node graph centers on the complexity and scalability of mapping intricate input-output relationships within large-scale systems. Conventional systems often encounter difficulties when attempting to represent the extensive permutations of transactional and procedural interactions across an entire network. As such, limitations in processing capabilities hinder the ability to produce comprehensive and dynamic models, resulting in fragmented or incomplete depictions of these relationships. This constrains computing device ability to analyze, plan, and improve processes across large scale networks and systems that are useful for more efficient operations.

The techniques described herein provide a technical solution through the development of a node graph architecture designed for real-time integration and analysis of large data sets. This architecture can dynamically construct node graphs that encapsulate different permutations of input-output connections within an end-to-end framework. Advanced algorithms can be deployed to continuously update and reconcile the graph structure as new data inputs become available. This includes identifying and relating comprehensive network nodes, allowing the system to seamlessly integrate diverse data points and maintain an up-to-date, accurate representation of the large scale network that continuously grows and changes.

The implementation of real-time node graph construction results in several technical enhancements. This construction provides continuous data integration into the node graph with continuous updates to the nodes and the edges between nodes within the node graph, ensuring that systems have up-to-date information streams. Accordingly, the construction can eliminate or reduce latency in data availability. The node graph structure facilitates efficient data indexing and retrieval, allowing for faster access to pertinent system relationships than conventional systems data storage and retrieval techniques or data storage and retrieval techniques that involve a node graph data structure. This capability can facilitate swift propagation of updates across the system, thus enhancing the system's responsiveness and scalability.

The technical problem addressed by improving data retrieval in node graphs entails the inefficiencies and inaccuracies associated with accessing relevant information from complex graph data structures. Conventional methods of data retrieval can struggle to efficiently navigate vast graph networks, especially when attempting to extract pertinent details related to sub-graph data structures that represent specific value chains. These challenges arise from redundant or unoptimized search processes, which often lead to increased retrieval times and higher computational costs, while failing to effectively pinpoint or prioritize the most relevant data subsets necessary for analysis.

The techniques described herein offer a technical solution by implementing advanced data retrieval through the structure of node graphs, particularly focusing on sub-graph data structures within these networks. This solution includes algorithms that can intelligently navigate the node graph, identifying sub-graph data structures that correspond to specified value chains or sub-graph data structures. Such algorithms can improve search paths and employ heuristic techniques that reduce retrieval time and computational overhead. By structuring data access around the segmentation of the graph into sub-graph data structures, the system can more efficiently target and extract relevant information.

The improved data retrieval techniques yield several technical enhancements in accessing and utilizing specific subsections of a broader node graph. These techniques increase the precision of data query results, ensuring high accuracy by effectively filtering out irrelevant data points. They also enhance retrieval efficiency and accuracy that reduce query response times, allowing fast access to relevant data subsets. This facilitates real-time data analytics capabilities, enabling systems to quickly process and analyze specific value chain segments. The improved retrieval mechanisms support enhanced data throughput and minimize bottlenecks in information processing, contributing to the system's overall responsiveness. Additionally, these techniques improve and/or optimize computational resource allocation by minimizing data redundancy and ensuring efficient utilization of processing power across networked system.

The technical problem associated with federated systems and the control over node graph sharing arises from the need to balance collaborative data integration against data privacy and sovereignty constraints. In traditional centralized data systems, sharing comprehensive data sets poses risks to confidential information and often violates regional data protection regulations. As organizations engage in shared networks, the challenge is to allow effective collaboration while ensuring that sensitive elements of the node graph remain protected and are only shared with authorized entities.

The techniques described herein introduce a federated system architecture designed to control specific node graph sharing, thus mitigating privacy concerns while still facilitating collaborative benefits. This system can segment the node graph into isolated private enclaves for each participant. Within these enclaves, data remains secure and local, accessible solely to the owner. Federated learning techniques are employed to derive shared insights without actual data transmission, enabling the selective sharing of insights rather than raw data. The system allows participants to define granular sharing controls, specifying which segments of the node graph are accessible and under what conditions, ensuring alignment with privacy and regulatory standards.

The implementation of federated systems with controlled node graph sharing results in several technical improvements. These systems uphold robust data privacy through decentralized data management, minimizing the risk of exposure by keeping data within local storage environments. By utilizing federated learning, the system aggregates insights without raw data transfer, maintaining data integrity and sovereignty across network nodes. This decentralized approach reduces the attack surface for potential breaches, significantly enhancing system security. Additionally, the architecture enables seamless integration of proprietary data into a collective analytical model, optimizing inter-organizational data processing without compromising the proprietary data. This configuration allows for efficient parallel processing and model refinement, facilitating advanced analytics and machine learning applications across distributed environment

The technical problem in networked systems, particularly within the context of systems operating across the value chain, is the challenge of seamless communication and data exchange with a central system. Traditional networked systems often experience latency, data inconsistency, and bottlenecks when numerous disparate systems attempt to update and retrieve information over a central network. These issues are exacerbated by the scale and complexity inherent in value chains, which traverse multiple entities and geographical locations, necessitating robust and efficient communication mechanisms to maintain coherence and synchronization of data across the network.

The techniques described herein propose a technical solution through the implementation of an advanced graph node architecture that facilitates efficient communication between systems across the value chain and a central system. This solution can involve configuring the central system as a nodal hub, where each node in the architecture represents specific entities or processes within the value chain. Alternatively, the solution can involve configuring decentralized nodes that communicate with no central hub, achieving decentralized communication and privacy. These nodes are interconnected in a manner that reflects the actual input-output relationships, allowing for streamlined data propagation and retrieval. The architecture can employ algorithms that dynamically adjust node connections based on network traffic, ensuring optimized data routing that minimizes latency and improves overall efficiency.

The implementation of a graph node architecture within networked systems enhances several technical aspects across the value chain. First, the architecture enables real-time data synchronization, reducing discrepancies and mitigating the risk of data inconsistency. This facilitates immediate data availability, enhancing the precision of analytics and decision-support systems. Second, the intelligent routing algorithms adjust node connections dynamically, which optimizes data flow and reduces latency throughout the network. This results in faster data processing times and improves system responsiveness under varying load conditions. Additionally, the architecture inherently supports fault tolerance by maintaining alternative pathways for data communication in the event of a node failure, thereby ensuring continuous operation and system reliability. Overall, the advanced graph node architecture strengthens the technical infrastructure needed for efficient data exchange, contributing to a more robust and agile value chain network.

The technical problem associated with tracking real-world events, processes, and occurrences, such as the production and transportation of goods within a graph node system, stems from the complexity of accurately representing and managing the dynamic and interconnected nature of these physical activities. Traditional systems often lack the capability to integrate multiple aspects of physical processes, such as changes in location, status, and characteristics, within a cohesive and responsive framework. This leads to inefficiencies in monitoring the transformation and movement of goods, making it challenging to manage logistics, ensure compliance with transportation restrictions, and capture the nuanced transformation characteristics of inputs into outputs.

The techniques described herein provide a technical solution through the implementation of an intelligent node graph system that can model and track the multifaceted nature of networking events in real time. The system can use advanced data analytics to map and update each node's attributes as networked items progress through various stages of their lifecycle, such as from creation, through transportation, to final transformation. Each node within this architecture can represent specific goods, transportation modes, or transformation processes, capturing relevant data points, such as location, condition, and transformation metrics. This setup allows the system to dynamically allow or restrict transportation based on predefined criteria and regulatory requirements, integrating these constraints into the decision-making functionality governing the network.

The implementation of this graph node system results in several technical effects useful to managing physical processes. The system enhances data acquisition and integration capabilities by providing precise real-time updates of physical attributes and changes within the network. This significantly improves monitoring accuracy by reducing dependency on manual tracking, thereby minimizing tracking errors. The architecture supports the orchestration of logistics operations by facilitating data-driven adjustments and enabling instantaneous data updates to relevant nodes. Automated enforcement of restrictions through system integration enhances compliance and regulatory adherence within the network. The standardized data framework within the system supports interoperability across different technological platforms, facilitating seamless data exchange and system integration. Overall, the system optimizes computational resources by structuring heterogenous data inputs into a cohesive, scalable architecture, improving the overall reliability and efficiency of monitoring events and processes.

The technical problem related to enabling collaborations between users on a graph network while tracking products lies in the challenge of facilitating seamless and secure data exchanges among diverse entities. Traditional systems struggle with synchronizing real-time updates and ensuring compatibility across different data formats. Moreover, protecting sensitive information while still allowing effective collaboration presents a significant technical hurdle. These issues can lead to inconsistencies and inefficiencies, impacting the effectiveness of the collaborative workflow.

The techniques described herein offer a technical solution through the development of an advanced graph network architecture. This architecture supports secure, real-time collaboration by employing cryptographic protocols and robust access controls, ensuring that data confidentiality is maintained. It provides mechanisms for integrating diverse data inputs into a cohesive structure, enabling consistent updates and data visibility across the network. By implementing dynamic access controls, the system can facilitate efficient information sharing that aligns with user roles and collaborative activities.

The implementation of this collaborative graph network results in several technical effects. The system ensures real-time data synchronization across users, minimizing discrepancies and enhancing the consistency of information. Secure data exchange can be facilitated through encryption and access control measures, restricting access to authorized users and preserving data confidentiality. The architecture integrates disparate data inputs into a unified format, enhancing data coherence across various systems. Additionally, adaptive management of user permissions through dynamic access controls enables efficient collaboration, ensuring data sharing aligns with security policies. These improvements contribute to a more resilient and efficient framework for tracking products and facilitating user collaboration within the graph network.

The implementations of embodiments of the present solution results in several technical advancements that significantly enhance system capabilities. Improved data retrieval algorithms ensure high accuracy and reduce query response times, facilitating real-time analytics. Intelligent node graph constructions can enable continuous data integration, precise monitoring, and efficient parallel processing, improving resource allocation and system responsiveness. Federated systems can uphold data privacy while allowing collaborative information sharing, enhancing system security and integrity. Advanced graph node architectures can provide real-time synchronization and fault tolerance, contributing to robust data exchange across the value chain. Systems for tracking physical events and facilitating user collaboration improve monitoring accuracy and regulatory compliance while supporting seamless data integration and communication. Overall, these solutions collectively optimize system reliability, efficiency, and the technical infrastructure needed for streamlined operations across complex network systems.

### D. Systems and Methods for Dynamically Revising a Network Graph Data Structure

A computing system can maintain a network graph data structure that models a changing set of relationships and interactions between entities. The graph database stores nodes representing entities, such as people, organizations, devices, or processes, and edges that represent the relationships or operational interactions (e.g., network operations) between those entities. Certain entities are associated with a networked item profile node, which maintains attributes and relationship links for a specific networked item, such as a physical asset, shipment, software resource, or data object. This graph structure is used in applications like supply chain tracking, cybersecurity threat modeling, and complex system simulations. To analyze, monitor, and act upon the operational history of a networked item, users often require visualizations of multiple sub-graphs connected to its profile node. Each sub-graph can identify or otherwise correspond with a path of entities and interactions involving one or more instances of that item.

When operating with conventional applications, a computing system tasked with providing such multi-sub-graph visualizations for a networked item's profile node faces several difficulties. First, many systems produce static exports, such as disconnected files, static images, or frozen data extracts, that break the live link to the persisted network graph data structure. This causes the system to present outdated sub-graph data, leading to user decisions based on stale information. Second, such systems often display sub-graphs without enforcing fine-grained, node- and edge-level access controls, exposing sensitive entity relationships to unauthorized users or withholding permitted information from authorized ones. Third, in collaborative environments where multiple users edit overlapping portions of the graph, including edges and entities present in more than one sub-graph connected to the same profile node, conventional systems frequently process conflicting updates to the same graph elements without automated, graph-level resolution, causing overwrites, data loss, and reduced confidence in the graph's integrity.

To address these technical challenges, the computing system can perform a series of operations beginning with receipt of a request from a client device to generate a digital record for a networked item. The request can contain an identification of the networked item, which the computing system use to identify a profile node for the networked item in the network graph data structure. From the profile node, the computing system can execute a traversal operation to identify one or more sub-graph data structures linked to the profile node. Each sub-graph can be a chain of nodes representing entities that have performed operations on, or interacted with, one or more instances of the networked item, with edges between the nodes indicating transfers, movements, or other transitions of the item between those entities. When multiple such paths are relevant, the computing system can assemble all of the paths into the same digital record, enforcing node- and edge-specific access controls by comparing the requesting user's credentials to stored permissions before including each element in the assembled sub-graphs.

After the computing system assembles the permitted portions of all relevant sub-graphs into the digital record for the networked item, the computing system can generate a live view (e.g., a structured file) or visual representation of the data of the digital record. The live view can be a dynamically updateable visualization of those nodes and edges across all included sub-graph data structures, which can be logically bound to the persisted network graph data structure. The live view can point to (e.g., as addresses) the different nodes and/or edges of the view and/or otherwise contain the respective nodes and/or edges. In some cases, rather than sending a disconnected snapshot, the computing system generates a network-accessible address, such as a hyperlink or similar resource locator, pointing to the live view hosted by the server. The hyperlink is transmitted to the client device, which can use the hyperlink to retrieve (e.g., using the pointers of the live view) the most current visualization of the digital record for the networked item's profile node and all included sub-graphs. Because the live view is bound to the underlying graph, any edit a user makes in the visualization, whether to a node attribute, an edge, or the sub-graph structure, is sent back to the computing system for application to the corresponding element in the network graph data structure. In some cases, before applying any such change, the computing system can re-validate the user's permissions against the affected node or edge to block unauthorized modifications.

When multiple users apply adjustments or changes to the same nodes or edges within sub-graph data structures connected to the same profile node, the computing system can continuously check for conflicts between uncommitted edits. If no conflict exists, the system can commit the change to the graph data structure and update the live view for all connected clients. If a conflict is detected, such as in scenarios where the same entity node or edge appears in more than one sub-graph within the digital record, the computing system can invoke a trained machine learning conflict-resolution model. This model can be trained on historical examples of similar graph-edit clashes to evaluate the competing changes and determines which should be committed. The computing system can then apply the model's selected revision to the graph and updates all clients' live views accordingly. By performing these coordinated steps, the computing system can preserve the security, accuracy, and structural integrity of multiple sub-graphs associated with a networked item's profile node in a collaborative, real-time editing environment.

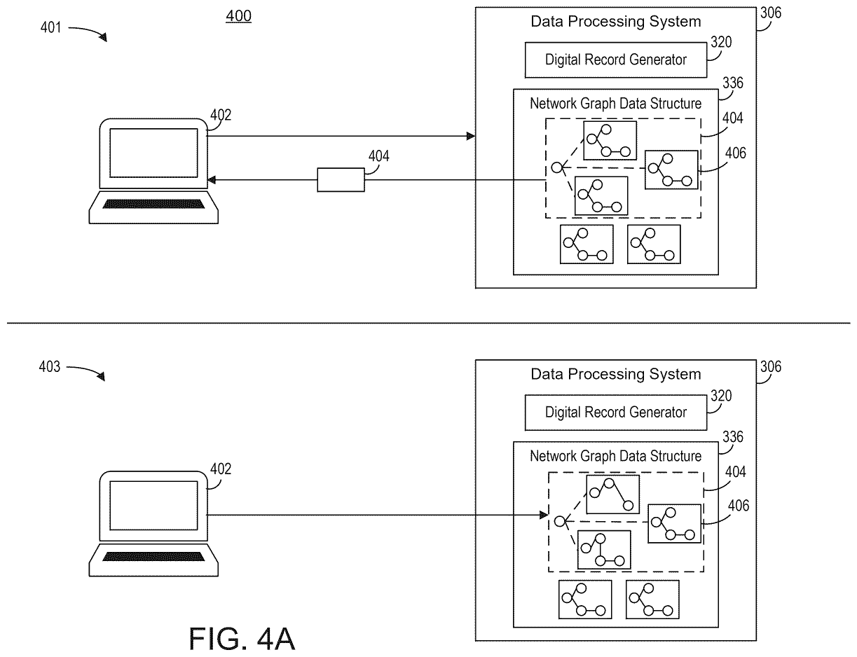

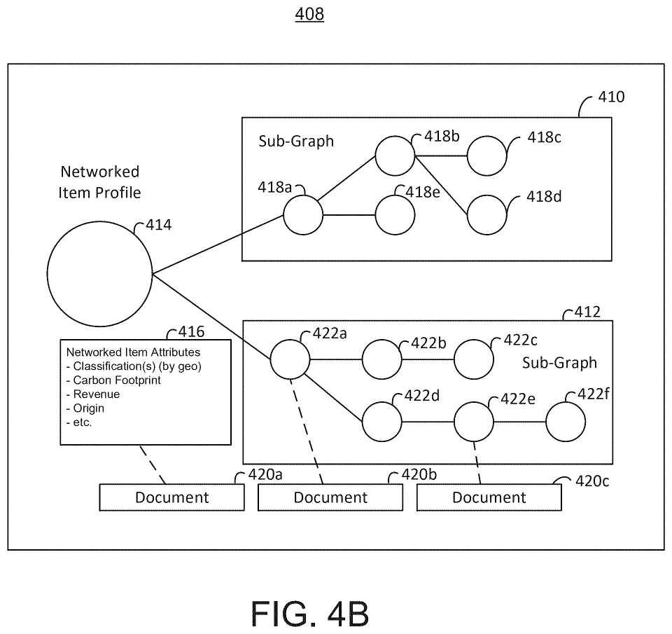

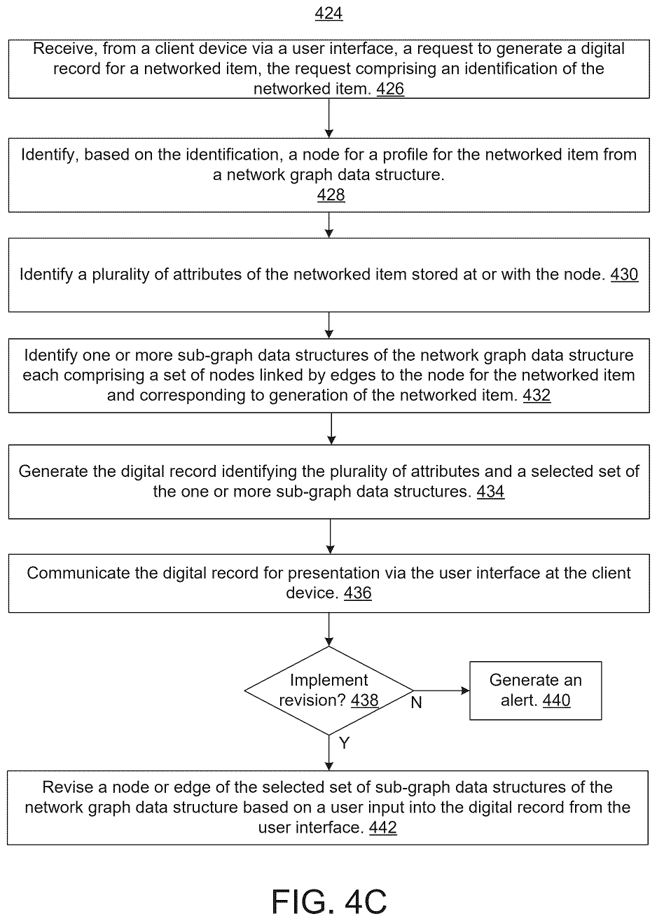

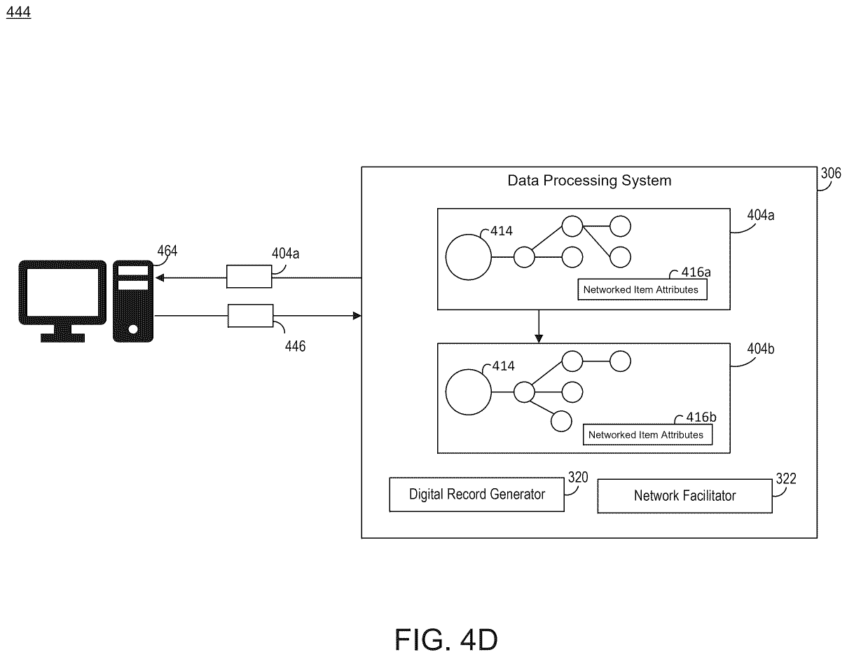

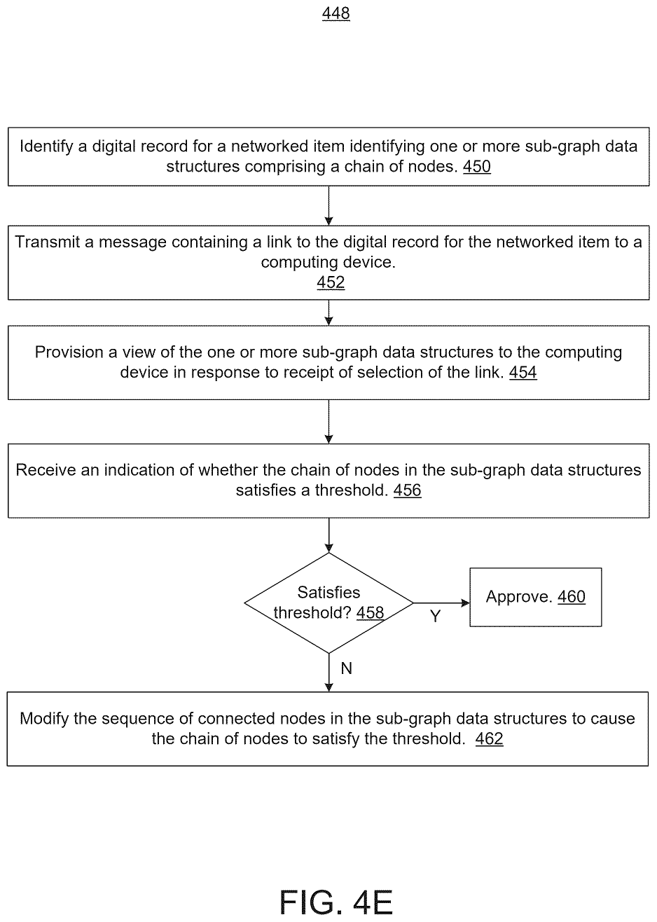

Referring now to FIG. 4A, illustrated is a schematic diagram of a system 400 for generating and updating a network graph data structure in response to input from a client device, in accordance with one or more implementations. The system 400 can include a user interaction 401, a client device 402, a digital record 404, a data processing system 306, a digital record generator 320, a network graph data structure 336, a sub-graph data structure 406, and a user interaction 403.

The user interaction 401 can be a communication between the client device 402 and the data processing system 306 comprising a request to generate the network graph structure 336. For example, the client device 402 may submit a request to generate a digital record 404 comprising the sub-graph data structure 406 based on a networked item. A networked item may be a digital representation of an item or product that is transferred between entities represented by nodes of the network graph data structure. The entity may be an organization (e.g., educational institute, corporation, government agency, and/or the like) that can interact with one or more other entities. In an example, the networked item may be associated with one or more other networked items. As an example, the networked item may be a product or good linked to others through supply chain relationships, such as vendors, manufacturers, distributors, or logistics providers. The data processing system 306 can generate sub-graph data structures, such as the sub-graph data structure 406, based on extracting a subset of entities (e.g., nodes) and relationships (e.g., edges) from the network graph data structure 336. The network graph data structure 336 can include a comprehensive collection of entities and their associated relationships. Based on the request identifying the networked item, the data processing system 306 may execute data retrieval and processing to generate the sub-graph data structure 406 that displays a subset of entities and relationships that are relevant to the networked item.

The client device 402 can be any client device that interacts with the data processing system 306. For example, the client device 402 may be a laptop, desktop computer, tablet, or mobile device operated by a user. In an example, the client device 402 may display a user interface. Based on user interactions with the user interface, the client device 402 can generate and transmit a request to generate the digital record 404 for a networked item to the data processing system 306. As an example, the user may select, via the user interface, the networked item and submit a request to generate the digital record 404 for that networked item. In some examples, the data processing system 306 may transmit the digital record 404 back to the client device 402 in response to receiving the request. The client device 402 may communicate with the data processing system 306 via a network connection using standard protocols. For example, the request may be a HyperText Transfer Protocol (HTTP) request. The client device 402 may send an HTTP request to the data processing system 306 and, in response, receive a link or file representing the digital record 404.

In some examples, the client device 402 may transmit one or more data files as part of the request to generate the sub-graph data structure 406. For example, the client device 402 may include files within the request, such as a bill of materials for a certain product or purchase orders, that can provide context for supply chain relationships associated with the entity. Based on these files, the data processing system 306 can generate nodes or relationships associated with the networked item. As an example, the data processing system 306 can identify suppliers for a component of product corresponding to the networked item based on a bill of materials included in the request.

The digital record 404 can be a data structure or file. The digital record 404 can be generated by the data processing system 306 in response to a request from the client device 402, for example. For instance, the digital record 404 may contain attributes of a networked item and identifications of one or more sub-graph data structures linked to the item's profile node. Specifically, the digital record 404 may include supply chain information associated with the product represented by the networked item. As an example, the digital record 404 may include a summary of the entity's classification, carbon footprint, and associated value chain sub-graphs. In some examples, the digital record 404 may be generated by the digital record generator 320 and transmitted to the client device 402 for presentation via a user interface. For example, the digital record 404 may be transmitted as a file, a data object, or a link that allows the client device 402 to access a view of the relevant sub-graph data structures.

The digital record 404 can include the sub-graph data structure 406. For example, the digital record 404 can include a plurality of sub-graph data structures, including the sub-graph data structure 406. The sub-graph data structure 406 can be a subset of the overall network graph data structure 336 representing a specific value chain or set of relationships relevant to a networked item. A value chain may represent a chain of nodes forming a path from a source node to a destination node representing a product or service provided by the entity. As an example, if the networked item is a chocolate bar, the sub-graph data structure 406 may represent the supply chain of a specific ingredient, such as sugar or cocoa beans. The sub-graph data structure 406 can show the upstream suppliers (e.g., agricultural cooperatives that grow the cocoa beans) and transformation steps (e.g., post-harvesting processing, such as bean roasting) for a particular component of a product. These suppliers may be represented as nodes and their interconnected relationships may be represented as edges within the sub-graph data structure 406.

In an example, the sub-graph data structure 406 may be generated by querying the network graph data structure 336 for nodes and edges linked to a given networked item profile, filtering by relevant attributes or relationships. For example, the sub-graph data structure 406 may be constructed using a machine learning model to perform entity resolution and relationship extraction to build the relevant value chain. The data processing system 306 may execute one or more machine learning models to identify latent relationships, infer missing links, and classify entities within the sub-graph data structure 406 based on contextual and semantic patterns derived from the underlying data. The machine learning model may be executed on various records available to the data processing system 306. These records can include public records (e.g., public import records retrieved from a government database), third-party commercial databases (e.g., supplier registries, trade compliance datasets, and industry certifications), and records provided by the client device 402. As an example, the machine learning model can perform entity resolution by identifying that two terms refer to the same entity across different documents. As another example, the machine learning model may extract supply chain relationships by identifying patterns such as supplier-customer linkages, shared logistics providers, or co-occurrence of entities within procurement documents and shipment records.

The user interaction 403 can be a sequence or stage representing a subsequent communication between the client device 402 and the data processing system 306. For example, the user interaction 403 may occur after the initial generation and presentation of the digital record 404. Alternatively, the user interaction 403 may occur asynchronously to the initial generation of the network graph data structure 336. For example, the user interaction 403 may be a request to edit a digital record generated by another user and/or at a previous point in time. As part of the user interaction 403, the client device 402 may transmit an update or revision to a node or edge of a sub-graph in the network graph data structure 336. For example, the client device 402 can receive user input via the user interface presented by the client device 402. In response to this user input, the client device 402 may transmit a revision to the digital record 404 to the data processing system 306. As an example, the data processing system 306 may receive, from the client device 402, user input indicating a change to a data object representing the node or edge. In response to receiving this user input, the data processing system 306 can propagate the change to the network graph data structure 336 associated with that node or edge. In some examples, the data processing system 306 may perform one or more checks before propagating a revision. For example, the data processing system 306 may evaluate whether the access permissions of the client device 402 authorize modifications to a given node or edge, or whether any pending revisions might conflict with the changes specified by the user input.

Referring now to FIG. 4B, illustrated is a schematic diagram of a digital passport 408 for value chain management, in accordance with one or more implementations. The digital passport 408 may be generated for a networked item (e.g., a digital representation of a product) by a data processing system, such as the data processing system 306 of FIG. 3A. The digital passport 408 can include a sub-graph data structure 410, a sub-graph data structure 412, a networked item profile 414, networked item attributes 416, and one or more documents 420a-420c. The sub-graph data structure 410 can include one or more nodes 418a-418e. The sub-graph data structure 412 can include one or more nodes 422a-422f.

The digital passport 408 may be a digital representation of the networked item. For example, the digital passport 408 can be a structured data file, such as a JSON, XML, or other container format that supports extensible metadata and relationships. In response to receiving a request from a client device (e.g., the client device 402 of FIG. 4A) to generate a passport for a networked item, the data processing system can generate the digital passport 408 based on data associated with that networked item. The digital passport 408 may consolidate relevant information associated with the networked item, such as documents associated with the networked item and/or sub-graphs showing relevant relationships to other networked items. In some examples, a user may transmit the digital passport 408 to another user. For example, the client device may transmit a link (e.g., HTTP link) to the digital passport 408. In this example, the data processing system may present the digital passport 408 based on the access permissions of the device opening the link to the digital passport 408. Specifically, the data processing system may compare access permissions (e.g., an access credential indicating access permissions) of a client device or account accessed by the client device opening the link to access restrictions associated with data within the digital passport 408. Based on this comparison, the data processing system may remove data (e.g., from the view presented in the digital passport 408). For example, the data processing system may remove data that the client device is not permitted to view based on their level of access.

The sub-graph data structure 410 may be a subset of the overall network graph data structure, representing a specific value chain or set of relationships relevant to the networked item profile 414. For example, the sub-graph data structure 410 may show the upstream suppliers and transformation steps for a particular product and/or component of a product represented by the networked item profile 414. The sub-graph data structure 410 can store and organize nodes and edges that correspond to entities and relationships involved in the production, transformation, and/or movement of a product associated with the networked item profile 414. For example, the sub-graph data structure 410 may represent a chain of nodes forming a path of one or more instances of the networked item from a source node (e.g., node 418c and/or node 418d) to a destination node (e.g., node 418a).

The sub-graph data structure 410 may be generated by querying a network graph data structure (e.g., network graph data structure 336 of FIG. 3A) for nodes and edges associated with the networked item. In an example, the data processing system can generate the sub-graph data structure 410 by filtering the network graph data structure based on relevant attributes or relationships. In this example, the data processing system may execute a machine learning model to identify and/or extract relationships within the network graph data structure. For example, the machine learning model can identify when two terms refer to the same entity or identify relationships between entities based on contextual clues. Based on the output of the machine learning model, the data processing system may generate nodes and/or relationships to be included as part of the sub-graph data structure 410.

The sub-graph data structure 412 may be another instance or type of sub-graph. For example, the sub-graph data structure 412 may represent a different segment of the value chain or a different set of relationships for the same or another networked item. This different segment of the value chain may be a downstream distribution or alternative supply routes for the networked item. As an example, if the networked item is an electronic device manufactured by a particular entity, the sub-graph data structure 410 may represent a supply chain associated with sourcing battery cells from one country (e.g., a manufacturer South Korea) while the sub-graph data structure 412 may represent a supply chain associated with sourcing battery cells from another country (e.g., a manufacturer in Canada). Additionally, or alternatively, the sub-graph data structure 410 may represent a supply chain associated with manufacturing the electronic device while the sub-graph data structure 412 may represent a supply chain associated distributing the electronic device to retail stores. The sub-graph data structure 412 may therefore provide additional or alternative views into the networked item's value chain, supporting analysis, decision support, or compliance checks. The sub-graph data structure 412 may be constructed using similar methods as sub-graph data structure 410. However, the sub-graph data structure 412 can be constructed using different filters, criteria, and/or user-driven customization.

The process of generating and displaying the networked item profile 414 can include user-driven or automated selection of which sub-graphs to display or analyze. For example, a client device (e.g., the client device 402 of FIG. 4A) may transmit input that indicates which sub-graphs to display. Based on this input, the data processing system can generate and display the sub-graph data structure 410 and the sub-graph data structure 412. Additionally, or alternatively, the data processing system can determine which sub-graphs to display based on one or more attributes of the networked item. As an example, based on determining that a component of a product is associated with several possible supply chains (e.g., cocoa beans can come from various suppliers in various countries), the data processing system can display the sub-graph data structure 410 as the current supply chain and the sub-graph data structure 412 as a possible alternative supply chain.

The networked item profile 414 can be a data structure (e.g., a table, spreadsheet, or other type of structured data) that represents a networked item. The networked item may be a node representing a specific product, material, or item within the value chain, serving as a central reference point for associated data and relationships. For example, the networked item profile 414 may be a profile for a particular product, such as an electronic device, and the various components that the product is made out of The networked item profile 414 can aggregate and present key attributes, relationships, and supporting documentation for the networked item. For example, the networked item profile 414 may store references to sub-graph data structures, documents, and attribute sets for the product. The networked item profile 414 may be instantiated by the system upon user request or as part of automated data ingestion, linking to sub-graphs, attributes, and documents as appropriate. For example, the networked item profile 414 may be created or updated dynamically as new data is ingested or user input is received.

The networked item attributes 416 can be a collection of data fields describing properties of the networked item (e.g., carbon footprint, revenue, origin, and/or the like). As an example, the networked item attributes 416 may include tariff classification codes, carbon footprint metrics, or certification data such as fair trade or organic status for the networked item. The networked item attributes 416 can provide relevant information for compliance, reporting, analytics, and decision support related to the networked item. For example, the networked item attributes 416 may be used to generate digital records (e.g., passports) for regulatory or supply chain purposes. The networked item attributes 416 may be populated from internal or external data sources, user input, or automated extraction from documents (e.g., documents 420a-420c), and may be updated as new information becomes available. For example, the networked item attributes 416 may be extracted using AI and natural language processing (NLP) from supporting documents or system-of-record data (e.g., the system of record data 337 of FIG. 3A).

The documents 420a-420c can be electronic files or records that provide supporting evidence, provenance, or attestation for the data and relationships represented in the digital passport 408 and associated sub-graphs. For example, the documents 420a-420c may include certificates of origin, bills of materials, audit reports, or compliance documents. The documents 420a-420c may be retrieved from internal and/or external sources. For example, the documents 420a-420c may be retrieved from a network graph data structure (e.g., the network graph data structure 336 of FIG. 3A). In some examples, the documents 420a-420c can be linked to specific nodes or attributes to substantiate claims, provide audit trails, or support regulatory compliance. As an example, a document 420a may be linked to a node representing a manufacturing facility, while a document 420b may be linked to a shipment event. The documents 420a-420c may be associated with nodes or attributes via metadata, hyperlinks, or embedded references, and may be managed within the a hub of a federated system for secure storage and retrieval.

The sub-graph data structure 410 can include the nodes 418a-418e. The nodes 418a-418e can be data structures representing entities such as facilities, companies, or locations within a sub-graph data structure 410. For example, each node of the nodes 418a-418e may correspond to a supplier, transformation step, or logistics provider in the value chain. The nodes 418a-418e can serve as connection points for edges representing relationships, enabling the modeling of value chain networks. For example, the nodes 418a-418e may be connected by edges to form a chain representing the flow of goods or information. The nodes 418a-418e can be instantiated based on entity resolution and canonicalization processes, linked by edges according to detected or inferred relationships. For example, the data processing system may generate the nodes 418a-418e by executing a machine learning model to resolve duplicate or ambiguous entities and construct the sub-graph.

The sub-graph data structure 412 can include the nodes 422a-422f. The nodes 422a-422f may correspond to another segment or aspect of the value chain. For example, nodes 422a-422f may represent downstream distributors, alternate suppliers, or related facilities. The nodes 422a-422f can enable the modeling of alternative or extended value chain scenarios, supporting analysis and decision-making. For example, the nodes 422a-422f may be connected by edges to illustrate alternative supply routes or distribution paths. The nodes 422a-422f may be generated, resolved, and linked using the same or similar processes as nodes 418a-418e. This process can include user-driven or automated selection of which sub-graphs to display or analyze. For example, a client device (e.g., the client device 402 of FIG. 4A) may transmit input that indicates which sub-graphs to display.

Referring now to FIG. 4C, illustrated is a method 424 of dynamically revising a structure of a graph data structure using selected views of the graph data structure. The method 424 can be executed, performed, or otherwise carried out by any of the computing devices or devices described herein, such as the data processing system 306, shown and described with reference to FIG. 3A. In brief overview of the method 424, the method 424 can include receiving a request to generate a digital record for a networked item (Step 426), identifying a node for a profile for the networked item (Step 428), identifying a plurality of attributes of the networked item (Step 430), identifying one or more sub-graph data structures linked to the node for the networked item (Step 432), generating the digital record identifying the plurality of attributes and sub-graph data structures (Step 434), communicating the digital record for presentation via the user interface (Step 436), determining whether to implement a revision (Step 438), generating an alert if a revision is not implemented (Step 440), and revising a node or edge of the selected set of sub-graph data structures based on user input (Step 442). The method 424 can include any number of steps and the steps can be performed in any order. By implementing the method 424, the data processing system can improve the efficiency and accuracy of managing and updating network graph data structures by enabling real-time, user-driven revisions to selected sub-graphs while maintaining data consistency across distributed systems, reducing latency in update propagation, and preventing conflicting modifications through coordinated access controls.

At step 426, the method 424 can include receiving a request to generate a digital record for a networked item (e.g., networked item profile 414 of FIG. 4B). The request can be received by a server (e.g., the data processing system 306 of FIG. 3A) comprising one or more processors. The server can receive, from a client device (e.g., client device 418 of FIG. 4A) via a user interface, a request to generate a digital record for a networked item, the request comprising an identification of the networked item. For example, the request may be transmitted by a client device (e.g., client device 402 of FIG. 4A) when a user selects an option to view or update a networked item's information. The request may be received at any time a user initiates an action to access or modify data related to a networked item. For example, the request can be triggered when a user interacts with a graphical user interface element associated with the networked item. The server may receive the request via a network connection, using standard protocols such as HyperText Transfer Protocol (HTTP). For example, the client device may transmit the request to the server as an HTTP request containing the networked item identifier.

At step 428, the method 424 can include identifying a node for a profile for the networked item. For example, based on the identification, the server can identify an associated node from an associated network graph structure (e.g., the network graph structure 336 of FIG. 3A). The associated node may be identified based on parsing the request received from the client device. The server can identify the node based on querying the network graph data structure to locate a node corresponding to the provided networked item identifier. This identification may occur after the request to generate a digital record is received and before any attributes or sub-graphs are retrieved. For example, the server can perform this identification step immediately after parsing the request and extracting the networked item identifier. In an example, the server may use entity resolution, canonicalization, or direct lookup techniques to identify the node. For example, the server may use AI-driven entity resolution to match the networked item identifier to a canonical node in the graph.

At step 430, the method 424 can include identifying a plurality of attributes of the networked item. For example, the server can identify a plurality of attributes of the networked item stored at or with the node for the profile for the networked item. The attributes of the networked item can include classifications (e.g., food and drug administration (FDA) classifications), associated assessments (e.g., environmental impact, carbon footprint, and/or the like), and/or associations with other nodes. These attributes may be retrieved from internal or external sources. For example, the server can access an internal database (e.g., the network graph data structure 336 of FIG. 3A) or an external database (e.g., a database including trade flows from the U.S. International Trade Administration). The server may access internal or external data sources, or use automated extraction from documents, to identify the attributes. For example, the server may use AI and NLP to extract attribute data from supporting documents linked to the node. In an example, the server can identify the plurality of attributes of the networked item after the node for the profile is identified and before generating the digital record. For example, the server may extract the attributes in response to locating the node in the network graph data structure.

At step 432, the method 424 can include identifying one or more sub-graph data structures linked to the node for the networked item. For example, the server can identify one or more sub-graph data structures (e.g., the sub-graph data structure 410 and the sub-graph data structure 412 of FIG. 4B) of the network graph structure based on the plurality of attributes. In an example, the server may determine sub-graphs representing value chains or supply routes associated with the networked item based on which other nodes are associated with the node of the networked item. Step 432 may occur after identifying the node and its attributes, and before generating the digital record. For example, the server may perform a graph traversal or query to extract relevant sub-graphs immediately after retrieving the node's attributes. The server may use AI-driven relationship extraction, recursive mapping, or filtering by access permissions to identify the sub-graphs. For example, the server may apply organization-specific filters or access controls to determine which sub-graphs are relevant to the request.

In some embodiments, each sub-graph data structure may include a set of nodes linked by edges to the node for the networked item and corresponding to generation of the networked item. For example, each sub-graph data structure may include a chain of nodes comprising a sequence of connected nodes that form a path from a source node (e.g., node 418d of FIG. 4B) to a destination node (e.g., node 418a of FIG. 4B). The term sequence may refer to an ordered chain of nodes, where the order indicates an order of network operations associated with the networked item. For example, each path can represent a chain of sequential actions associated with producing or distributing the networked item. In this example, each node may represent an entity that executes one or more actions in this chain of sequential actions and each edge may represent movement from a first node to a second node. For example, each edge may represent a transition (e.g., movement) from a first node (e.g., entity) that performs a first network operation to a second node that performs a second network operation in a sequence of network operations. In some examples, the server may identify the sub-graph data structure based on which nodes are linked to the networked item. For example, based on determining that another node is linked to a node representing the networked item, the server can retrieve a chain of nodes linked to the other node and present that chain as a sub-graph data structure.

In some embodiments, the sub-graph data structure may be generated based on user-generate input. For example, the server can receive user-generated input that identifies access permissions associated with the networked item. Access permissions may refer to an indication of which data items a system (e.g., the server) is permitted to use to generate the sub-graph data structure. The server can determine the access permissions for a request based on the access permissions of the account accessing the server (e.g., such as abased on a user role of the account, ownership, or group permission) to transmit the request or based on the access permissions being included in the request itself (e.g., as an authentication token, such as a JSON web token, a username, a password, or an API key). In some cases, the access permission scan indicate whether the permissions are whether the requesting entity has read and/or write permissions. In some examples, the client device or account may be associated with predefined levels of access. In this example, the server can identify permitted data items based on a level of access indicated in the user-generated input. As an example, the user-generated input may indicate a level of access that only includes metadata related to product classification and origin, while excluding sensitive financial or personal data associated with the networked item. Based on this indication, the server can identify sub-graph data structures that include only the permitted metadata fields for inclusion in a digital record. This may enable the server to generate sub-graph data structures that are suitable for external sharing, as they exclude sensitive or restricted information.

In some embodiments, the server may compare access permissions with access restrictions. For example, the plurality of nodes or sub-graph data structures may (each) be associated with a set of access restrictions. The set of access restrictions may define which users or entities are permitted or denied to execute certain actions to change or view data associated with the sub-graph data structures and/or nodes. For example, the access restrictions may indicate whether certain users are allowed or denied access to specific nodes or sub-graphs, the types of operations (e.g., read, write, modify, and delete) that are allowed or prohibited, time-based or contextual limitations on access, any hierarchical or role-based constraints that govern how data within the graph may be accessed or manipulated, and/or the like. In some examples, the server can identify the sub-graph data structures based on determining which sub-graph data structures the user (e.g., a user account associated with the client device) is permitted to view by comparing the access permissions of that user (e.g., of the account logged into the client device) to the access restrictions. This comparison may include determining whether the access permissions satisfy an access restriction level associated with the identified sub-graph data structures based on a predefined access control policy. The server can then retrieve sub-graph data structures that the client device is permitted to view based on this comparison.

At step 434, the method 424 can include generating a digital record (e.g., digital record 404 of FIG. 4A) identifying the plurality of attributes and sub-graph data structures. For example, the server can generate the digital record identifying the plurality of attributes and a selected set of the one or more sub-graph data structures. To generate the digital record, the server may extract relevant metadata and structural information from the network graph database. This data can then be compiled and serialized into a structured format suitable for transmission and storage. The digital record may include a summary of the networked item's attributes and references to the relevant sub-graphs. The step 434 may occur after the attributes and sub-graph data structures have been identified and before the record is communicated to the client device. For example, the server may assemble the digital record in response to retrieving data from the network graph data structure. In an example, the server may format the digital record as a file, data object, or structured message for presentation via a user interface. For example, the server may generate a JSON or XML file containing the digital record data for transmission to the client device.

At step 436, the method 424 can include communicating the digital record for presentation via the user interface. For example, the server can communicate the digital record for presentation via the user interface at the client device. The step 436 may occur after the digital record is generated and before any revision is implemented. For example, the server may send the digital record in response to generating the digital record.

In some embodiments, the server may communicate the digital record by transmitting the digital record as a file or HTTP link to the client device, enabling display in a graphical user interface. For example, the server can transmit an HTTP link corresponding to the digital record to the client device. In response, the server may receive a selection of the HTTP link. The selection may indicate a request by the client device to access the digital record. In response to receipt of the selection, the server can transmit a view of the one or more sub-graph data structures to the client device for presentation (e.g., via the user interface). This may enable secure delivery to the client device. For example, by transmitting only authorized views of sub-graph data structures, the system can ensure that access to sensitive information is controlled. Furthermore, this may facilitate revisions to a sub-graph data structure made by multiple client devices. For example, multiple client devices may submit proposed changes to the sub-graph data structure (e.g., via separate digital records that the server generates containing the same sub-graph data structure and transmits to different computing devices for revisions or by transmitting the same digital passport to different computing devices for revisions), which the server can validate and merge according to predefined access permissions and conflict resolution policies. By transmitting the view of the sub-graph data structure, as opposed to transmitting the entire digital record as a file, the server can ensure that the edits made by multiple client devices are precisely tracked and integrated, maintaining both data integrity and access control.

In some embodiments, the server may configure each view as nodes connected by lines. For example, the server can generate the view by depicting each of the one or more sub-graph data structures, wherein the configuration visually represents nodes as individual elements (e.g., circles, as illustrated by nodes 418a-418e in FIG. 4B) and edges as linear connections between nodes within each respective sub-graph data structure. This may allow the server to present a view that intuitively represents the relationships and connectivity among the nodes in the system. In this example, data associated with the sub-graph data structures may be stored as a unified set of entities and interconnected relationships between those entities. Views of sub-graph data structures may then be dynamically rendered as symbols with linear connections in response to a request from the client device to view a sub-graph data structure. This may allow the server to avoid redundant storage of entities and relationships, thereby conserving space in the associated database.

In some embodiments, the server may receive user input in response to communicating the digital record. For example, in response to receiving user input comprising a revision to the digital record being presented, the client device may transmit the user input to the server. The user input may indicate a change to the node or edge of one or more sub-graph data structures. For example, the user can indicate that two nodes should be connected, indicate a change to metadata associated with a node, add nodes, and/or the like. In some examples, the server can propagate changes to a node or edge identified by the user input in response to receiving the user input.

In some embodiments, the server may communicate a file representing a version of the digital record that the client device can revise. For example, the server can transmit a file including data objects representing nodes and edges in the sub-graph data structures. In response to the receiving the file, the client device can transmit a revision. For example, the client device can receive user input indicating a change to a data object (e.g., representing a node or an edge) in the digital file and, in response, transmit the user input as a revision to the file. The server may then identify the node or edge that corresponds to the changed data object and propagate the change to the identified node or edge. Propagating the change may refer to changing one or more nodes or edges within the larger network graph data structure (e.g., network graph data structure 336 of FIG. 3A) from which the sub-graph data structures are generated. In some examples, the server may propagate the changes in response to verifying an access credential. For example, the client device may be associated with a client account. The client account may correspond to an access credential that indicates a level of access permission. In an example, the server can verify that the access credential permits the client device to edit the sub-graph data structure and/or the identified node before propagating the change. For example, the server can verify that the user does have permission to edit a node before executing a revision. If the server determines that the user does not have permission, the server can reject the modification, thus conserving security of the network graph data structure.

In some embodiments, the server may check for conflicts of revisions before propagating a pending revision submitted by the client device. For instance, the server may not implement received for revisions for a defined time period (e.g., one day, one week, one month, etc.) after receipt of the revisions. The server may store the revisions in memory until the time period ends, at which point the server may implement the revisions unless the server determines there is a conflicting revision that is also pending or that has been input for the same structure of the node graph data structure. For example, the server may check for other pending revisions to a node or edge before propagating the revision indicated by the user input. Based on determining that there are other pending revisions, the server may propagate and/or reject revisions based on predefined logic. As an example, the server may propagate a first revision associated with a first time and reject a second revision associated with a second time based on determining that the first time is earlier than the second time. As another example, the server may propagate a first revision associated with a first client device and reject a second revision associated with a second client device based on determining that the access level of the first client device supersedes that of the second client device. This may prevent conflicting updates from being applied, which may maintain a reliable state within the network graph data structure. Since sub-graph data structures each display only a subset of the network graph data structure, client devices may make changes within the context of their limited sub-graph view but may conflict with other changes or violate constraints when considered in the context of the overall network graph data structure. Preventing conflicting revisions at the server level may help ensure that each sub-graph data structure remains consistent with the overall network graph data structure.

In some embodiments, the server may execute a machine learning model (e.g., a neural network, a support vector machine, a random forest, etc.) to resolve pending revisions that conflict. The machine learning model can be trained based on a training dataset containing conflicting revisions to the same nodes or edges. The training dataset can include labels indicating the correct revisions to implement into the corresponding nodes or edges. The training dataset can include metadata about the changes, such as the times or dates of the revisions, the sources (e.g., IP addresses or IP ranges) of the respective edits, account information about the accounts that implemented the changes, etc. The training dataset can include any such data. The machine learning model can be trained using back-propagation techniques with a loss function and/or otherwise using a gradient descent. The machine learning model can be executed to generate predictions of the correct conflict to output and trained based on differences between the output and the labels. In some cases, the machine learning model can be trained in real-time as the server detects conflicts and a user selects the correct revision to implement. The server can use the user input as a label and compare the label with the prediction by the machine learning model. The server can revise the weights and/or labels based on the differences, further improving the accuracy of the outputs of the machine learning model.

In one example, in response to detecting that the pending revision associated with the user input conflicts with another pending revision associated with a second user input from a second computing device, the server may generate a feature vector containing the data of each input, including the data of the conflict itself and/or metadata about the inputs. The server can input the feature vector into the machine learning model and execute the machine learning model. Based on the pending revisions, the machine learning can generate output including a selection of a revision. This revisions may be none of the pending revisions (e.g., in cases in which the machine learning model is trained to generate a correct revision different from, but based on, multiple revisions), one of the pending revisions, or a combination of the two pending revisions. In this example, the machine learning model may be trained based on labeled training data of conflicting revisions to the network graph data structure. As an example, the labeled training data may teach the machine learning model to combine revisions if they are different types (e.g., a metadata revision to a node and an edge revision associated with the node). As another example, the labeled training data may teach the machine learning model to reject at least one revision if they include structural changes that cannot be combined (e.g., one revision deletes a node while the other adds edges to that same node). The server can then revise the node or edge associated with the pending revisions based on the output of the machine learning model.

At step 438, the method 424 can include determining whether to implement a revision. For example, the server can determine whether to implement a revision to a node or edge of the selected set of sub-graph data structures based on user input into the digital record from the user interface. The server may evaluate whether a requested change is valid, authorized, or conflicts with other pending revisions. For example, the server may check access credentials, compare against access restrictions, or evaluate for revision conflicts using a machine learning model. Based on this evaluation, the server can decide to either implement or reject the revision. The step 438 may occur after the digital record has been presented and user input indicating a revision has been received. For example, the server may perform this determination in response to receiving a revision request from the client device.

At step 440, the method 424 can include generating an alert if a revision is not implemented. For example, the server can generate an alert if a revision is not implemented, such as when a revision request is denied or conflicts with another pending revision. In this example, the server may notify the client device that the requested revision could not be applied due to access restrictions or detected conflicts. The step 440 may occur after a determination is made not to implement a revision. For example, the server may generate and transmit the alert in response to determining that a revision request is denied. In some examples, the server may format the alert as a message or notification for presentation via the user interface at the client device. For example, the server may send an error message or warning dialog to the client device indicating the reason for the failure.

At step 442, the method 424 can include revising a node or edge of the selected set of sub-graph data structures based on user input. For example, the server can revise a node or edge of the selected set of sub-graph data structures of the network graph data structure based on a user input into the digital record from the user interface. As part of revising a node or edge, the server may update the network graph data structure to reflect a change to a node attribute or edge relationship as indicated by the user input. The step 442 may occur after a determination is made to implement the revision and before any subsequent updates or notifications. For example, the server may apply the revision immediately after confirming that the requested change is valid and authorized. In some examples, the server may propagate the change to the network graph data structure and update any relevant digital records or sub-graphs. For example, the server may update the graph database and trigger updates to any live views or digital records reflecting the revised data.

In an example, a data processing system receives, via a network interface, a structured request packet from a remote client device, the packet comprising a networked item identifier and metadata specifying access control parameters. The system parses the packet using a request handling module, validates the identifier's syntax against an internal schema, and initiates the digital record generator process. The system queries a graph database storing a network graph data structure, locates a node corresponding to the profile of the identified networked item, and retrieves a plurality of attributes stored at or associated with that node. The system then applies an access permissions evaluation algorithm to filter associated sub-graph data structures, ensuring only accessible sub-graphs linked to the identified node are selected based on the supplied access parameters.

The data processing system executes a sub-graph extraction routine to identify a set of sub-graph data structures each linked to the identified node of the networked item. Each selected sub-graph comprises a sequence of connected nodes forming a path from a source node to a destination node, with each node representing an entity that has performed a network operation on one or more instances of the item. The system retrieves the graph topology and relationship data, formats the data into internal data objects representing both nodes and edges, and applies an access restrictions comparison process to confirm compliance with access control rules. The digital record generator then assembles a digital record comprising the filtered attributes and the selected sub-graph data structures for subsequent transmission.

The data processing system stores the generated digital record in a content repository and generates a corresponding Hypertext Transfer Protocol (HTTP) link. The system transmits the HTTP link to the client device via a secure transport protocol. Upon detection of a valid HTTP link selection event returned from the client device, the system serializes the selected one or more sub-graph data structures into a visual data representation, wherein nodes are encoded as discrete data objects and edges are encoded as connection objects specifying directional relationships. The serialized view is transmitted to the client device in a structured data file format, enabling the rendering of nodes connected by lines within each sub-graph on the client display without additional query operations.

The data processing system detects a revision input event from the client device in the form of an updated data object representing a node or edge within the transmitted sub-graph. The system identifies the graph element corresponding to the updated data object, verifies that user access credentials associated with the input satisfy defined access restrictions, and determines whether the proposed revision conflicts with any pending modifications in a revision queue. If a revision conflict is detected, the system executes a trained machine learning model to resolve the conflict by selecting the optimal revision based on historical labeled conflict-resolution data. The system then propagates the validated revision to the network graph data structure, updates associated indexes and paths, and synchronizes the revised graph state across distributed storage nodes to maintain data consistency.

By virtue of the implementation of the techniques described herein, processor cycles and memory allocations can be reduced by a system generating and revising views of a network graph. For example, a system can activate a digital record generator in response to a request, identify a node for a profile from a network graph data structure, identify attributes stored with the node, identify one or more sub-graph data structures comprising a chain of nodes, and generate a digital record identifying only the selected portions instead of loading an entire global network graph data structure into working memory. By causing processing to focus on sub-graph data structures linked to a single profile and by performing node or edge revisions based on user input into the digital record rather than recomputing global structures, the system can avoid exhaustive traversal and large in-memory joins commonly used by conventional systems. As a result, overall processor utilization and memory consumption can be reduced while dedicated views remain responsive for interactive analysis.

In examples, network bandwidth consumption can be reduced by a system transmitting compact views instead of entire datasets. For example, a system can communicate a digital record for presentation via a user interface based on an identification of a networked item, where the digital record identifies a plurality of attributes and one or more sub-graph data structures linked to a node for a profile, and where subsequent revisions are applied server-side by revising a node or an edge based on user input into the digital record. By sending only a representation of selected sub-graph data structures and attributes and by confining node-or-edge mutations to server-side propagation, the system can avoid bulk synchronization of full graph partitions across a network. Consequently, total message count and payload size can be reduced during both initial viewing and iterative revision cycles.

In some examples, result quality and decision precision can be increased by a system aligning computations to semantically relevant graph portions. For example, a system can identify a node for a profile corresponding to a received identification, identify a plurality of attributes stored with the node, identify one or more sub-graph data structures comprising a sequence of connected nodes forming a path from a source node to a destination node, and revise a node or an edge based on user input into the digital record. By constraining analysis to a path representing network operations of instances of a networked item and by incorporating targeted user-driven corrections directly into the identified sub-graph data structures, the system can reduce false associations and stale relationships that often arise in global, undifferentiated graph processing. Therefore, accuracy of value-chain representations and downstream analytics can improve relative to systems that operate on unscoped or non-interactive graph snapshots.

In at least some examples, exposure to adversarial manipulation can be reduced by a system limiting data exposure and centralizing authoritative mutations. For example, a system can communicate a digital record for presentation via a user interface while retaining the network graph data structure server-side, and can revise a node or an edge only when user input is provided through the digital record workflow executed by a server comprising one or more processors. By mediating edits through server-controlled procedures tied to a specific profile node and to identified sub-graph data structures, and by avoiding distribution of full datasets to client devices, the system can reduce attack surfaces associated with client-side tampering and unauthorized mass edits. As a result, opportunities for malicious actors to exploit unmanaged data replicas or ambiguous update paths can be diminished.

Conventional computing arrangements for maintaining network graph data structures can face limitations in maintaining synchronization with client-facing applications when data frequently changes. For example, static visualization tools can present outdated snapshots that lose correlation with the persisted graph stored at a server. Furthermore, when multiple users concurrently edit overlapping nodes or edges through separate interfaces, such operations can result in conflicting updates that degrade data consistency. Traditional approaches can rely on periodic refreshes or centralized locks on graph elements, which can increase latency and restrict simultaneous collaboration. Such methods can fail to enforce node-level and edge-level access boundaries during visualization, causing certain users to view or alter restricted information. As network graphs scale to represent large interdependencies between organizations or assets, maintaining current, permissioned, and conflict-free structures can become increasingly difficult without continuous synchronization mechanisms between distributed users and the central data repository.

The techniques described herein can maintain a dynamically bound view of a network graph data structure by generating and updating a digital record for particular networked items. In some implementations, a data processing system can receive a request from a user device through a network interface and identify sub-graph data structures linked to a node representing a profile of a networked item. The data processing system can generate a digital record depicting the sub-graph nodes and edges and communicate the digital record to the user interface for visualization. In some implementations, any modification entered via the view can be transmitted to the data processing system, which can revise the underlying graph in real time based on user input and stored permissions. The data processing system can apply access controls to individual nodes and edges and invoke conflict detection logic or machine learning models to resolve overlapping updates. In some implementations, dedicated copies of the graph can be distributed across participants through federated arrangements such that private data remains confined to respective environments while shared analytic insights can propagate across the network.

Subsequent to generating the digital record, the data processing system can receive requests (e.g., in response to selection of a link pointing to the location in memory of the digital record) from one or more other computing devices containing an identification of the digital record (e.g., in response to selections of a link corresponding to the digital record). The data processing system provision the view of the digital record to the requesting computing devices in response to receiving the requests. Users at the computing devices can access the view of the digital record and interact with the view to modify (e.g., remove or add a node or edge; or remove, add, or edit attributes of respective nodes or edges) or add records to the portion of the network graph data structure depicting or otherwise represented in the view. The data processing system can similarly provision the view in response to such requests over time, enabling collaborative updating of the portion of the network graph data structure represented or depicted in the view of the digital record.

As a result, the techniques described herein can allow external computing devices to evaluate digital records for networked items that include chains of nodes (e.g., reflecting components along the supply chain) that are part of a larger network graph structure. The techniques can allow for provisioning a view of a digital record across different computing devices, which can be dynamically updated in real time to reflect changes in the underlying network graph data structure, ensuring that all viewers access the most current and accurate information. The techniques may therefore allow the external entities, such as customs enforcement agencies, to evaluate an up-to-date record of a product's supply chain attributes. The up-to date record may therefore facilitate determination of whether products satisfy standards for import or export based on the digital record.

Furthermore, through the larger network graph structure, the computing device can efficiently identify alternative supply chain paths. For example, in response to receiving an indication from an external computing device that a subset of the chain of nodes does not satisfy a threshold (e.g., a threshold carbon emissions standard, and/or the like), the data processing system can identify compliant alternative nodes or sub-graphs within the network graph data structure and modify the chain of nodes accordingly to generate revised digital records Without the integrated and interconnected structure provided by the network graph data structure, analyzing complex interdependencies among numerous entities and processes in large-scale supply chains may be difficult due to the extensive relationships and data volume inherent in large-scale value chains. For example, identifying viable alternative supply chain segments that satisfy regulatory thresholds can involve computationally intensive searches across disjointed datasets, severely limiting scalability and responsiveness in dynamic supply chain management. Datasets associated with supply chain participants may be disjointed because they are maintained separately by different organizations, and are therefore formatted inconsistently, lack unified identifiers, standardized relational mappings, and/or the like. The network graph data structure therefore facilitates rapid substitution of non-compliant supply chain segments with compliant alternatives. Consequentially, the techniques can facilitate compliance with thresholds, such as regulations enforced by customs agencies, by allowing for provisioned views to external computing devices and enabling modifications derived from the network graph data structure based on indications from external computing devices.

Referring now to FIG. 4D, illustrated is a sequence diagram of a system 444 for dynamically modifying a network graph data structure to satisfy a threshold, in accordance with one or more embodiments. The system 444 can include the client device 402 and the data processing system 306. The data processing system 306 can include the digital record generator 320 and the network facilitator 322. Based on receiving an indication 446 that a first digital record 404a associated with networked item attributes 416a does not meet a threshold, the data processing system 306 can generate a second digital record 404b associated with a second set of networked item attributes 416b.

In some examples, the data processing system 306 can transmit the first digital record 404a to the client device 402. In response to receiving a request to generate a digital record for a networked item, the data processing system 306 can generate the digital record 404a. The data processing system 306 can do so by identifying a node for a profile of the networked item from a network graph data structure (e.g., the network graph data structure 336 of FIG. 3A), retrieving a plurality of attributes of the networked item stored at or with that node, and identifying one or more sub-graph data structures linked to the profile node that each comprise a chain of connected nodes representing network operations involving instances of the networked item. The digital record 404a may include the networked item profile 414 that represents a data structure associating key identifying information and relationships for the networked item within the network graph data structure. The digital record 404a may also include the first set of networked item attributes 416a that comprise specific descriptive data fields about the networked item, such as classifications, carbon footprint metrics, revenue information, and origin details. For example, different types of relationships between nodes (e.g., different supply connections, ownership links, transportation pathways, and/or the like) can be analyzed and aggregated to generate distinct networked item attributes reflecting provenance, regulatory certifications, environmental impact, and transactional history. Changes to nodes and/or edges of the networked item profile 414 may therefore change values included in networked item attributes.

The computing device 464 may be a device (e.g., laptop, mobile device, and/or the like). For example, the computing device 464 may be a device other than the device that submitted the request to generate the digital record or a different client device with access to the data processing system 306. As an example, a client device (e.g., the client device 402 of FIG. 4A) associated with an entity that manufactures a networked item may submit a request to generate a digital record. In this example, the computing device 464 may be a separate device operated by an authority figure, such as a customs agent. The computing device 464 may access the system to review, verify, or audit the digital record for regulatory purposes. In this example, devices associated with the data processing system 306 may be assigned distinct access permissions and role-based authorizations that govern the scope of data and functionalities available to the associated users. The access permissions may ensure that sensitive information and modification capabilities are restricted according to user credentials and organizational policies. By supporting multi-device access, the system 444 can allow external entities (e.g., customs agents) to efficiently review and act upon the networked item data without needing to originate the request (e.g., submit the request for generation of the digital record 404a).

In response to receiving the first digital record 404a, the computing device 464 may analyze the first digital record 404a for the networked item. The computing device 464 can then determine whether the first digital record 404a satisfies specified thresholds, such as regulatory standards. For example, the computing device 464 may determine whether the networked attributes 416a comply with security (e.g., network security or computer network security), environmental, safety, and trade compliance requirements. Additionally, the computing device 464 may evaluate compliance with jurisdiction-specific import/export restrictions, product safety certifications, industry-specific quality benchmarks, and/or the like. These thresholds may establish metrics that the networked item may be required or recommended to comply with for distribution to a certain market. As an example, the computing device 464 may determine that the networked item's carbon footprint (e.g., total greenhouse gas emissions associated with manufacturing the networked item) exceeds the maximum allowable limit established by environmental regulations for that market, indicating non-compliance with sustainability thresholds. Based on determining that the networked item attributes 416a do not satisfy a threshold, the computing device 464 can generate and transmit the indication 446 to the data processing system 306, specifying the particular thresholds or criteria that the digital record fails to meet.

In response to receiving the indication 446, the data processing system 306 can analyze the specified thresholds or criteria that the digital record fails to meet and modify one or more aspects of the first digital record 404a to generate the second digital record 404b. For example, the data processing system 306 may adjust nodes and/or edges of the first digital record 404a to generate the second digital record 404b that does satisfy the specified thresholds. As an example, changing a node from a supplier that is not certified for Restriction of Hazardous Substances (RoHS) compliance to a supplier that is certified for RoHS compliance may ensure that all components used to manufacture a networked item meet the European Union's requirements for limiting hazardous materials. In this example, changing the node may make the networked item eligible for sale within the European Union.

In some examples, the modifications may be generated by the network facilitator 322. For example, the network facilitator 322 may apply a set of rules to assess whether the networked item can be transferred or modified to achieve compliance with the threshold included in the indication 446. In this example, the network facilitator 322 may determine whether the networked item can be modified to achieve compliance with the threshold included in the indication while maintaining compliance with one or more other thresholds that the networked item is currently in compliance with. Applying the set of rules to the networked item may include identifying relevant digital records, extracting associated profiles and transformation data, and evaluating these against stored criteria, such as certifications, import/export restrictions, or environmental standards. Through this process, the data processing system 306 may identify alternative suppliers, substitute materials, revised transportation routes, and/or the like to determine a modification that will put the networked item in compliance with the threshold included in the indication 446.

The network graph data structure 336 may allow the network facilitator 322 to easily identify the modification. Conventionally, identifying viable alternative nodes and edges may involve computationally intensive searches across disjointed datasets. For example, these datasets may be in different languages, use varying data formats, follow inconsistent schema conventions, and/or the like. Moreover, retrieving datasets from disparate sources, where each dataset may be hosted on different platforms, governed by distinct access protocols, can be computationally expensive due to the overhead involved in data acquisition and authentication. The network graph structure 336 may facilitate identification of alternative nodes and edges by providing a unified representation that links heterogeneous data sources, enabling efficient traversal and comparison across related entities. By aggregating data from multiple sources into a unified graph-based representation, the network graph structure 336 may also reduce inconsistencies that can arise from fragmented or duplicated records across disparate systems. As a result, generating the modification based on the network graph data structure 336 may significantly reduce the computational resources used for data retrieval and reconciliation, and may improve the accuracy of the modification by leveraging a more complete and consistent view of the underlying data.

Based on the one or more modifications to the first digital record 404a, the data processing system 306 may generate the second digital record 404b that reflects these modifications. For example, the data processing system 306 can apply the modification, update the relevant node and edge attributes accordingly, and generate an updated set of compliance metrics and relationships for the networked item. In some examples, the relationships reflected in the second digital record 404b may not be applied to an overall network graph data structure 336 until confirmation is received from a client device. For example, the modifications may be presented to a client device (e.g., a device other than the computing device 464) as an option for review and approval before being committed to the network graph data structure that maintains a record of all nodes, edges, and relationships across a plurality of networked items. This may allow the data processing system 306 to provide stakeholders with actionable recommendations while preserving the integrity of the underlying data until explicit confirmation is received. The data processing system 306 can then transmit the second digital record 404b to be presented as a suggestion to the computing device 464 and/or one or more other client devices. For example, the second digital record 404b may be presented as a suggestion for supply chain modifications that would put the networked item in compliance with one or more regulations and/or industry standards that the networked item is currently not in compliance with. This may allow the data processing system 306 to automatically generate actionable recommendations for compliance, streamlining regulatory adherence and reducing manual intervention.

In some examples, the digital record generator 320 may generate the second digital record 404b as the updated version of the first digital record 404a. For example, the digital record generator 320 may receive the modification to the first digital record 404a, indicating a modification to a node or edge, and then generate the second digital record 404b that reflects this modification. The digital record generator 320 may be a component of the data processing system 306 that is responsible for assembling all relevant data into a structured digital record that accurately represents the current state of the networked item within the network graph data structure. Based on the modification, the digital record generator 320 can generate updated attributes, compliance metrics, revised relationships, and/or the like for the networked item. The digital record generator 320 may centrally manage these relationships to propagate changes efficiently, resolve potential conflicts, and maintain a consistent view of the networked item's status across distributed environments. Additionally, the digital record generator 320 may format this updated information as the second digital record 404b for presentation to client devices. By centralizing the creation and update of digital records, the digital record generator 320 may support consistency across all stakeholders interacting with the system.

Referring now to FIG. 4E, illustrated is a flowchart of a method 448 for dynamically modifying a network graph data structure to satisfy a threshold, in accordance with one or more embodiments. The method 448 can be executed, performed, or otherwise carried out by any server, data processing system (e.g., the data processing system 306 of FIG. 3A), and/or computing device (e.g., computing device 464 of FIG. 4D) described herein. In brief overview of the method 448, the method 448 can include identifying a digital record for a networked item identifying one or more sub-graph data structures comprising a chain of nodes (step 450), transmitting a message containing a link to the digital record for the networked item to a computing device (step 452), provisioning a view of the one or more sub-graph data structures to the computing device in response to receipt of selection of the link (step 454), receiving an indication of whether the chain of nodes in the sub-graph data structures satisfies a threshold (step 456), making a threshold satisfaction determination (step 458), approving the chain of nodes when the threshold is satisfied (step 460), and modifying the sequence of connected nodes in the sub-graph data structures to cause the chain of nodes to satisfy the threshold (step 462).

At step 450, the method 448 can include identifying a digital record (e.g., the first digital record 404a of FIG. 4D) for a networked item. For example, the data processing system may identify the digital record based on a request of a computing device (e.g., the computing device 464 of FIG. 4D). Additionally, or alternatively, the data processing system may identify the digital record based on a triggered workflow (e.g., receipt of a request for a network operation involving the networked item). For example, when a client device (e.g., a device other than the computing device) transmits an identification request, the data processing system may retrieve the corresponding digital record for further processing as part of a triggered workflow. The digital record may be retrieved for presentation to the computing device. In either example, the computing device may be associated with an authority organization that can audit and/or evaluate networked items (e.g., networked items of network operations being completed or performed between different geographical regions or locations) based on the associated digital records. The digital record may include one or more sub-graph data structures comprising a chain of nodes. The chain of nodes may include a sequence of connected nodes that form a path of the networked item from a source node (e.g., an initial component used to manufacture the networked item) to a destination node (e.g., a node representing the networked item). For example, the digital record may display a networked item profile (e.g., the networked item profile 414 of FIG. 4E) for a networked item (e.g., of a network operation) that displays supply chain relationships as nodes representing supply chain participants (e.g., manufacturers, suppliers, distribution centers, or transportation hubs), and edges representing relationships between the supply chain participants (e.g., transfers, shipments, or transformations of items between the supply chain participants). In some examples, the data processing system can identify the digital record by querying the graph data structure to locate a digital record linked to a node of a profile for a networked item. The data processing system may query the graph data structure based on one or more identifiers included in a request received from the computing device. For example, the data processing system can identify the digital record by matching identifiers (e.g., identifiers associated with a request and/or triggered workflow) and linking associated sub-graph data structures each defining a sequence of nodes forming a path of instances of the networked item.

At step 452, the method 448 can include transmitting a message containing a link to the digital record for the networked item to a computing device. For example, the data processing system can transmit a message that includes a Hypertext Transfer Protocol (HTTP) link referencing the digital record for remote access by the computing device. The link may correspond to a generated Uniform Resource Locator (URL) identifying the digital record for later retrieval in an interactive interface. For example, the data processing system may generate a URL that includes an HTTP link. The generated URL, formatted as an HTTP link, enables secure and direct access to the digital record via a browser-based interface. A browser-based interface may be any web-enabled graphical user interface (GUI) that allows interaction with digital content via browser-executed code (e.g., HyperText Markup Language (HTML), and/or the like). A browser may be any application that enables users to access, navigate, and interact with resources hosted on the World Wide Web. The message can be transmitted following generation or retrieval of the digital record. For example, after identifying the networked item's digital record, the data processing system can authorize the computing device and then send the link to the client once network authorization for the computing device is verified. In some examples, the digital record may be rendered at the computing device based on the URL. For example, in response to receiving selection of the link, the digital record may be rendered for display in the browser-based interface of the computing device.

At step 454, the method 448 can include provisioning a view of the one or more sub-graph data structures to the computing device in response to receipt of selection of the link. For example, the data processing system can provision a live (e.g., dynamically generated) view of the linked sub-graph data structures to the computing device upon receiving link selection confirmation. The selection of the link may generate an API response that initiates data retrieval and/or rendering. In response to link activation (e.g., selection of the link by the computing device), data processing system can generate a visualization showing nodes connected by edges within selected sub-graph data structures for presentation via a user interface.

At step 456, the method 448 can include receiving an indication of whether the chain of nodes in the sub-graph data structures satisfies a threshold. For example, the computing device can transmit an indication via the provisioned view reflecting whether the chain of nodes in one or more sub-graph data structures satisfies one or more thresholds to the data processing system. The indication may include evaluation scores, an indication of passing or failing one or more thresholds, recommended modifications, and/or the like. For example, the indication may include analytical or compliance evaluation results transmitted from the computing device through a network interface. The indication may be generated based on user input and/or one or more operations (e.g., evaluation operations) executed by the computing device. In some examples, the computing device may generate the indication at least in part based on networked attributes (e.g., networked item attributes 416 of FIG. 4B). For example, the computing device can determine whether values (e.g., carbon footprint) or other attributes (e.g., country of origin) indicated by the networked attributes satisfy one or more thresholds.

In some embodiments, the data processing system may receive, from the computing device, a request for additional information along with the indication. For example, the computing device may transmit a request for further information about a node and/or other relationships associated with a node. In an example, the computing device may transmit a request for an origin of the networked item. In response to the request, the data processing system can identify a relevant data structure that identifies the origin of the networked item and append the data structure to the view of the one or more sub-graph data structures rendered at the computing device. The data structure may be an additional chain of nodes that can be appended to a node in the chain of nodes originally presented to the computing device.

In some embodiments, the computing device may generate a set of compliance flags. For example, the computing device can generate compliance flags for each node in the chain of nodes, and/or for a particular network operation, based on evaluating the node attributes against a rule set comprising structured criteria. Structured criteria may define parameters (e.g., thresholds, definitive attributes such as country of origin, networked item type or classification, value, networked item characteristics, substructure rules (e.g., number of hops or nodes of a particular substructure), and/or the like) that can be used to classify nodes or network operations as compliant or non-compliant. Node attributes may be any metadata associated with a node, such as location, certifications (e.g., Fair Labor Association (FLA) certification), and/or the like. Based on determining that at least one compliance flag fails to satisfy the structured criteria, the computing device can generate the indication. For example, based on determining that a node is associated with a country that is currently under embargo (e.g., by a country associated with computing device), and therefore does not satisfy the rule set, the data processing system can generate the indication. In this example, the rule set may include further conditions. For example, the rule set may determine that a node corresponds to a country subject to an embargo on a category of products that includes the item associated with the node. In some examples the computing device may update compliance flags as attributes of nodes change. For example, in response to determining that updated attributes of a node comply with the defined set of criteria, the computing device can update the flag accordingly to reflect the compliance of the node. Additionally, or alternatively, compliance flags may be generated and/or updated by the data processing system.

In an example, the rule set applied by the computing device can include one or more rules corresponding to the destination of a networked operation. For example, the data processing system can receive a request for a digital record for a network operation involving transport of a networked item being shipped between two regions. The request can include an indication of the origin and/or destination (e.g., final destination) for the network operation. The digital record can include a view into nodes involved in the network operation, including the final destination of the networked item. The data processing system can determine, or transmit to a computing device to determine, whether the final destination (or any other stop of the network operation) identified in the request satisfies a threshold (e.g., a particular rule or criterion). The data processing system can do so using the digital record of the networked item of the network operation. For instance, the data processing system can identify the digital record corresponding to the networked item. The data processing system can use the digital record to access a view of the network graph data structure that includes nodes involved in the network operation, which, in some cases, may be displayed based on the nodes being involved in previous operations of the networked item that were used to update or modify the network graph data structure (e.g., the portion of the network graph data structure accessible through the digital record).

The data processing can retrieve attributes of the nodes and compare the attributes to the rules to determine whether the attributes fail satisfy any of the rules. For instance, the data processing system can identify the node for the destination, retrieve a geographic attribute of the node indicating a geographic location or region of the destination, and compare the geographic location or region to a list of restricted geographic locations or regions. The data processing system can determine a threshold is not satisfied responsive to determining a match. The data processing system can similarly determine whether to restrict or modify sequences of nodes represented in the digital record based on attributes (e.g., geographic attributes or any other attributes) of any nodes in the digital record, in some cases only doing so for nodes identified in the request as being involved in the network operation. If the data processing system transmits the digital record to another computing device to perform a check, the computing device can similarly use the digital record to apply rules to data represented in the digital record.

At step 458, the method 448 can include determining whether the chain of nodes in the sub-graph data structures satisfy a threshold. For example, the data processing system can determine, based on the information included in the indication, whether the chain of nodes satisfies a threshold. In this example, the data processing system may evaluate the networked item in reference to a plurality of thresholds and may systematically determine whether the networked item satisfies each of the thresholds. This determination can include determining whether evaluation scores received from the computing device satisfy a threshold. As an example, the computing device may generate a food safety score for a networked item representing a food product. The computing device may generate the food safety score based on historical food safety events (e.g., product recalls, contamination incidents, failed inspections) from various suppliers included in the digital record. Based on the food safety score, the data processing system can determine whether the networked item satisfies a threshold food safety score. As another example, the computing device may determine whether the networked item satisfies the threshold based on a direct indication from the computing device. For example, the computing device may transmit an indication that a product includes components from an embargoed country, which makes the product ineligible for import to the country that issued the embargoes. The computing device can then generate an indication that the networked item does not satisfy a threshold (e.g., 0% embargoed components), and the data processing system can directly determine that the chain of nodes in the sub-graph data structures does not satisfy the threshold based on the indication.

At step 460, the method 448 can include approving the chain of nodes when the threshold is satisfied. For example, in response to determining that the chain of nodes satisfies one or more relevant thresholds, the data processing system can approve the chain of nodes. In some examples, the data processing system may internally log the approval. Additionally, or alternatively, the data processing system may generate and transmit a notification to one or more associated client devices based on the approval. The data processing system may also trigger a workflow (e.g., shipment release, contract validation, and/or the like) based on the chain of nodes satisfying the threshold.

At step 462, the method 448 can include modifying the sequence of connected nodes in the sub-graph data structures to cause the chain of nodes to satisfy the threshold. For example, in response to determining, based on the indication, that the sequence of connected nodes do not satisfy the threshold, the data processing system can modify the sequence of connected nodes forming the path based on the indication received to generate a modified digital record (e.g., the digital record 404b of FIG. 4D). The modification may cause the chain of nodes to satisfy the threshold. For example, modifications such as replacing non-compliant suppliers, rerouting logistics paths, updating ingredient sources, adjusting facility assignments, and/or the like can change the networked attributes of the networked item. These modifications may place the networked item in compliance with the threshold. The data processing system can perform modification by querying the network graph for alternate nodes satisfying rule sets and updating the chain of nodes with valid replacements. For example, a search routine may identify and merge compliant sub-graph paths to rebuild a valid chain satisfying the rule set constraints.

The data processing system can generate the modifications based on the network graph data structure (e.g., the network graph data structure 336 of FIG. 3A). By using the network graph data structure, the data processing system can efficiently identify compliant alternatives by traversing interconnected nodes and evaluating rule sets in a computationally optimized manner. As an example, if a supplier node fails to meet sustainability criteria, the data processing system may identify an alternative supplier node within the graph that meets the required environmental standards and is logistically compatible with the existing chain. The alternative supplier node may be associated with another supply chain. Maintaining the nodes and edges of a plurality of supply chains within a unified network graph data structure may therefore provide an efficient data source from which to retrieve alternative nodes and edges for modifications of the sequence of nodes of the networked item.

In some embodiments, the data processing system may modify the sequence of connected nodes based on a rule set received from the computing device. For example, as part of the indication, the computing device may include the rule set. The rule set may include geographic exclusion parameters encoded in a structured compliance schema. As described herein, geographic exclusion parameters may refer to a list of one or more geographic areas that are restricted (e.g., excluded) from inclusion in the network graph path due to regulatory, trade, or policy constraints. For example, certain countries may be excluded from import to another country due to embargoes. As another example, certain geographical areas may be subject to quarantine restrictions (e.g., of livestock) or environmental protection regulations that limit (e.g., exclude) the transport or processing of networked items within those regions. As described herein, a structured compliance schema may refer to a formalized framework or data model that encodes the rule set into machine-readable patterns (e.g., to enable automated evaluation by systems like the data processing system). In some examples, the data processing system may generate the modification based on the structured compliance schema. For example, the data processing system can modify the sequence of connected nodes by replacing a node tagged with a geolocation attribute matching a restricted region with a substitute node having a geolocation attribute outside the restricted region. As an example, a country under embargo may be within the restricted region, while a country not under embargo may be outside the restricted region. Nodes may be tagged with information when they are associated with metadata (e.g., networked attributes) that indicate the information. A geolocation attribute may indicate a geographic location where the product (e.g., the networked item or component of the networked item) was created (e.g., manufactured, grown, and/or the like).

In some embodiments, the data processing system can modify the digital record by merging sub-graph data structures. For example, the data processing system can identify a second sub-graph data structure comprising a second chain of nodes linked to a second digital record. The second sub-graph may represent an alternative supply chain for a component that is the same or similar to a component of the networked item. As an example, if the networked item is a vehicle battery manufactured in the United States, the computing device can transmit an indication that a node corresponding to cathode materials sourced from a mine in Indonesia does not satisfy a sustainability threshold. Based on the indication, the data processing system may identify a second sub-graph structure associated with a laptop battery. The second sub-graph data structure may include cathode materials sourced from another supplier and/or country that is closer to the United States (e.g., Canada), and therefore reducing carbon emissions associated with transport of materials. The data processing system may query (e.g., by specifying geographic constraints such as preferred countries or regions) the network graph data structure to retrieve the second sub-graph data structure. The network graph data structure may provide a data source from which the data processing system can efficiently query to retrieve alternative nodes and edges (e.g., rather than executing a computationally intensive search across disjointed datasets). The data processing system can modify the digital record by merging the second sub-graph data structure into the digital record. For example, the data processing system may replace at least part of the first sub-graph data structure with at least part of the second sub-graph data structure. The data processing system may maintain other nodes and edges associated with the digital record when replacing at least part of the first sub-graph data structure, therefore merging the second sub-graph data structure into a composite path. Modifying the digital record by merging in other sub-graph data structures may change the networked attributes of the digital record. For example, the networked attributes of the composite path may be associated with lower carbon emissions. As a result, a modified digital record that includes the composite path may satisfy the threshold indicated by the computing device.

In some embodiments, the data processing system can modify the digital record by retrieving a missing attribute for a node. For example, the data processing system can determine that a node is missing an attribute. The data processing system may detect the missing attribute by comparing node metadata against a schema of required field-value pairs. Node metadata may be descriptive information such as facility characteristics, compliance statuses, operational metrics, or certification details associated with a node. Required field-value pairs may be predefined mandatory data elements, including safety certifications, environmental impact measurements, and regulatory identifiers that can be used to evaluate compliance with relevant standards. Upon successful retrieval, the data processing system can update (e.g., modify) the node metadata to include this attribute. For example, the data processing system can insert the missing attribute into the node metadata. In this example, the modification can cause the chain of nodes to satisfy import regulations and/or origin-based thresholds.

As an example, the threshold may be associated with country of origin for components of the networked item. The threshold may require that a fraction of the components of the networked item be from a group of countries, may ban certain countries of origin, and/or the like. Based on determining that the country of origin attribute is missing or incomplete for a supplier node within the chain of nodes representing the supply chain (e.g., by comparing node metadata against a schema of required field-value pairs), the data processing system can query internal or external authoritative data sources to retrieve accurate country of origin information. Upon successful retrieval, the data processing system can update (e.g., modify) the node metadata to include the country of origin.

In some examples, a missing attribute may be an attribute that is out of date. Being out of date may refer to surpassing an associated period of validity. The data processing system may determine that an attribute (e.g., carbon emission value) is out of date based on a date associated with the attribute (e.g., a date of the last update to the attribute) and a period of validity associated with the attribute. Based on this determination, the data processing system can retrieve a current carbon emission value for the node. The current carbon emission value may change the networked attributes of the networked item. For example, the current carbon emission value may be lower than the out of date value. As a result, retrieving the missing attribute may cause the chain of nodes to satisfy the one or more thresholds.

In some embodiments, the data processing system may request approval for the modification by transmitting the digital record along with an authentication token to a requesting device. For example, the data processing system can use an authentication token to request approvals for modifications. An authentication token may be a cryptographically secure digital credential that uniquely verifies the integrity and authorization status of the modified digital record. Cryptographically secure digital credentials may be encrypted digital signatures (e.g., Rivest-Shamir-Adleman (RSA) signatures, Elliptic Curve Digital Signature Algorithm (ECDSA) signatures, and/or the like) that authenticate the source of the modification to prevent tampering.

The data processing system can append the authentication token to the digital record in response to modifying the sequence of connected nodes. The data processing system can then identify and transmit the digital record with the appended authentication token in response to a request from a requesting device. In an example, the requesting device may be either the computing device (e.g., a device associated with a customs agent) or a second computing device (e.g., a device associated with an entity that manufactures the networked item). As an example, the computing device may approve the addition of missing attributes to the nodes. As another example, the second computing device may approve changes to the chain of nodes (e.g., changes to the supply chain). The computing device and/or second computing device may transmit the request to validate product compliance, facilitate changes to supply chains, and/or the like. By transmitting the digital record with the appended authentication token to the requesting device, the data processing system can trigger an authentication process. For example, the authentication token may trigger automated approval logic that can be used to approve the modification. The automated approval logic may be rule-based algorithms, machine learning models, or smart contract protocols that evaluate the authentication token and associated metadata to determine whether the modification meets predefined compliance criteria. Additionally, or alternatively, the authentication token may cause a prompt for user input (e.g., from a user of the requesting device) for authentication. In response to receiving approval, the data processing system may implement the modification in a larger network graph data structure (e.g., the network graph data structure 336 of FIG. 3A).

In some embodiments, the data processing system may modify the digital record by replacing a subset of nodes within the chain of nodes. For example, the data processing system can receive a threshold from the computing device (e.g., as part of the indication) and then identify that a first subset of nodes in the chain of nodes fail to satisfy the threshold. The threshold may include a rule set that includes node-level attribute constraints and/or edge-level transaction metadata. A node-level attribute constraint may be regulatory certification requirements, maximum allowable carbon emission values, and/or the like. Edge-level transaction metadata may be shipment dates, transportation methods, quantity limits associated with the movement of the networked items between nodes, and/or the like. The data processing system can search for nodes of the network graph data structure that are outside the chain of nodes based on the defined rule set. Based on the search, the data processing system can identify a second subset of nodes that satisfy the defined rule set. For example, if the rule set requires a valid safety certification and a threshold carbon emission profile that the networked item does not satisfy (e.g., the networked item is associated with carbon emissions higher than the threshold), the data processing system may locate alternative supplier nodes possessing valid safety certifications and lower carbon emission profiles that comply with the maximum emissions threshold. The data processing system can then modify the sequence of nodes by replacing the first subset of nodes with at least part of the second subset of nodes retrieved by the search.

In some embodiments, the data processing system can determine the modification using a model (e.g., machine learning model, such as a neural network, and/or the like). The data processing system can determine that the chain of nodes fails to meet a first threshold corresponding to emission values (e.g., carbon emissions, and/or the like). The data processing system can then identify an emission value for each node and execute a model using each emission value to identify an at-risk node of the chain of nodes. The at-risk node may be a node that exhibits relatively high emissions compared to other nodes within the chain, or is identified by the model as the most effective opportunity for emissions reduction based on factors such as emission magnitude, supply chain position, and potential impact on overall network compliance. The data processing system can replace the at-risk node with a new node. The new node may correspond to a new emission value below a second threshold. In some examples, the replacement may result in the emission value of the chain of nodes falling below the first threshold, and therefore being in compliance with the first threshold.

As an example, the networked item may be specific electric vehicle battery model within the network graph data structure. In response to a request from a client device (e.g., associated with the manufacturer of the battery) the data processing system may generate a digital record including one or more sub-graph data structures with nodes representing supply chain participants (e.g., raw material miners, cathode and anode material processors) and edges representing relationships between those supply chain participants. The digital record may be a path from at least one source node (e.g., an initial material, such as mined lithium) to a destination node (e.g., a node representing the battery). The digital record may also include a set of networked attributes that include attributes of the vehicle battery, such as origin of materials, safety test results, ethical standards (e.g., fair labor practices) and/or the like.

In some examples, the digital record may be provided to a computing device. For example, the digital record may be provided based on a request from the client device and/or as part of an automated workflow that is triggered based on the generation of the digital record. The computing device may be associated with an authority, such as a customs agency, regulatory body, or certification authority responsible for reviewing, verifying, or approving the compliance and documentation of the vehicle battery. For example, the computing device may be associated with a United States customs agent that can determine whether the vehicle battery is approved for import into the United States. The data processing system may transmit a message containing a link to the digital record and then provision a view of the one or more sub-graph data structure and/or the networked attributes in response to selection of the link. The data processing system can provision the view by dynamically generating (e.g., based on the most current node and edge information within the network graph data structure) a visual representation of sub-graph data structures. The computing device can then transmit an indication of whether the vehicle battery satisfies one or more thresholds. As an example, the computing device can generate an indication that the battery contains cobalt sourced from a supplier in a country under embargo for mineral resources, which does not satisfy import compliance standards for the United States. The indication may be generated based on user input and/or pre-established evaluation logic processed by the computing device.

The computing device may evaluate whether all components are sourced from countries not under embargo as the threshold. In response to receiving an indication that the vehicle battery does not satisfy a threshold, the data processing system may modify one or more of the data structures associated with the digital record. For example, the data processing system may replace nodes representing components sourced from embargoed countries with alternative supplier nodes located in compliant regions. Additionally, the data processing system may adjust the corresponding edges to reflect updated shipping routes or transactions that adhere to regulatory requirements. These modifications can generate a revised digital record that aligns with the specified threshold for permissible sourcing.

The data processing system may identify alternative nodes and edges from the network graph data structure. While conventional methods of identifying alternative nodes and edges may involve data reconciliation (e.g., identifying inconsistencies between datasets), non-standard labels, and slow traversal of fragmented datasets, the method 448 may allow the computing system to dynamically evaluate and substitute non-compliant supply chain segments (e.g., individual nodes and/or sub-graph data structures) by searching through the network graph data structure. For example, the data processing system can execute a search query within the network graph data structure with filters for cobalt suppliers that are not from countries that are under embargo with the United States. The data processing system may also apply additional filters, such as those related to carbon emissions or indicators of child labor involvement. The other filters may maintain compliance with other thresholds. The network graph data structure therefore provides an interconnected representation of entities and their relationships, significantly increasing the efficiency and scalability of compliance-driven substitutions by enabling rapid traversal, targeted queries, and context-aware filtering within a coherent data framework.

In this example, the data processing system may maintain compliance with other thresholds while generating these modifications. For example, when substituting a supplier node to comply with geographic sourcing restrictions, the system may select an alternative supplier whose production emissions remain below the established carbon footprint threshold, thereby preserving environmental compliance while updating the digital record. In some examples, the data processing system can modify a larger network graph data structure (e.g., the network graph data structure 336 of FIG. 3A) based on these modifications. For example, the data processing system may present the modified digital record to the client device associated with the battery manufacturer. In response to receiving approval, the data processing system may apply the modification to the network graph data structure.

In some embodiments, the described systems and methods can be used to implement network security measures at the different nodes. For example, the data processing system may enforce node and/or edge-level access permissions. By executing modifications to digital records based on appending authentication tokens to digital records, the data processing system can validate the authenticity of the modification before committing it to the record. For example, before applying a modification, the data processing system can verify that the client device has permission to alter a specific node or edge, and that the request originates from the device itself, by validating the cryptographic signature of the authentication token. Furthermore, the machine learning model can resolve conflicting edits when a node has been compromised. For example, if an unauthorized user attempts to make edits to the node, the machine learning model may determine that the unauthorized edit is suspicious based on access credentials associated with the unauthorized user and/or historical editing patterns of the node. If the edit is determined to be suspicious or in violation of access policies, the system can automatically reject the modification, generate an alert for security personnel, and/or restore the node to its last known secure state. As an example, an authorized user may be the victim of a phishing attack. The machine learning model can detect that an attempted modification from the account of the user is unusual (e.g., originates from an unusual location, occurs at unusual hours, or modifies information that usually does not need to be updated) and reject the modification based on the detection.

In another example, a data processing system including a network server, one or more processors, and memory stores executable instructions that enable dynamic modification of a network graph data structure representing a supply chain of IoT-enabled shipping containers. The data processing system identifies, within a digital record associated with a particular container, two sub-graph data structures linked to the container's profile. Each sub-graph includes a sequence of connected nodes forming a path from a manufacturing origin node to a retail destination node, where each node represents a port authority, customs checkpoint, or logistics hub, and each edge represents the transfer of the container between these entities. The path visualizes the operational transit history of the container from the source node through the sequence of nodes until reaching its destination. Responsive to detecting that certain nodes report excessive dwell times or missing compliance metadata, the system transmits a message containing a link to the container's digital record to an authorized logistics manager's computing device.

The data processing system receives a link selection from the logistics manager and provisions a browser-based visualization of the sub-graph data structures on the manager's device. Using this interactive view, the manager supplies an indication to the system that a portion of the path fails to meet efficiency and compliance thresholds defined in an internal policy rule set. Embedded in that indication is a structured compliance schema which includes a geographic exclusion parameter forbidding the container from transiting through a restricted customs zone. The system automatically detects a node within the chain tagged with a geolocation attribute matching the restricted region, replaces it with a substitute node corresponding to an alternate route outside the restricted zone, and adjusts the path accordingly so that the modified chain satisfies the compliance threshold.

In another example, the logistics manager requests the origin information for the container while providing the path modification indication. In response, the data processing system retrieves archival records from a manufacturing database identifying the plant of origin and appends a data structure with that origin metadata to the chain of nodes in the displayed sub-graph view. Concurrently, the system evaluates an environmental threshold specified in sustainability rules, determines that several nodes along the chain fail emission value requirements, and executes an emissions optimization model using the recorded emission values at those nodes. The model identifies a high-risk customs checkpoint node with emissions above acceptable limits, which the system replaces with a lower-emission processing facility node from the network graph data structure, thereby satisfying both environmental and compliance thresholds.

During interactive modification sessions, the system includes in the sub-graph view a flag for each node indicating whether it meets defined operational, environmental, and compliance criteria. The manager's indication that the path fails threshold requirements is generated based on observing these flags in the visualization. Additionally, when a node is missing a required attribute defined in a metadata schema, such as an inspection timestamp, the system detects the discrepancy, inserts the missing value into the node's metadata, and revalidates the path, ensuring conformity with the structured compliance schema. The data processing system can also merge two distinct sub-graph chains, retrieved from separate digital records, into a composite path that meets the required thresholds.

Finally, when threshold compliance has been restored, the data processing system appends an authentication token to the digital record for the container, encoding proof of compliance for automated approval logic in downstream customs systems. If a second request for the networked item is received from another authorized computing device, the system locates the digital record with its appended token and transmits it to the requesting system over a secure HTTP link generated by the processor. In some instances, the system uses the thresholds provided by the manager to conduct a broader search across the network graph for alternative nodes that satisfy all constraints, replacing the deficient nodes in the chain with the optimal substitutes identified. This enables continual, dynamic optimization of operational paths while maintaining regulatory, geographic, and environmental compliance.

In some implementations, the data processing system can use the digital record to implement real-time screening for a network operation corresponding to the digital record. For example, the data processing system can receive or retrieve the digital record from an entity involved in a networked operation, such as an entity transmitting or receiving a networked item of the networked operation corresponding to the digital record. The data processing system can provision the view of the network graph data structure corresponding to the digital record network operation to a client device and determine whether the chain of nodes in the sub-graph data structures satisfies a threshold, as described herein. The data processing system can retrieve attributes of the respective nodes and/or edges of the sub-graph data structures, such as geographic attributes, flags indicating malicious behavior (e.g., smuggling, trafficking, or fraud, which may have been previously determined for respective nodes or sub-graph data structures) or any other characteristic of individual nodes, metrics, such as emission values, etc.), from the respective nodes and/or edges. The data processing system can retrieve attributes of the respective sub-graph data structures or the networked itself from the digital record. The data processing system can compare the attributes to a threshold (e.g., a defined value, a defined rule, or a defined rule set). The data processing system can generate a flag indicating compliance or non-compliance based on whether the retrieved attributes chain of nodes or other data in the sub-graph data structures represented in the sub-graph data structures satisfies the threshold (e.g., exceeds or is less than the threshold or a satisfied rule or rule set of one or more rules) and generate an alert including the flag. The data processing system can transmit the alert to the client device. The alert can restrict the network operation responsive to determining the data does not satisfy the threshold and/or allow the network operation responsive to determining the data satisfies the threshold.

The systems and methods described herein provide technical benefits by enabling automated, server-directed modification of complex network graph data structures representing real-world operational flows, such as supply chains or data transmission pathways, without requiring complete intensive complete reconstruction of the graph. The systems and methods solve technical problems including: (i) inefficient identification of non-compliant or suboptimal nodes within vast, dynamically changing graphs; (ii) delays and computational overhead associated with rebuilding chains from scratch when operational criteria fail; (iii) inability to enforce structured compliance rules directly within a live network visualization; and (iv) lack of integrated mechanisms for merging disparate sub-graphs while preserving threshold satisfaction. By provisioning interactive sub-graph views to client devices, analyzing node-level and edge-level metadata against defined rule sets, and performing automated substitution of deficient nodes with compliant alternatives, the system improves the speed, accuracy, and scalability of network operation management. These improvements leverage specific computer capabilities, including metadata schema validation, emissions model execution, and rule-based graph traversal, to achieve more efficient data structure processing than could be performed using routine conventional techniques, thereby providing a concrete technological solution to problems in dynamic network graph modification.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as LISP, PERL, C, C++, C#, PROLOG, or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing device that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the networked items listed thereafter, equivalents thereof, and additional networked items, as well as alternate implementations consisting of the networked items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional networked items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

For example, descriptions of positive and negative electrical characteristics may be reversed. Elements described as negative elements can instead be configured as positive elements and elements described as positive elements can instead by configured as negative elements. For example, elements described as having first polarity can instead have a second polarity, and elements described as having a second polarity can instead have a first polarity. Further relative parallel, perpendicular, vertical or other positioning or orientation descriptions include variations within +/−10% or +/−10 degrees of pure vertical, parallel or perpendicular positioning. References to “approximately,” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

What is claimed is:

1. A system for dynamically revising a structure of a network graph data structure using a generated view of the network graph data structure, comprising:
a server comprising one or more processors configured by instructions stored in memory, the memory comprising:
a network graph data structure storing a network of nodes and edges between the network of nodes, the network graph data structure digitally representing types of relationships between entities represented by the network of nodes and networked items; and
a digital record generator configured to generate dedicated views of portions of the network graph data structure;
the one or more processors configured by the instructions stored in the memory to:
receive, from a client device via a user interface, a request to generate a digital record for a networked item, the request comprising an identification of the networked item;
activate the digital record generator in response to the request to cause the digital record generator to:
identify, based on the identification, a node for a profile for the networked item from the network graph data structure;
identify a plurality of attributes of the networked item stored at or with the node for the profile for the networked item;
identify, for the networked item, one or more sub-graph data structures of the network graph data structure each linked to the node of the profile for the networked item and comprising a chain of nodes, the chain of nodes comprising a sequence of connected nodes forming a path of one or more instances of the networked item from a source node to a destination node,
wherein the path represents network operations of the one or more instances of the networked item through the sequence of connected nodes,
wherein each node of the sequence of connected nodes represents an entity performing a network operation on the one or more instances of the networked item, and
wherein each edge between one or more pairs of the sequence of connected nodes represents movement of the one or more instances of the networked item from a first node of the pair of nodes to a second node of the pair of nodes;
generate the digital record identifying the plurality of attributes of the networked item and the identified one or more sub-graph data structures for the networked item;
communicate the digital record for presentation via the user interface at the client device; and
revise a node or edge of the one or more sub-graph data structures of the network graph data structure based on a user input into the digital record from the user interface.

2. The system of claim 1, wherein the one or more processors are configured to receive the request to generate a digital record for a networked item by:
receiving a user-generated input identifying the networked item and associated access permissions corresponding to levels of access with different nodes of the network graph data structure,
wherein the one or more processors are configured to identify the one or more sub-graph data structures based on the access permissions.

3. The system of claim 2, wherein the one or more processors are configured to identify the one or more sub-graph data structures by:
identifying a plurality of nodes or sub-graph data structures that are linked with the node for the networked item;
comparing the access permissions with access restrictions associated with each of the plurality of nodes or sub-graph data structures; and
identifying, based on the comparison, the one or more sub-graph data structures responsive to determining the access permissions of a user providing the user input satisfy access restrictions of each of the one or more sub-graph data structures and nodes within the sub-graph data structures.

4. The system of claim 1, wherein the one or more processors are configured to communicate the digital record for presentation via the user interface at the client device by:
transmitting a Hypertext Transfer Protocol (HTTP) link corresponding to the digital record to the client device;
receiving a selection of the HTTP link from the client device; and
transmitting a view of the one or more sub-graph data structures to the client device for presentation in response to receiving the selection of the HTTP link from the client device.

5. The system of claim 4, further comprising generating the view by:
configuring the view to depict each of the one or more sub-graph data structures, the configuration depicting nodes connected by lines within each of the respective one or more sub-graph data structures.

6. The system of claim 4, wherein the one or more processors are configured to transmit the view of the one or more sub-graph data structures by:
transmitting a file containing data objects representing nodes within each of the one or more sub-graph data structures; and
wherein the one or more processors are configured to revise the node or edge of the one or more sub-graph data structures of the network graph data structure by:
receiving, from the client device, the user input indicating a change to a data object representing the node or edge of the one or more sub-graph data structures;
identifying the node or edge that corresponds to the changed data object; and
propagating the change from the changed data object to the identified node or edge.

7. The system of claim 6, wherein the one or more processors are configured to propagate the change from the changed data object to the identified node or edge in response to determining an access credential of a user providing the user input satisfies an access restriction of the identified node or edge.

8. The system of claim 4, wherein the one or more processors are configured to transmit the view of the one or more sub-graph data structures by:
transmitting the one or more sub-graph data structures to the client device; and
wherein the one or more processors are configured to revise the node or edge of the one or more sub-graph data structures of the network graph data structure by:
receiving, from the client device, the user input indicating a change to the node or edge of the one or more sub-graph data structures; and
propagating the change to the identified node or edge.

9. The system of claim 1, wherein the one or more processors are further configured to:
prior to revising the node or edge of the one or more sub-graph data structures, determine whether the revision conflicts with any other pending revisions to the node or edge; and
revise the node or edge response to determining the revision does not conflict with any other pending revisions.

10. The system of claim 1, wherein the one or more processors are further configured to:
prior to revising the node or edge of the one or more sub-graph data structures, determine whether the revision conflicts with any other pending revisions to the node or edge;
detect a conflict between the revision and a pending revision from a second user input originating from a second computing device;
execute a machine learning model using the revision and the pending revision as input to cause the machine learning model to output a selection of the revision as the correct revision, the machine learning model trained based on labeled training data of conflicting revisions to the network graph data structure; and
revise the node or edge based on the output of the machine learning model.

11. A method for dynamically revising a structure of a network graph data structure using a generated view of the network graph data structure, comprising:
receiving, by a server comprising one or more processors, from a client device via a user interface, a request to generate a digital record for a networked item, the request comprising an identification of the networked item;
identifying, based on the identification, a node for a profile for the networked item from a network graph data structure, the network graph data structure storing a network of nodes and edges between the network of nodes digitally representing types of relationships between entities and networked items represented by the network of nodes;
identifying, by the server, a plurality of attributes of the networked item stored at or with the node for the profile for the networked item;
identifying, by the server for the networked item, one or more sub-graph data structures of the network graph data structure each linked to the node of the profile for the networked item and comprising a chain of nodes, the chain of nodes comprising a sequence of connected nodes forming a path of one or more instances of the networked item from a source node to a destination node,
wherein the path represents network operations of the one or more instances of the networked item through the sequence of connected nodes,
wherein each node of the sequence of connected nodes represents an entity performing a network operation on the one or more instances of the networked item, and
wherein each edge between one or more pairs of the sequence of connected nodes represents movement of the one or more instances of the networked item from a first node of the pair of nodes to a second node of the pair of nodes;
generating, by the server, the digital record identifying the plurality of attributes and the one or more sub-graph data structures;
communicating, by the server, the digital record for presentation via the user interface at the client device; and
revising, by the server, a node or edge of the one or more sub-graph data structures of the network graph data structure based on a user input into the digital record from the user interface.

12. The method of claim 11, wherein receiving the request to generate a digital record for a networked item comprises:
receiving a user-generated input identifying the networked item and associated access permissions corresponding to levels of access with different nodes of the network graph data structure,
wherein identifying the one or more sub-graph data structures is based on the access permissions.

13. The method of claim 12, wherein identifying the one or more sub-graph data structures comprises:
identifying a plurality of nodes or sub-graph data structures that are linked with the node for the networked item;
comparing the access permissions with access restrictions associated with each of the plurality of nodes or sub-graph data structures; and
identifying, based on the comparison, the one or more sub-graph data structures responsive to determining the access permissions of a user providing the user input satisfy access restrictions of each of the one or more sub-graph data structures and nodes within the sub-graph data structures.

14. The method of claim 11, wherein communicating the digital record for presentation via the user interface at the client device comprises:
transmitting a Hypertext Transfer Protocol (HTTP) link corresponding to the digital record to the client device;
receiving a selection of the HTTP link from the client device; and
transmitting a view of the one or more sub-graph data structures to the client device for presentation.

15. The method of claim 14, further comprising generating the view by:
configuring the view to depict each of the one or more sub-graph data structures, the configuration depicting nodes connected by lines within each of the respective one or more sub-graph data structures.

16. The method of claim 14, wherein transmitting the view of the one or more sub-graph data structures comprises:
transmitting a file containing data objects representing nodes within each of the one or more sub-graph data structures; and
wherein revising the node or edge of one or more sub-graph data structures of the network graph data structure comprises:
receiving, from the client device, the user input indicating a change to a data object representing the node or edge of the one or more sub-graph data structures;
identifying the node or edge that corresponds to the changed data object; and
propagating the change from the changed data object to the identified node or edge.

17. The method of claim 11, further comprising:
prior to revising the node or edge of the one or more sub-graph data structures, determining whether the revision conflicts with any other revisions to the node or edge;
detecting a conflict between the revision and a pending revision from a second user input originating from a second computing device;
executing a machine learning model using the revision and the pending revision as input to cause the machine learning model to output a selection of the revision as the correct revision, the machine learning model trained based on labeled training data of conflicting revisions to the network graph data structure; and
revising the node or edge based on the output of the machine learning model.

18. A non-transitory computer-readable medium storing instructions that, when executed by one or more processors, cause the one or more processors to perform operations comprising:
receiving, from a client device via a user interface, a request to generate a digital record for a networked item, the request comprising an identification of the networked item;
identifying, based on the identification, a node for a profile for the networked item from a network graph data structure, the network graph data structure storing a network of nodes and edges between the network of nodes digitally representing types of relationships between entities and networked items represented by the network of nodes;
identifying a plurality of attributes of the networked item stored at or with the node for the profile for the networked item;
identifying, for the networked item, one or more sub-graph data structures of the network graph data structure each linked to the node of the profile for the networked item and comprising a chain of nodes, the chain of nodes comprising a sequence of connected nodes forming a path of one or more instances of the networked item from a source node to a destination node,
wherein the path represents network operations of the one or more instances of the networked item through the sequence of connected nodes,
wherein each node of the sequence of connected nodes represents an entity performing a network operation on the one or more instances of the networked item, and
wherein each edge between one or more pairs of the sequence of connected nodes represents movement of the one or more instances of the networked item from a first node of the pair of nodes to a second node of the pair of nodes;
generating the digital record identifying the plurality of attributes and the one or more sub-graph data structures;
communicating the digital record for presentation via the user interface at the client device; and
revising a node or edge of the one or more sub-graph data structures of the network graph data structure based on a user input into the digital record from the user interface.

19. The non-transitory computer-readable medium of claim 18, wherein the operations further comprise:
receiving a user-generated input identifying the networked item and associated access permissions corresponding to levels of access with different nodes of the network graph data structure,
wherein identifying the one or more sub-graph data structures is based on the access permissions.

20. The non-transitory computer-readable medium of claim 18, wherein the operations further comprise:
prior to revising the node or edge of the one or more sub-graph data structures, determining whether the revision conflicts with any other revisions to the node or edge;
detecting a conflict between the revision and a pending revision from a second user input originating from a second computing device;
executing a machine learning model using the revision and the pending revision as input to cause the machine learning model to output a selection of the revision as the correct revision, the machine learning model trained based on labeled training data of conflicting revisions to the network graph data structure; and
revising the node or edge based on the output of the machine learning model.
